(19) United States
(12) Patent Application Publication
(10) Pub. No.: US 2023/0112684 A1
(43) Pub. Date: Apr. 13, 2023

(54) POWER RELEASE LATCH ASSEMBLY WITH DOUBLE PULL AND POWER CHILD LOCK

(71) Applicant: Magna Closures Inc., Newmarket (CA)

(72) Inventor: Roman CETNAR, Newmarket (CA)

(21) Appl. No.: 17/964,181

(22) Filed: Oct. 12, 2022

Related U.S. Application Data
(60) Provisional application No. 63/308,494, filed on Feb. 9, 2022.
(60) Provisional application No. 63/300,200, filed on Jan. 17, 2022.
(60) Provisional application No. 63/298,389, filed on Jan. 11, 2022.
(60) Provisional application No. 63/285,963, filed on Dec. 3, 2021.
(60) Provisional application No. 63/283,806, filed on Nov. 29, 2021.
(60) Provisional application No. 63/255,405, filed on Oct. 13, 2021.

(51) Int. Cl. E05B 81/14; E05B 81/06; E05B 81/30; E05B 81/34; E05B 81/42; E05B 83/36; E05B 85/26; E05B 77/26; E05B 77/30

(52) U.S. Cl. CPC E05B 81/14; E05B 81/06; E05B 81/30; E05B 81/34; E05B 81/42; E05B 83/36; E05B 85/26; E05B 77/26; E05B 77/30; E05B 77/02

(57) ABSTRACT

A power latch assembly for motor vehicle closure applications has a single motor operable to move a pawl from a ratchet holding position to a ratchet releasing position; place the power latch assembly in a double pull mechanical release state, and place the power latch assembly in a child lock state.

### CROSS-REFERENCE TO RELATED APPLICATIONS

This application claims the benefit of U.S. Provisional Application Ser. No. 63/308,494, filed Feb. 9, 2022, U.S. Provisional Application Ser. No. 63/300,200, filed Jan. 17, 2022, U.S. Provisional Application Ser. No. 63/298,389, filed Jan. 11, 2022, U.S. Provisional Application Serial No. 63/285,963, filed Dec. 3, 2021, U.S. Provisional Application Ser. No. 63/283,806, filed Nov. 29, 2021, and U.S. Provisional Application Ser. No. 63/255,405, filed Oct. 13, 2021, which are all incorporated herein by way of reference in their entirety.

### FIELD

The present disclosure relates generally to automotive door latches of the type used in closure systems for releasably latching a closure panel to a body portion of a motor vehicle, and more particularly, to a power- operated closure latch assembly equipped with a single power motor driving multiple functions, including power release, crash unlock and lock functions, double lock, child lock, and mechanical release.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed and unlatch and release the door to permit subsequent movement of the door to its open position. As is also well known, the latch assembly is configured to include a latch mechanism for latching the door and a release mechanism for unlatching the door. The release mechanism can be power-operated to unlatch the door.

During powered actuation of latch mechanism, it is known to actuate a first gear mechanism with a first motor to move a pawl from a ratchet holding position to a ratchet releasing position, thereby allowing a ratchet to move from a striker capture position to a striker releasing position, whereat the door can be moved from a closed position to an open position.

Additionally, it is known to provide a secondary motor in addition to the first motor, with the secondary motor being used to, by way of example, move a lock mechanism to at least one of a double lock and a child lock position. Although such secondary motors can prove useful, they come at an increase in cost, complexity, power demand, and package size of the latch assembly.

Thus, there remains a need to develop alternative arrangements for latch mechanisms for use in vehicular door latches which optimize the ability to perform multiple functions without having to provide multiple motors to accomplish the desired functions.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

It is another object of the present disclosure to provide a power latch assembly for motor vehicle closure applications that has a single motor that is optimized in size and performs multiple functions.

It is another object of the present disclosure to provide a power latch assembly for motor vehicle closure applications that has a single motor capable of at least two or more functions, including: moving a pawl from a ratchet holding position to a ratchet releasing position; placing the power latch assembly in a double pull mechanical release state, and placing the power latch assembly in a child lock state.

It is another object of the present disclosure to provide a power latch assembly for motor vehicle closure applications that is normally actuated via electrical signals to a single power actuator whereat inside and outside door handles are mechanically disengaged and wherein the inside and outside door handles can be selectively and/or automatically changed for mechanically engaged actuation via the single power actuator.

It is another object of the disclosure to configure the outside door handle to become automatically operable via mechanical actuation from an inoperable state, such as a double lock state and child lock state, in direct response to a crash condition through automatic actuation of the single power actuator.

It is another object of the disclosure to configure the inside door handle to be selectively operable via a double pull actuation mode through selective actuation of the single power actuator.

It is another object of the disclosure to configure the inside door handle to be selectively inoperable in a child lock mode through selective actuation of the single power actuator.

In accordance with these and other objects, features and advantages, a power latch assembly for a closure panel includes: a ratchet configured for movement between a striker capture position and a striker release position and being biased toward the striker release position. Further, a pawl configured for movement between a ratchet holding position, whereat the pawl maintains the ratchet in the striker capture position, and a ratchet releasing position, whereat the pawl releases the ratchet for movement of the ratchet to the striker release position. A single power actuator is configured to move the pawl from the ratchet holding position to the ratchet releasing position. The single power actuator is further configured to selectively place the power latch assembly in a double pull lock state, whereat a double mechanical actuation of an inside release mechanism moves the pawl from the ratchet holding position to the ratchet releasing position. The single power actuator is further configured to place the power latch assembly in a child lock state, whereat repeated mechanical actuation of an inside release mechanism does not move the pawl from the ratchet holding position to the ratchet releasing position.

In accordance with another aspect of the disclosure, a power release gear is configured in operable communication with the single power actuator, wherein the single power actuator is configured to drive the power release gear from a home position in a first direction to a release position, whereupon the power release gear operably drives the pawl from the ratchet holding position to the ratchet releasing position, and from the home position in a second direction to a lock position, whereupon the power release gear operably places the power latch assembly in one of the double pull lock state and the child lock state.

In accordance with another aspect of the disclosure, the power release gear can be configured to move from the home position in the second direction to the lock position, whereupon the power release gear operably places the power latch assembly in the child lock state, and then be returned to directly to the home position, whereupon the power release gear operably places the power latch assembly in the double pull lock state.

In accordance with another aspect of the disclosure, a power release link operably couples the power release gear with a pawl release lever, wherein the power release link is configured to drive the pawl release lever and move the pawl from the ratchet holding position to the ratchet releasing position when the power release gear is driven from the home position to the release position.

In accordance with another aspect of the disclosure, the power release gear and the power release link are configured for lost-motion with one another.

In accordance with another aspect of the disclosure, the power release link has an elongate slot and the power release gear has a pin disposed in the elongate slot for translation therein, such that when the power release gear is driven from its home position in the first direction to the release position, the pin engages a drive end of the elongate slot and drives the power release link to move the pawl release lever and drive the pawl from the ratchet holding position to the ratchet releasing position, and when the power release gear is driven from its home position in the second direction to the lock position, the pin moves away from the drive end in lost-motion through the elongate slot to place the power latch assembly in one of the double pull lock state and the child lock state.

In accordance with another aspect of the disclosure, an inside release link is configured for driven movement from a rest position to a deployed position in response to mechanical actuation of the inside release mechanism, and an inside lock cam is configured for movement between a cam unlock position, whereat the inside release link is aligned for operable engagement with the pawl release lever, and a cam double pull lock position, whereat the inside release link is misaligned from operable engagement with the pawl release lever during a first mechanical actuation of the inside release mechanism.

In accordance with another aspect of the disclosure, the inside lock cam can be configured for movement to a cam child lock position, whereat the inside release link is misaligned from operable engagement with the pawl release lever during repeated mechanical actuations of the inside release mechanism.

In accordance with another aspect of the disclosure, the inside lock cam can be configured as a two- piece cam, with separate first and second cam members of the two-piece cam being biased for relative movement with one another by a spring member.

In accordance with another aspect of the disclosure, the inside lock cam can be configured for engagement by a lug of the power release gear when the power release gear is driven a first time from its home position in the second direction to the lock position, whereupon the inside lock cam is driven to the cam double pull lock position.

In accordance with another aspect of the disclosure, the inside lock cam, while in the cam double pull lock position, is configured for engagement by the lug of the power release gear when the power release gear is driven a second time from its home position in the second direction to the lock position, whereupon the inside lock cam is driven to the cam child lock position.

In accordance with another aspect of the disclosure, a double pull link is coupled to the inside lock cam for operable engagement with the inside release link. While the inside lock cam is in the cam double pull lock position, during a first mechanical actuation of the inside release mechanism, the inside lock cam is driven by the double pull link to the cam unlock position, whereat the inside release link is aligned for operable engagement with the pawl release lever upon completion of the first mechanical actuation of the inside release mechanism. During a second mechanical actuation of the inside release mechanism, the inside release link moves the pawl release lever and drives the pawl from the ratchet holding position to the ratchet releasing position.

In accordance with another aspect of the disclosure, while the inside lock cam is in the child lock position, during mechanical repeated actuation of the inside release mechanism, the inside lock cam remains in the child lock position.

In accordance with another aspect of the disclosure, the power release gear can be configured to remain in the release position, whereat the lug of the power release gear engages a child lock projection of the inside lock cam to releasably place the power latch assembly in the child lock state.

In accordance with another aspect of the disclosure, a method of performing multiple functions with a single power actuator of a power latch assembly having a ratchet configured for movement between a striker capture position and a striker release position and being biased toward the striker release position and a pawl configured for movement between a ratchet holding position, whereat the pawl maintains the ratchet in the striker capture position, and a ratchet releasing position, whereat the pawl releases the ratchet for movement of the ratchet to the striker release position, is provided. The method includes, configuring the single power actuator to move the pawl from the ratchet holding position to the ratchet releasing position when the power latch assembly is in a latch closed, unlocked position. Further, configuring the single power actuator to selectively place the power latch assembly in a double pull lock state, whereat completion of a first and second mechanical actuation of an inside release mechanism the pawl is moved from the ratchet holding position to the ratchet releasing position. Further yet, configuring the single power actuator to place the power latch assembly in a child lock state, whereat repeated mechanical actuation of the inside release mechanism fails to move the pawl from the ratchet holding position to the ratchet releasing position.

In accordance with another aspect of the disclosure, the method includes arranging a power release gear in operable communication with the single power actuator and configuring the single power actuator to drive the power release gear from a home position, in a first direction, to a release position, whereupon the power release gear operably drives the pawl from the ratchet holding position to the ratchet releasing position. The single power actuator is further configured to drive the power release gear from the home position, in a second direction, to a lock position, whereupon the power release gear operably places the power latch assembly in one of the double pull lock state and the child lock state.

In accordance with another aspect of the disclosure, the method includes operably coupling the power release gear to a pawl release lever with a power release link, and configuring the power release link to drive the pawl release lever and move the pawl from the ratchet holding position to the ratchet releasing position when the power release gear is driven from the home position to the release position.

In accordance with another aspect of the disclosure, the method includes configuring the power release gear and the power release link for lost-motion with one another.

In accordance with another aspect of the disclosure, the method includes, while driving the power release gear from its home position in the first direction to the release position, causing a pin disposed in an elongate slot of the power release link to engage a drive end of the elongate slot to drive the power release link to move the pawl release lever and drive the pawl from the ratchet holding position to the ratchet releasing position. Further, while driving the power release gear from its home position in the second direction to the lock position, causing the pin to move away from the drive end in lost-motion through the elongate slot to place the power latch assembly in one of the double pull lock state and the child lock state.

In accordance with another aspect of the disclosure, the method includes arranging an inside release link for driven movement from a rest position to a deployed position in response to mechanical actuation of the inside release mechanism, and further including arranging an inside lock cam for movement between a cam unlock position, whereat the inside release link is aligned for operable engagement with the pawl release lever, a cam double pull lock position, whereat the inside release link is misaligned from operable engagement with the pawl release lever during a first mechanical actuation of the inside release mechanism, and a cam child lock position, whereat the inside release link remains misaligned from operable engagement with the pawl release lever during repeated mechanical actuations of the inside release mechanism.

In accordance with another aspect of the disclosure, the method includes arranging the inside lock cam to be engaged by a lug of the power release gear and moved to the cam double pull lock position when the power release gear is driven a first time from its home position in the second direction to the lock position.

In accordance with another aspect of the disclosure, the method includes configuring the inside lock cam, while in the cam double pull lock position, to be engaged by the lug of the power release gear and moved to the cam child lock position when the power release gear is driven a second time from its home position in the second direction to the lock position.

In accordance with another aspect of the disclosure, the method includes coupling a double pull link to the inside lock cam and arranging the double pull link to be selectively driven by the inside release link while the inside lock cam is in the cam double pull lock position, such that upon completing a first mechanical actuation of the inside release mechanism, the double pull link drives the inside lock cam to the cam unlock position and the inside release link becomes aligned for operable engagement with the pawl release lever, and upon completing a second mechanical actuation of the inside release mechanism, the inside release link moves the pawl release lever and drives the pawl from the ratchet holding position to the ratchet releasing position.

In accordance with another aspect of the disclosure, the method includes arranging the double pull link to remain free from driven engagement with the inside release link while the inside lock cam is in the cam child lock position, such that during repeated mechanical actuation of the inside release mechanism, the inside lock cam remains in the cam child lock position and the pawl remains in the ratchet holding position.

In accordance with another aspect of the disclosure, the method can further include arranging a power release gear in operable communication with the single power actuator and configuring the single power actuator to drive the power release gear from a home position, in a first direction, to a release position, whereupon the power release gear operably drives the pawl from the ratchet holding position to the ratchet releasing position, and from the home position, in a second direction, to a lock position, whereupon the power release gear operably places the power latch assembly in the child lock state, and configuring the single power actuator to drive the power release gear from the lock position, in the first direction back to the home position, whereupon the power latch assembly is placed in the double pull lock state.

In accordance with another aspect of the disclosure, the method can further include arranging an inside release link for driven movement from a rest position to a deployed position in response to mechanical actuation of the inside release mechanism, and further including arranging an inside lock cam for movement between a cam unlock position, whereat the inside release link is aligned for operable engagement with the pawl release lever, and a cam double pull lock position, whereat the inside release link is misaligned from operable engagement with the pawl release lever during a first mechanical actuation of the inside release mechanism, wherein the inside lock cam includes a first cam member and a second cam member configured for movement relative to one another.

In accordance with another aspect of the disclosure, the method can further include arranging the inside release link to engage the second cam member and pivot the second cam member relative to the first cam member against a bias of a biasing member connecting the first cam member to the second cam member during mechanical actuation of the inside release mechanism when the power release gear is in the lock position, whereupon the second cam member returns to a home position under the bias of the biasing member upon completion of the mechanical actuation of the inside release mechanism.

In accordance with another aspect of the disclosure, a method of constructing a power latch assembly having a single motor configured to perform multiple functions, the multiple functions comprising: moving a pawl from a ratchet holding position to a ratchet releasing position; placing the power latch assembly in a double pull lock state, whereat a double mechanical actuation of an inside release mechanism moves the pawl from the ratchet holding position to the ratchet releasing position; and placing the power latch assembly in a child lock state, whereat repeated mechanical actuation of an inside release mechanism does not cause the pawl to move from the ratchet holding position to the ratchet releasing position, is provided.

In accordance with another aspect of the disclosure, a latch assembly includes an inside lock link moveable between a coupled and decoupled position, and a cam for holding the inside lock link in a decoupled position, wherein a first pull of the inside lock link, when in a decoupled position, causes the cam to move to a position to allow the inside lock link to move to a coupled position, and wherein a second pull of the inside lock link, when in the coupled position, causes the latch assembly to be released.

In accordance with another aspect of the disclosure, a power release actuator system is provided that includes a power latch assembly for a vehicle door including a ratchet configured for movement between a striker capture position and a striker release position and being biased toward the striker release position. A pawl is configured for movement between a ratchet holding position, whereat the pawl maintains the ratchet in the striker capture position, and a ratchet releasing position, whereat the pawl releases the ratchet for movement to the striker release position. A link member is configured to selectively move the pawl from the ratchet holding position to the ratchet releasing position. An override release mechanism is moveable between a disengaged position, whereat at least one of an inside door handle and an outside door handle is disengaged from operable communication with the link member, and an engaged position, whereat at least one of the inside door handle and the outside door handle is engaged in operable communication with the link member. A single power release actuator is configured to control powered actuation of the link member to move the pawl from the ratchet holding position to the ratchet releasing position and to maintain the override release mechanism in the disengaged position during normal operation of the power latch assembly and to selectively move the override release mechanism to the engaged position.

In accordance with another aspect of the disclosure, the power release actuator system includes a motor and a drive gear driven about a drive gear axis by the motor. The drive gear has an actuation feature extending outwardly therefrom in spaced relation from the drive gear axis. The actuation feature is configured in operable communication with the link member to selectively move the pawl from the ratchet holding position to the ratchet releasing position when the motor drives the drive gear in a first direction.

In accordance with another aspect of the disclosure, the power release actuator system includes a single motor and a drive gear driven about a drive gear axis by the motor. The drive gear has an actuation feature extending outwardly therefrom in spaced relation from the drive gear axis. The actuation feature is configured in operable communication with the link member to selectively move the pawl from the ratchet holding position to the ratchet releasing position when the motor drives the drive gear in a first direction.

In accordance with another aspect of the disclosure, the actuation feature is configured to selectively move the override release mechanism between the disengaged and engaged positions when the motor drives the drive gear in a second direction opposite the first direction.

In accordance with another aspect of the disclosure, the actuation feature is configured for lost motion relative to the link member.

In accordance with another aspect of the disclosure, the link member is operably coupled to the pawl.

In accordance with another aspect of the disclosure, the actuation feature moves the link member into alignment for engagement with an outside release lever operably coupled to the outside door handle upon the override release mechanism moving to the engaged position.

In accordance with another aspect of the disclosure, an indexing member is configured to move between a plurality of indexed positions to bring the inside door handle into and out of operable communication with the pawl upon the drive gear being driven in the second direction.

In accordance with another aspect of the disclosure, the indexing member is indexable a predetermined number of degrees between adjacent ones of the plurality of indexed positions by a lug of the drive gear to releasably hold the inside door handle in operable or inoperable communication with the pawl.

In accordance with another aspect of the disclosure, an indexing member biasing member can be configured to releasably hold the indexing member in the plurality of indexed positions.

In accordance with another aspect of the disclosure, the outside release lever is aligned for engagement with a driven feature of the link member when the override release mechanism is in the engaged position and is moved out from alignment from the driven feature of the link arm when the override release mechanism is in the disengaged position.

In accordance with another aspect of the disclosure, an inside release link is operably coupled to the inside door handle, with the inside release link having a disengaged position, whereat the inside door handle is disengaged from operable communication with the pawl, and an engaged position, whereat the inside door handle is configured in operable communication with the pawl.

In accordance with another aspect of the disclosure, the indexing member is configured to move the inside release link between the disengaged and engaged positions in response to movement of the lug of the drive gear into driving engagement with the indexing member upon the override release mechanism moving between the engaged and disengaged positions.

In accordance with another aspect of the disclosure, a control unit is provided in electrical communication with the single motor. The control unit is configured in electrical communication with at least one sensor configured to detect a crash condition, wherein the control unit automatically energizes the single motor in response to a detected crash to move the drive gear in the second direction to cause the override release mechanism to move from the disengaged position to the engaged position.

In accordance with another aspect of the disclosure, a method of operating the power latch assembly includes, in a normal operating condition, wherein an outside door handle is inoperable to allow mechanical actuation of the power latch assembly, energizing a motor to drive an actuation feature from a rest position in a first direction to move a pawl from a ratchet holding position to a ratchet releasing position to allow a ratchet to move to a striker release position and returning the actuation feature to the rest position, and in a crash condition, automatically energizing the motor to drive the actuation feature from the rest position in a second direction opposite the first direction to bring the outside door handle into an operable condition to allow mechanical actuation of the power latch assembly via the outside door handle.

In accordance with another aspect of the disclosure, the method can further include causing an inside door handle to move from an operable condition, whereat the inside door handle is operable to move the pawl from a ratchet holding position to a ratchet releasing position to allow the ratchet to move to a striker release position, to an inoperable condition, whereat the inside door handle is inoperable to move the pawl from the ratchet holding position to the ratchet releasing position, upon driving the actuation feature from the rest position in a second direction.

In accordance with the disclosure, there is provided a latch assembly for a closure panel having a ratchet configured for movement between a striker capture position and a striker release position and being biased toward said striker release position, a pawl configured for movement between a ratchet holding position, whereat said pawl maintains said ratchet in said striker capture position, and a ratchet releasing position, whereat said pawl releases said ratchet for movement of said ratchet to said striker release position, a release mechanism operably coupled to the pawl, and a lock mechanism adapted to couple and decouple the release mechanism to the pawl, where the release mechanism is unable to shift the lock mechanism from a first lock state to a second lock state when the lock mechanism is in the first lock state.

Further areas of applicability and functionality of the power latch assembly and single motor thereof will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly embodying the teachings of the present disclosure;

FIG. 2 is a front side perspective view of a power latch assembly embodying the teachings of the present disclosure shown schematically in operable communication with various components of the side door, with some components removed for clarity purposes only;

FIG. 3A is a front side plan view of the power latch assembly of FIG. 2 shown in a latch closed and unlocked position with a power release gear shown in a home position with an inside release link shown in an engaged position;

FIG. 3B is right side view of the power latch assembly of FIG. 3A looking generally along the direction of arrow 3B;

FIG. 3C is bottom side view of the power latch assembly of FIG. 3A looking generally along the direction of arrow 3C;

FIG. 3D is a rear side plan view of the power latch assembly of FIG. 3A;

FIG. 4 is an enlarged fragmentary front side plan view illustrating the power release gear with a gear pin of the power release gear shown in a slot of a power release link while in a home position, with the gear pin shown in a full travel release position, a pre-travel lock position, and a full travel lock position;

FIG. 5A is an enlarged fragmentary top perspective view illustrating the inside release link in an unlock position, aligned for engagement with a pawl lever pin;

FIG. 5B is a view similar to FIG. 5A illustrating the inside release link in a lock position, misaligned with the pawl lever pin to remain disengaged from the pawl lever pin;

FIG. 6 is a front side plan view of the power latch assembly shown in a latch closed and unlocked position with the power release gear shown in a home position with the inside release link shown in the home unlock position, aligned for engagement with the pawl lever pin;

FIG. 7 illustrates the power release gear being rotated away from its home position to a lock position, whereat the inside release link is moved from the unlock position to a double pull lock position misaligned and disengaged from the pawl lever pin, via a lock cam being moved to a lock position;

FIG. 8 illustrates the power release gear being rotated from the lock position back to its home position, with the lock cam retaining the inside release link in the double pull lock position, misaligned and disengaged from the pawl lever pin;

FIG. 9 illustrates the inside release link moved from a home position to a deployed position via actuation of an inside release mechanism, with the inside release link bypassing the pawl lever pin and driving a double pull link to move the lock cam from the lock position to an unlock position, whereupon the power latch assembly remains in a latch closed position;

FIG. 10 illustrates the inside release link returned from the deployed position to the home position via release of the inside release mechanism, with the inside release link shown moved to the unlock position, aligned for engagement with the pawl lever pin due to the lock cam remaining in the unlock position;

FIG. 11 illustrates the inside release link moved from the home position to the deployed position via actuation of the inside release mechanism, with the inside release link engaging the pawl lever pin, thereby driving a pawl to a ratchet releasing position, resulting in the power latch assembly being moved to a latch released position;

FIG. 12 illustrates the inside release link returned from the deployed position to the home position via release of the inside release mechanism, with the inside release link shown returned to the unlock position, aligned for engagement with the pawl lever pin, with the power latch assembly returned to a latch closed position;

FIG. 13 illustrates the power release gear being rotated away from its home position to the lock position, whereat the inside release link is moved from the unlock position to a double pull lock position, misaligned and disengaged from the pawl lever pin, via the lock cam being moved to the lock position;

FIG. 14 illustrates the power release gear being rotated from the lock position back to its home position, with the lock cam retaining the inside release link in the double pull lock position, misaligned and disengaged from the pawl lever pin;

FIG. 15 illustrates the power release gear being rotated away from its home position to the lock position, whereat the inside release link is moved from the double pull lock position to a child lock position, misaligned and disengaged from the pawl lever pin, via the lock cam being moved from the lock position to a child lock position;

FIG. 16 illustrates the power release gear being rotated from the lock position back to its home position, with the lock cam retaining the inside release link in the child lock position, misaligned and disengaged from the pawl lever pin;

FIG. 17 illustrates the inside release link moved from a home position to a deployed position via actuation of an inside release mechanism, with the inside release link bypassing the pawl lever pin, thereby resulting in the power latch assembly remaining in a latch closed position;

FIG. 18-A and 18-B is a flow diagram illustrating a method of releasing a power latch assembly of a closure panel of a motor vehicle, placing the power latch assembly in a double pull lock position, and placing the power latch assembly in a child lock position, in accordance with another aspect of the disclosure;

FIG. 19 illustrates some functions of a power latch assembly constructed in accordance with another aspect of the present disclosure;

FIG. 20 is a front side perspective view of another power latch assembly including the function of FIG. 19, embodying the teachings of the present disclosure, with some components removed for clarity purposes only;

FIG. 21A is a front side plan view of the power latch assembly of FIG. 20 shown in a latch closed and unlocked position with a power release gear shown in a home position with an inside release link shown in an engaged position;

FIG. 21B is right side view of the power latch assembly of FIG. 21A looking generally along the direction of arrow 21B;

FIG. 21C is bottom side view of the power latch assembly of FIG. 21A looking generally along the direction of arrow 21C;

FIG. 21D is a rear side plan view of the power latch assembly of FIG. 21A;

FIG. 22 is an enlarged fragmentary front side plan view illustrating the power release gear with a gear pin of the power release gear shown in a slot of a power release link while in a home position, with the gear pin also shown in phantom in a full travel release position, and in phantom in a pre-travel lock position, and in phantom in a full travel lock position;

FIG. 23A is an enlarged fragmentary front side plan view illustrating an inside lock cam while in an unlock position;

FIG. 23B is a view similar to FIG. 23A illustrating the inside lock cam while in a lock position;

FIG. 23C is an enlarged fragmentary front side plan view of FIG. 23B illustrating a biasing member imparting a bias on the inside lock cam to releasably hold the inside lock cam in the lock position;

FIG. 23D is a view similar to FIG. 23A illustrating the inside lock cam while in a child lock position;

FIGS. 24A-24H are enlarged fragmentary front side plan views illustrating an interface between a power release gear and the inside lock cam of the power latch assembly of FIG. 20;

FIGS. 25A-25E are enlarged fragmentary front side plan views illustrating various positions of the power release gear of the power latch assembly of FIG. 20;

FIG. 26 is a front side plan view of the power latch assembly shown in a latch closed and unlocked position with the power release gear shown in a home position with the inside release link shown in the home unlock position, aligned for engagement with the pawl lever pin;

FIG. 27 illustrates the power release gear being rotated away from its home position to a lock position, whereat the inside release link is moved from the unlock position to a double pull lock position misaligned and disengaged from the pawl lever pin, via a lock cam being moved to a lock position;

FIG. 28 illustrates the power release gear being rotated from the lock position back to its home position, with the lock cam retaining the inside release link in the double pull lock position, misaligned and disengaged from the pawl lever pin;

FIG. 29 illustrates the inside release link moved from a home position to a deployed position via actuation of an inside release mechanism, with the inside release link bypassing the pawl lever pin and driving a double pull lever to move the lock cam from the lock position to an unlock position, whereupon the power latch assembly remains in a latch closed position;

FIG. 30 illustrates the inside release link returned from the deployed position to the home position via release of the inside release mechanism, with the inside release link shown prior to being moved to the unlock position;

FIG. 31 is similar to FIG. 30 illustrating the inside release link moved to the unlock position, aligned for engagement with the pawl lever pin due to the lock cam remaining in the unlock position;

FIG. 32 illustrates the inside release link moved from the home position to the deployed position via actuation of the inside release mechanism, with the inside release link engaging the pawl lever pin, thereby driving a pawl to a ratchet releasing position, resulting in the power latch assembly being moved to a latch released position;

FIG. 33 illustrates the inside release link returned from the deployed position to the home position via release of the inside release mechanism, with the inside release link shown returned to the unlock position, aligned for engagement with the pawl lever pin, with the power latch assembly returned to a latch closed position;

FIG. 34 illustrates the power release gear being rotated away from its home position to the lock position, whereat the inside release link is moved from the unlock position to a double pull lock position, misaligned and disengaged from the pawl lever pin, via the lock cam being moved to the lock position;

FIG. 35 illustrates the power release gear being rotated from the lock position back to its home position, with the lock cam retaining the inside release link in the double pull lock position, misaligned and disengaged from the pawl lever pin;

FIG. 36 illustrates the power release gear being rotated away from its home position to the lock position, whereat the inside release link remains misaligned and disengaged from the pawl lever pin, with the lock cam being moved from the lock position to a child lock position;

FIG. 37 illustrates the power release gear being rotated from the lock position back to its home position, with the inside release link remaining misaligned and disengaged from the pawl lever pin and the lock cam remaining in the child lock position;

FIG. 38 illustrates the inside release link moved from a home position to a deployed position via actuation of an inside release mechanism, with the inside release link bypassing the pawl lever pin, thereby resulting in the power latch assembly remaining in a latch closed position;

FIG. 39 illustrates the power release gear in its home position, with the lock cam retaining the inside release link in the double pull lock position, misaligned and disengaged from the pawl lever pin;

FIG. 40 illustrates the power release gear being rotated away from its home position to the lock position, whereat the inside release link remains misaligned and disengaged from the pawl lever pin, with the lock cam being moved from the lock position to the child lock position;

FIG. 41 illustrates the power release gear being rotated from the lock position back to its home position, with the inside release link remaining misaligned and disengaged from the pawl lever pin and the lock cam remaining in the child lock position;

FIG. 42 illustrates the power release gear being rotated away from its home position to the lock position, whereat the inside release link is moved to the unlock position, aligned for engagement with the pawl lever pin due to the lock cam being moved to the unlock position;

FIG. 43 illustrates the power release gear being rotated from the lock position back to its home position, with the inside release link remaining aligned for engagement with the pawl lever pin and the lock cam remaining in the unlock position;

FIG. 44 illustrates different positions of the lock cam as it is rotated in a clockwise directions via biased engagement by the power release gear, including an unlock position shown with a cam lug in solid, a lock position shown with the cam lug in an upper dashed position, and a child lock position shown with the cam lug in a lower dashed position;

FIG. 45 illustrates a plurality of switches of the power latch assembly of FIG. 20;

FIG. 46 is a front side perspective view of yet another power latch assembly embodying the teachings of the present disclosure, with some components removed for clarity purposes only;

FIG. 47A is a front side plan view of the power latch assembly of FIG. 46 shown in a latch closed and unlocked position with a power release gear shown in a home position with an inside release link shown in an engaged position;

FIG. 47B is right side view of the power latch assembly of FIG. 47A looking generally along the direction of arrow 47B;

FIG. 47C is bottom side view of the power latch assembly of FIG. 47A looking generally along the direction of arrow 47C;

FIG. 47D is a rear side plan view of the power latch assembly of FIG. 47A;

FIGS. 48A and 48B are enlarged fragmentary front side plan views illustrating the power release gear with a gear pin of the power release gear shown in a slot of a power release link while in a maximum home position and a minimum home position, respectively;

FIG. 49 is an enlarged fragmentary front side plan view illustrating the power release gear with a gear pin of the power release gear shown in a slot of a power release link while in a home position, with the gear pin also shown in phantom in a full travel release position and in phantom in a full travel lock position;

FIGS. 50A through 50D are enlarged fragmentary rear side plan views illustrating the power release gear in a minimum home position, a mid-home position, a maximum home position, and a full release position, respectively;

FIG. 51 is a front side plan view of the power latch assembly shown in a latch closed and unlocked position with the power release gear shown in a home position with the inside release link shown in the home unlock position, aligned for engagement with the pawl lever pin;

FIG. 52 illustrates the power release gear being initially rotated away from its home position to a lock position;

FIG. 53 illustrates the power release gear fully rotated to the lock position, whereat the inside release link is moved from the home unlock position to a double pull lock position misaligned and disengaged from the pawl lever pin, via a lock cam being moved to a lock position;

FIG. 54 illustrates the power release gear being rotated from the lock position back to its home position, with the lock cam retaining the inside release link in the double pull lock position, misaligned and disengaged from the pawl lever pin;

FIG. 55 illustrates the inside release link moved from a home position to a deployed position via actuation of an inside release mechanism, with the inside release link bypassing the pawl lever pin and driving the lock cam from the lock position to an unlock position, whereupon the power latch assembly remains in a latch closed position;

FIG. 56 illustrates the inside release link returned from the deployed position to the home position via release of the inside release mechanism, with the inside release link shown prior to being moved to the home unlock position;

FIG. 57 is similar to FIG. 56 illustrating the inside release link moved to the home unlock position, aligned for engagement with the pawl lever pin due to the lock cam remaining in the unlock position;

FIG. 58 illustrates the inside release link moved from the home position to the deployed position via actuation of the inside release mechanism, with the inside release link engaging the pawl lever pin, thereby driving a pawl to a ratchet releasing position, resulting in the power latch assembly being moved to a latch released position;

FIG. 59 is a view similar to FIG. 58 illustrating a striker being released from a ratchet as the ratchet is moved to a striker releasing position;

FIG. 60 illustrates the inside release link returned from the deployed position to the home position via release of the inside release mechanism, with the inside release link shown returned to the home unlock position, aligned for engagement with the pawl lever pin, with the power latch assembly returned to a latch closed position;

FIG. 61 is a front side plan view of the power latch assembly shown in the latch closed and unlocked position with the power release gear shown in the home position with the inside release link shown in the home unlock position, aligned for engagement with the pawl lever pin;

FIG. 62 illustrates the power release gear being rotated away from its home position to the lock position, whereat the inside release link is moved from the home unlock position to the lock position, misaligned and disengaged from the pawl lever pin, via the lock cam being moved to the lock position, whereupon the power release gear remains in the lock position;

FIG. 63 illustrates the inside release link moved from the home position to the deployed position via actuation of the inside release mechanism, with the inside release link bypassing the pawl lever pin and driving the lock cam from the lock position to an unlock position, whereupon the power latch assembly remains in a latch closed position;

FIG. 64 illustrates the inside release link returned from the deployed position to the home position via release of the inside release mechanism, with the inside release link being maintained in the lock position by a lug of the power release gear while the power release gear is in the lock position;

FIG. 65 illustrates the power release gear being rotated from the lock position back to its home position, with the with the inside release link shown prior to returning to the home unlock position;

FIG. 66 illustrates the power release gear in its home position, with the with the inside release link shown returned to the home unlock position;

FIG. 67 illustrates the power release gear rotated from its home position to its fully travel release position, whereat pawl is moved to its ratchet releasing position;

FIG. 68 is a view similar to FIG. 67 illustrating the striker being released from the ratchet as the ratchet is moved to the striker releasing position;

FIG. 69 illustrates the power release gear rotated from its fully travel release position to its home position, whereat pawl returns into biased engagement with ratchet;

FIG. 70 illustrates a plurality of switches of the power latch assembly of FIG. 46;

FIG. 71A illustrates an exploded view of a two-piece inside lock cam of a power latch assembly constructed in accordance with another non-limiting embodiment of the disclosure showing a comparison to the single piece inside lock cam of the power latch assembly of FIGS. 46-69;

FIG. 71B is an assembled view of the two-piece inside lock cam of FIG. 71A with a toggle spring showing a comparison to the single piece inside lock cam and toggle spring of the power latch assembly of FIGS. 46-69;

FIG. 71C is another assembled view of the two-piece inside lock cam that is moveable between unlock and lock positions and is biased to remain in the respective unlock and lock positions via a biasing member;

FIG. 72A is a front side plan view of a power latch assembly including the two-piece inside lock cam of FIGS. 71A and 71B, with the power latch assembly shown in a latch closed and unlocked position with a power release gear shown in a home position with an inside release link shown in a home unlock position, aligned for engagement with a pawl lever pin;

FIG. 72B illustrates the power release gear being initially rotated away from its home position to a lock position;

FIG. 72C illustrates the power release gear fully rotated to the lock position, whereat the inside release link is moved from the home unlock position to a double pull lock position misaligned and disengaged from the pawl lever pin via the two-piece inside lock cam being moved to a lock position via engagement with a lug of the power release gear;

FIG. 72D illustrates the power release gear being rotated from the lock position back to its home position, with the two-piece inside lock cam retaining the inside release link in the double pull lock position, misaligned and disengaged from the pawl lever pin;

FIG. 72E illustrates the inside release link moved from a home position to a deployed position via actuation of an inside release mechanism, with the inside release link bypassing the pawl lever pin and driving the two- piece inside lock cam from the lock position to an unlock position, whereupon the power latch assembly remains in a latch closed position;

FIG. 72F illustrates the inside release link returned from the deployed position to the home position via release of the inside release mechanism, with the inside release link shown prior to being moved to the home unlock position;

FIG. 72G is similar to FIG. 72F illustrating the inside release link moved to the home unlock position, aligned for engagement with the pawl lever pin due to the two-piece inside lock cam remaining in the unlock position;

FIG. 72H illustrates the inside release link moved from the home position to the deployed position via actuation of the inside release mechanism, with the inside release link engaging the pawl lever pin, whereupon the power latch assembly moves to a latch open position;

FIG. 73A is a front side plan view of the power latch assembly shown in the latch closed and unlocked position with the power release gear shown in the home position with the inside release link shown in the home unlock position, aligned for engagement with the pawl lever pin;

FIG. 73B illustrates the power release gear being initially rotated away from its home position to a child lock position;

FIG. 73C illustrates the power release gear rotated away from its home position to the child lock position, whereat the inside release link is moved from the home unlock position to the lock position, misaligned and disengaged from the pawl lever pin, via the two-piece inside lock cam being moved to the lock position, whereupon the power release gear remains in the child lock position;

FIG. 73D illustrates the inside release link moved from the home position to the deployed position via actuation of the inside release mechanism, with the inside release link bypassing the pawl lever pin and driving a first cam member of the two-piece inside lock cam to a bypass position, whereupon a second cam member of the two-piece inside lock cam remains stationary in engagement with the lug of the power release gear, such that power latch assembly remains in a latch closed position;

FIG. 73E illustrates the inside release link returned from the deployed position to the home position via release of the inside release mechanism, with the inside release link being maintained in the lock position by a lug of the power release gear while the power release gear is in the child lock position;

FIG. 73F is a view similar to FIG. 73D, illustrating the inside release link moved again from the home position to the deployed position via actuation of the inside release mechanism, with the inside release link bypassing the pawl lever pin and driving the first cam member of the two-piece inside lock cam to the bypass position, whereupon the second cam member of the two-piece inside lock cam remains stationary in engagement with the lug of the power release gear, such that power latch assembly remains in the latch closed position;

FIG. 74A is a view similar to FIGS. 73C and 73E illustrating the power release gear rotated away from its home position to the child lock position, whereat the inside release link is moved from the home unlock position to the lock position, misaligned and disengaged from the pawl lever pin, via the two-piece inside lock cam being moved to the lock position;

FIG. 74B illustrates the power release gear being rotated from the child lock position back to its home position, with the two-piece inside lock cam retaining the inside release link in the double pull lock position, misaligned and disengaged from the pawl lever pin;

FIG. 74C illustrates the inside release link moved from the home position to the deployed position via actuation of the inside release mechanism, with the inside release link bypassing the pawl lever pin and driving the two- piece inside lock cam from the lock position to the unlock position, whereupon the power latch assembly remains in the latch closed position;

FIG. 74D illustrates the inside release link returned from the deployed position to the home position via release of the inside release mechanism, with the inside release link shown prior to being moved to the home unlock position;

FIG. 74E is similar to FIG. 74D illustrating the inside release link moved to the home unlock position, aligned for engagement with the pawl lever pin due to the two-piece inside lock cam remaining in the unlock position; and

FIG. 74F illustrates the inside release link moved from the home position to the deployed position via actuation of the inside release mechanism, with the inside release link engaging the pawl lever pin, whereupon the power latch assembly moves to the latch open position.

FIG. 75 is an isometric view of a motor vehicle equipped with a closure system including a closure latch assembly shown mounted to a vehicle door;

FIG. 76 is a plan view of a closure latch assembly constructed in accordance with one aspect of the disclosure and adapted for use in the closure system shown in FIG. 75;

FIG. 77 is an isometric view of the closure latch assembly of FIG. 76 with various components removed therefrom for clarity purposes only to better illustrate a ratchet, pawl and release link arrangement of the closure latch assembly;

FIGS. 78A through 78D illustrate a non-limiting example embodiment of a latch mechanism of the closure latch assembly of FIG. 75;

FIG. 79 is a diagrammatical view of the closure latch assembly shown in FIGS. 76-77;

FIG. 80 is a diagrammatical view of a power latch system and power latch assembly thereof in accordance with an aspect of the disclosure;

FIG. 81 is a perspective, semi-transparent view of a closure latch assembly constructed in accordance with an aspect of the disclosure;

FIG. 82A is a plan view illustrating of the closure latch assembly of FIG. 80 with an inside release link shown moved to an unlocked position and an outside release lever shown in a locked position;

FIG. 82B is a side view of the closure latch assembly of FIG. 81 looking generally along the arrow 82B of FIG. 82A;

FIG. 82C is an end view of the closure latch assembly of FIG. 81 looking generally along the arrow 82C of FIG. 82A;

FIG. 83 is a plan view of the closure latch assembly of FIG. 81 with a power release gear and actuation feature shown in a maximum rest position and with the inside release link shown in the unlocked position for ready engagement with the inside release lever and with an outside release lever shown in a locked position disengaged from a release link;

FIGS. 84-87 illustrate a normal powered actuation of the closure latch assembly of FIG. 81 via powered movement of the power release gear and actuation feature by a power actuator from a rest position in a first direction with the outside release lever shown in the locked position, and then back to the rest position;

FIG. 88 illustrates a crash unlock operation of the closure latch assembly of FIG. 81 via powered movement of the actuation feature by the power actuator from a rest position in a second direction with the outside release lever shown in an unlocked position and the inside release link shown in an unlocked position;

FIG. 89 illustrates the outside release lever engaged with the release link and manually moved to a released position via an outside door handle to open the closure latch assembly;

FIG. 90 illustrates the outside release lever returned to a rest, home position via release of the outside door handle with the outside release lever and the inside release link shown in their respective unlocked positions;

FIG. 91 illustrates the power release gear and actuation feature returned to the maximum rest position after movement from the rest position in the second direction, whereat the outside release lever is returned to the locked position and whereat an indexing knob is operably moved by the power release gear to move the inside release link to a locked position

FIGS. 92A and 92B illustrate the inside release link in respective engaged and disengaged positions;

FIGS. 93A and 93B-93C illustrate inside release members in accordance with different, non-limiting aspects of the disclosure;

FIG. 94 illustrates a method operating a power latch assembly constructed in accordance with an aspect of the disclosure;

FIG. 95A is a front side plan view of a power latch assembly in accordance with another exemplary configuration illustrating the latch in a second lock state, or double pull state, and an inside release link shown in an unactuated and misaligned position;

FIG. 95B illustrates the actuation of the inside release link of FIG. 95A changing the state of the latch from the second lock state to an unlock state;

FIG. 95C illustrates the latch of FIG. 95A in a first lock state, or double lock/child lock state, and an inside release link shown in an unactuated and misaligned position; and

FIG. 95D illustrates the latch of FIG. 95C in the first lock state and the inside release link compressing a resilient element in an actuated position.

Corresponding reference numerals are used throughout all of the drawings to indicate corresponding parts.

### DETAILED DESCRIPTION OF EXAMPLE EMBODIMENTS

One or more example embodiments of a powered latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

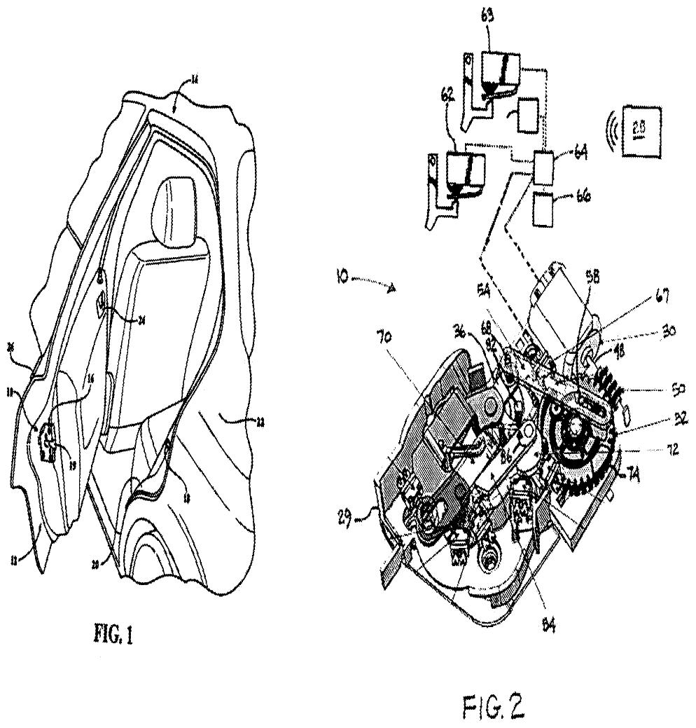

Referring initially to FIG. 1, a non-limiting example of a power latch assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 configured to releasably latch and hold a striker 18 mounted to a sill portion 20 of a vehicle body 22 when swing door 12 is closed. Latch assembly 10 can be selectively actuated via mechanical actuation of an inside release mechanism, such as an inside door handle 24, an outside door handle 26, and a key fob 28 (FIG. 2). As will be detailed, latch assembly 10 is configured to be power-operated to perform multiple functions via selective actuation of a single power release actuator, such as an electric motor 30. By multiple functions being powered via a single power release actuator 30, the latch assembly 10 is able to be minimized in size and weight, thereby enhancing the flexibility of design of the closure panel, while also reducing the cost associated therewith.

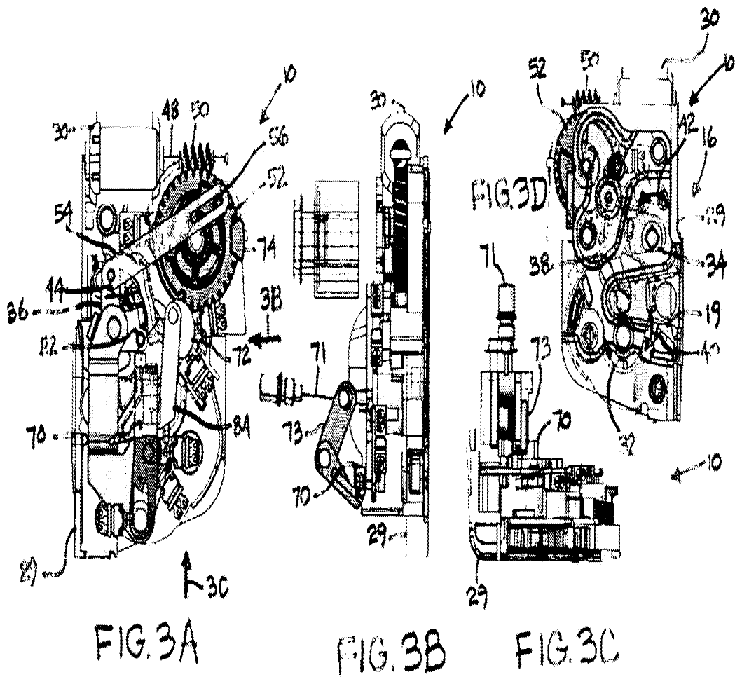

Referring to FIG. 2, shown is a non-limiting embodiment of latch assembly 10 and latch mechanism 16 (FIG. 3D) contained in a housing, shown in part via a latch frame plate 29, with some components removed for clarity purposes only. Latch mechanism 16 includes a ratchet 32 and a pawl 34, and a release lever, also referred to as release link, pawl release link, or pawl release lever 36. Ratchet 32 is movable between a striker capture position, whereat ratchet 32 retains striker 18 with a striker slot 38 of ratchet 32 and swing door 12 in closed position, and a striker release position, whereat ratchet 32 permits release of striker 18 from a fishmouth 19 provided by latch housing of latch assembly 10 to allow movement of swing door 12 to the open position. A ratchet biasing member 40 (shown schematically in FIG. 3D), such as a spring, is provided to normally bias ratchet 32 toward its striker release position. Pawl 34 is movable between a ratchet holding position, whereat pawl 34 holds ratchet 32 in its striker capture position, and a ratchet releasing position whereat pawl 34 permits ratchet 32 to move to its striker release position. A pawl biasing member 42, such as a suitable spring, is provided to normally bias pawl 34 toward its ratchet holding position.

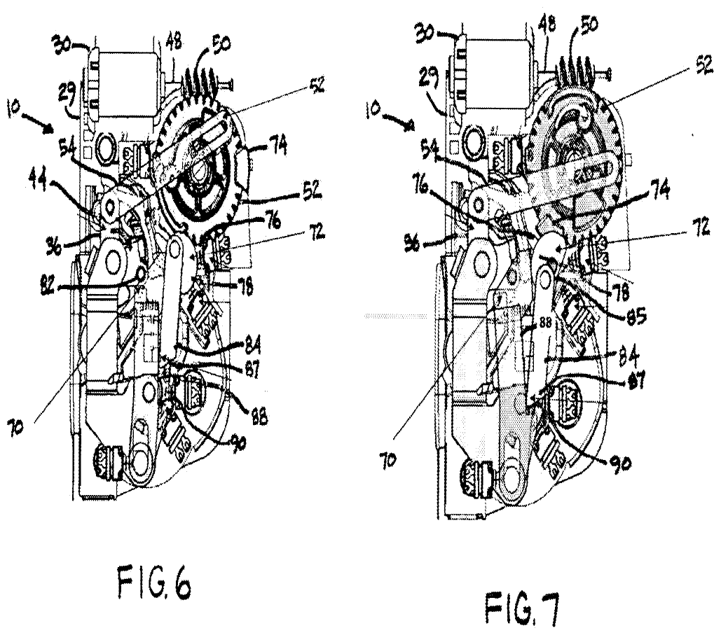

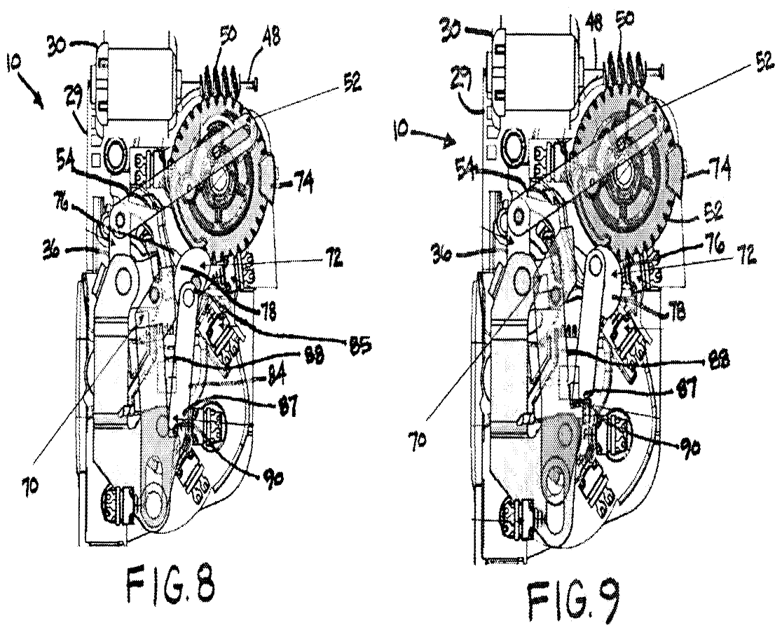

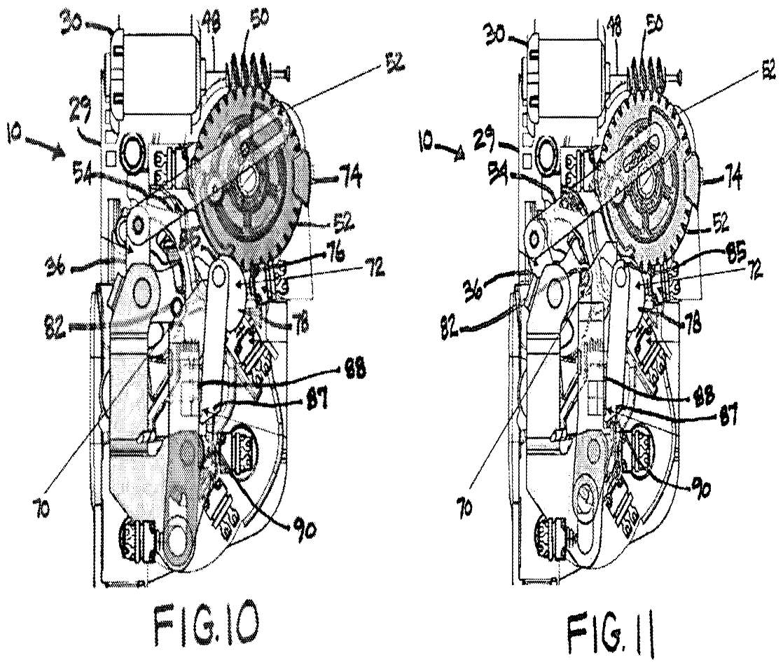

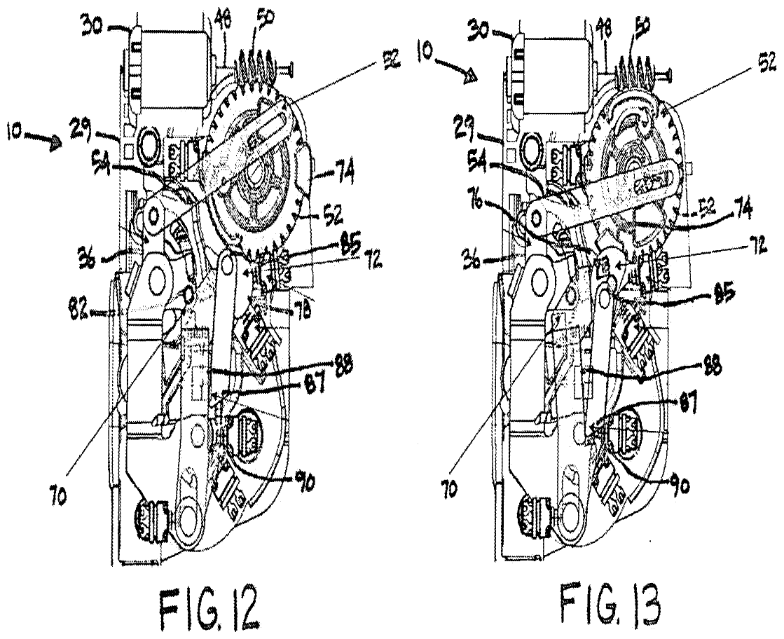

Pawl release lever 36 is operatively (directly or indirectly via another component, such as an intermediate or secondary pawl release lever, and shown as directly, by way of example and without limitation) coupled, also referred to as connected, to pawl 34 and is movable between a deployed position, also referred to as pawl release position, whereat pawl release lever 36 moves pawl 34 against the bias of pawl biasing member 42 to its ratchet releasing position, and a non-deployed position, also referred to as home position, whereat pawl release lever 36 permits pawl 34 to be in its ratchet holding position. A pawl release lever biasing member 44 (FIGS. 3A and 6), such as a suitable spring, can be provided to normally bias pawl release lever 36 to its home position.

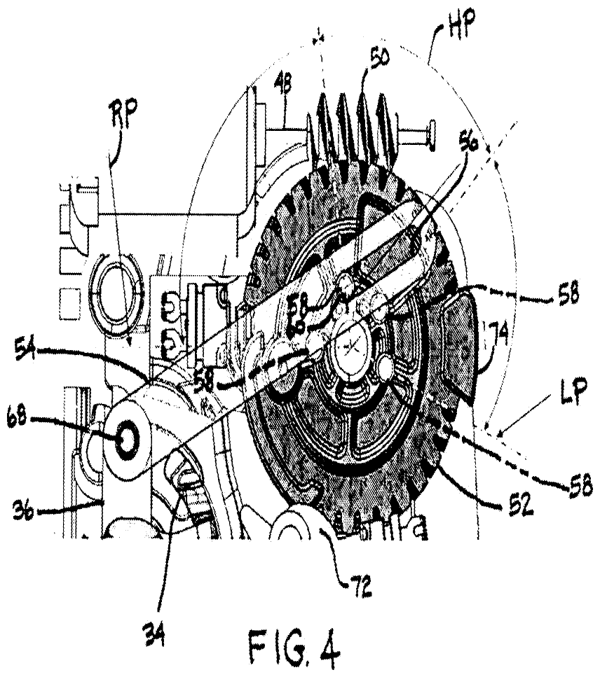

Pawl release lever 36 can be moved in a normal powered actuation to its pawl release position via selective powered actuation of power release actuator 30. Power release actuator 30 has an output, shown as being provided by an output member, also referred to as output shaft 48, with a power release gear 52 configured in meshed engagement with an output gear, also referred to a main drive gear or drive gear 50, wherein drive gear 50 is shown as a worm gear mounted on output shaft 48 and fixed for conjoint rotation with the output shaft 48 of power release actuator 30. Driven movement of power release gear 52 from a home position (HP) in a first direction (counterclockwise, as viewed in FIG. 4) to a full travel release position (RP) is configured to move pawl release lever 36 to its pawl release position, whereat pawl 34 is moved to its ratchet releasing position.

When desired to move pawl 34 from the (its) ratchet holding positon to the (its) ratchet releasing position during normal use conditions, such as when a person approaches motor vehicle 14 with electronic key fob 28 (FIG. 2) and actuates the outside door handle 26, for example, sensing both the presence of key fob 28 and that outside door handle 26 has been actuated (e.g. via electronic communication between an electronic switch 62 (FIG. 2, wherein inside door handle 24 also is actuatable via an electronic switch 63) and a latch electronic control unit (ECU) shown at 64 that at least partially controls the operation of latch assembly 10). In turn, latch ECU 64 actuates (energizes) power release motor 30 to cause drive gear 50 to be rotatably driven by rotating the output shaft 48 of the power actuator 30 in a first direction, thereby causing power release gear 52 to be rotatably driven from its home position in the first direction to its full travel release position to release the latch mechanism 16 and shift latch assembly 10 into an unlatched operating state so as to facilitate subsequent opening of vehicle swing door 12. Power release motor 30 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 10). In turn, if detecting a normal use condition, such as the presence of electronic key fob 28, by way of example and without limitation, latch ECU 64 actuates power release motor 30 to rotate the output shaft 48 in the first direction to release the latch mechanism 16 and shift latch assembly 10 into an unlatched operating state so as to facilitate subsequent opening of vehicle door 12, as discussed above.

During normal operation, as output shaft 48 is rotated in the first direction, drive gear 50 causes power release gear 52 to rotate in the first direction, whereupon a power release link 54, operably coupling the power release gear 52 with pawl release lever 36, is configured to drive the pawl release lever 36 against the bias of pawl release lever biasing member 44 and move the pawl 34 from the ratchet holding position to the ratchet releasing position when the power release gear 52 is driven from the home position to the full travel release position.

To facilitate the desired movement between power release gear 52 and power release link 54, power release link 54 has an elongate slot 56 (only identified by reference numeral 56 in FIG. 4 to avoid cluttering the FIGS.) and the power release gear 52 has an outwardly extending pin 58 fixed thereto, with pin 58 being disposed in the elongate slot 56 for selective lost-motion translation therein. When the power release gear 52 is driven from its home position HP in the counterclockwise, first direction from the home position HP to the release position RP, pin 58 is moved into engagement with a drive end 60 of the elongate slot 56 and drives the power release link 54 to move the pawl release lever 36 and drive the pawl 34 against the bias of pawl biasing member 42 from the ratchet holding position to the ratchet releasing position, whereat ratchet 32 is free to move to the striker release position under the bias of ratchet biasing member 40.

Then, upon release of power latch assembly 10, ECU 64, upon receiving a signal from a position sensor 67, which can be configured to detect the relative position of power release gear 52, ratchet 32 and/or pawl 34, by way of example and without limitation, signals power release motor 30 to rotate in an opposite direction, thereby causing a reversal in motion of power release gear 52 in a clockwise direction, as viewed in FIG. 4, whereupon pawl release lever 36 is allowed to return to its home position, such as under the bias of pawl release lever biasing member 44, returning pawl 34 to the ratchet holding position. Pawl release lever 36 can be pivotably coupled directly to pawl release link 54, such as via a pin 68.

In addition to the normal power release discussed above, power release gear 52 can be driven from its home position HP in the second direction, clockwise as viewed in FIG. 4, to a full travel lock position, also referred to as the lock position (LP). During movement of the power release gear 52 toward the lock position LP, the pin 58 moves away from the drive end 60 of elongate slot 56 in lost-motion through the elongate slot 56 to place the power latch assembly in one of a double pull lock state also referred to illustratively as a second lock state, whereat two manual actuations of the inside release mechanism 24 is required to move the pawl 34 from the ratchet holding position to the ratchet releasing position to manually unlatch the power latch assembly 10, as discussed further below, and a child lock state also referred to illustratively as a first lock state, whereat any number of repeated manual actuations of the inside release mechanism 24 does not move the pawl 34 from the ratchet holding position to the ratchet releasing position, and thus, fails to manually unlatch the power latch assembly 10, thereby preventing the door 12 from being manually opened via inside release mechanism 24 while power latch assembly 10 is in the child lock state.

To facilitate manual actuation of power latch assembly 10 from the inside release mechanism 24, an inside lock link, also referred to as inside release link 70, is configured for driven movement via a cable 71 (FIGS. 3B and 3C) as cable 71 is pulled by inside release mechanism 24. Cable 71 moves an inside release lever 73, shown as being rotatably pivoted about a pin, whereupon inside release lever 73 engages and drives inside release link 70 to translate inside release link 70 from a rest, also referred to as home position, to a deployed position in response to mechanical actuation of the inside release mechanism 24. While inside release link 70 is in an unlock position, such as shown in FIG. 6, inside release link 70 is configured for operable communication to engage and move pawl release lever 36, upon inside release link 70 being moved to its deployed position, such that pawl 34 is moved from its ratchet holding position to its ratchet releasing position. In contrast, while inside release link 70 is in a lock position, such as shown in FIG. 7, inside release link 70 is out of operable communication from pawl release lever 36, such that inside release link 70 is unable to engage and move pawl release lever 36 upon being moved to its deployed position, and thus, pawl 34 is prevented from being moved from its ratchet holding position to its ratchet releasing position.

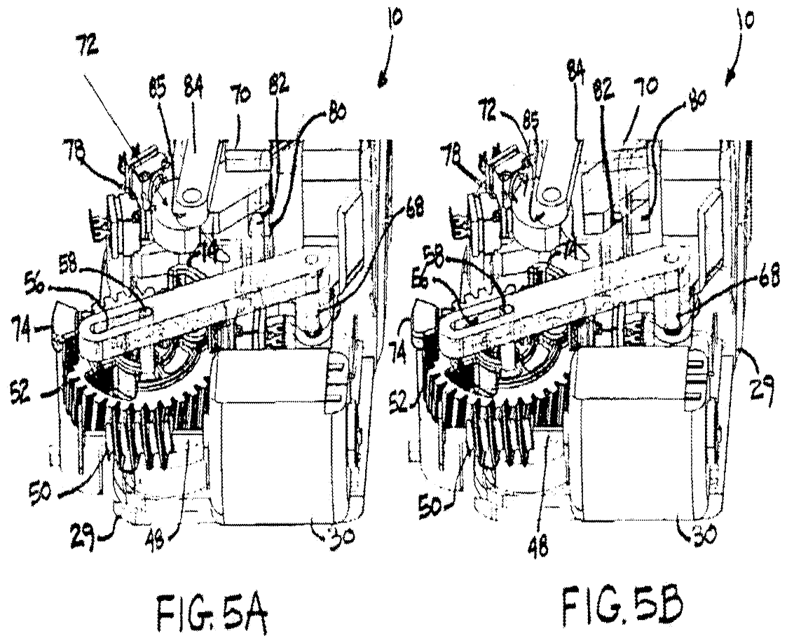

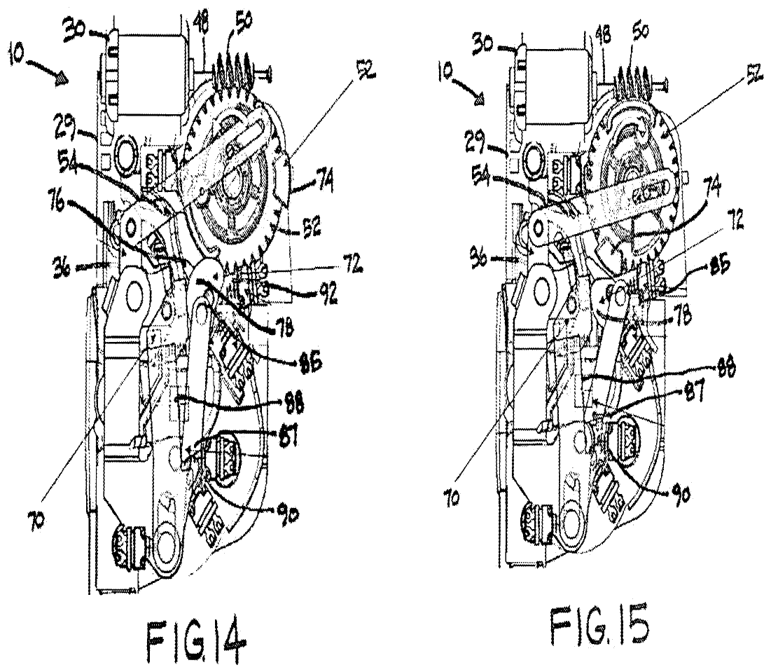

To facilitate moving inside release link 70 between its unlock and lock positions, a cam, also referred to as inside lock cam 72, is configured for movement between a cam unlock position (FIG. 6), whereat the inside release link 70 is aligned for operable engagement with the pawl release lever 36; a cam double pull lock position (FIGS. 7 and 8), whereat the inside release link 70 is misaligned from operable engagement with the pawl release lever 36 during a first mechanical actuation of the inside release mechanism 24; and a cam child lock position (FIGS. 15-17), whereat the inside release link 70 remains misaligned from operable engagement with the pawl release lever 36 for any number of mechanical actuations of the inside release mechanism 24, thus, preventing manual opening of door 12 via inside release mechanism 24 as long as inside lock cam 72 is in its cam child lock position. To facilitate movement of the inside lock cam 72 between the cam unlock position; cam double pull lock position; and the cam child lock position, the inside cam lock 72 is configured for engagement by a drive member, also referred to as lug 74, of the power release gear 52 when the power release gear 52 is driven a first time from its home position HP in the second direction (clockwise) to the lock position LP, whereupon the inside lock cam 72 is driven to the cam double pull lock position (FIGS. 7 and 8). When the inside lock cam 72 is in its unlock position, and as the power release gear 52 is driven a first time from its home position HP in the second direction to the lock position LP, lug 74 engages a first protrusion, also referred to as first arm 76 to rotate inside lock cam 72 in a counterclockwise direction, as viewed in FIGS. 6-8. As inside lock cam 72 is rotated via engagement with lug 74 of power release gear 52, an eccentric, bulbous cam lobe 78 engages a surface of inside release link 70 to push a drive surface, also referred to as drive face 80 (FIGS. 5A and 5B), of inside release link 70 from aligned relation with a driven member, also referred to as driven lug 82 of pawl release lever 36, whereat inside release link 70 is in the unlock position (FIG. 5A), out from alignment with the driven lug 82, whereat inside release link 70 is in the lock position (FIG. 5B). Driven lug 82 is shown, by way of example and without limitation, as an upstanding pin or protrusion fixed to pawl release lever 36. Upon inside release link 70 being moved to the lock position, and inside lock cam 72 being moved to the cam double pull lock position (FIGS. 7 and 8), power release gear 52 is able to be rotated back in the counterclockwise direction (FIG. 8) from the full travel lock position LP to the home position HP.

While the inside lock cam 72 is rotated to the cam double pull lock position, a double pull lever, also referred to as double pull link 84, having a first end 85 pivotably coupled directly to the inside lock cam 72 for conjoint movement therewith, has a second end 87 configured for operable engagement with the inside release link 70. Double pull link 84 is biased via a double pull link biasing member, such as a torsion spring member shown schematically at 86 (FIG. 2), to bring second end 87 of double pull link 84, opposite the first end 85 pivotally connected to inside lock cam 72, into engagement with a recessed surface 88 of inside release link 70, wherein recessed surface terminates at a drive shoulder 90. While the inside lock cam 72 is in the cam double pull lock position, during a first mechanical actuation of the inside release mechanism 24, the inside lock cam 72 is driven by the double pull link 84, via engagement of the drive shoulder 90 with second end 87, to the cam unlock position, whereat the drive face 80 of inside release link 70 is brought into aligned relation for operable engagement with the driven lug 82 of pawl release lever 36 upon completion of the first mechanical actuation of the inside release mechanism 24. It can be seen that the double pull link 84, upon driving the inside lock cam 72, causes the cam lobe 78 to rotate out from cammed engagement with inside release link 70, thereby causing inside release link 70 to be moved back to its unlock position. As such, during a second mechanical actuation of the inside release mechanism 24, the inside release link 70 is driven such that the drive face 80 of inside release link 70 forcibly engages driven lug 82 of pawl release lever 36 to cause pawl release lever 36 to drive the pawl 34 from the ratchet holding position to the ratchet releasing position, thereby allowing ratchet 32 to move from the striker capture position to the striker releasing position. Accordingly, a double mechanical actuation of inside release mechanism 24 while inside lock cam 72 is in the double pull lock position causes power latch assembly 10 to move from the latch closed position to the latch released position.

While the inside lock cam 72 is in the cam double pull lock position, a second arm 92 of the inside lock cam 72, extending generally from an opposite side of inside lock cam 72 from first arm 76, is configured for engagement by the lug 74 of the power release gear 52 when the power release gear 52 is driven a second time from its home position HP in the second direction to the lock position LP, whereupon the inside lock cam 72 is driven to the cam child lock position (FIG. 15). Upon rotation of inside lock cam 72 to the child lock position, the bulbous cam lobe 78 maintains inside release link 70 out from alignment with the driven lug 82 in the lock position (FIG. 5B). As inside lock cam 72 is further rotated, the second end 87 of double pull link 84 is pulled along the recessed surface 88 of inside release link 70 away from drive shoulder 90, thereby creating a space between drive shoulder 90 and second end 87 of double pull link 84. As such, while the inside lock cam 72 is in the child lock position, during repeated mechanical actuation of the inside release mechanism 24, associated translating movement of inside release link 70 does not cause movement of inside lock cam 72, as the drive shoulder 90 does not engage the second end 87 of double pull link 84 as discussed above while inside lock cam 72 is in the double pull lock position, and thus, the inside lock cam 72 remains in the child lock position.

Then, when desired to return the power latch assembly 10 to the unlocked position, the power release gear 52 can be driven a third time from its home position HP in the second direction to the lock position LP via selective actuation of electric motor 30, whereupon the second arm 92 of inside lock cam 72 is driven by lug 74 to rotate the inside lock cam 72 back to its unlock position.

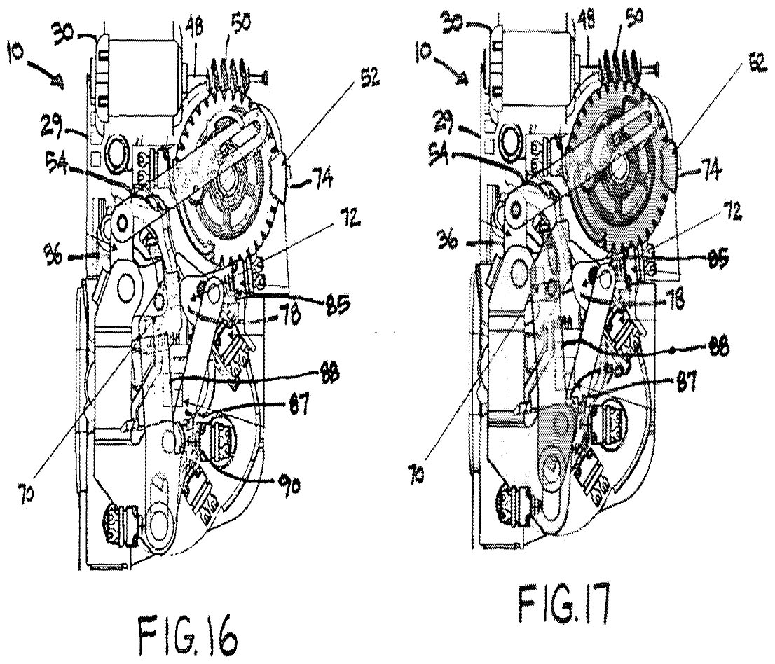

In accordance with another aspect of the disclosure, as illustrated in FIGS. 18-A and 18-B, a method 1000 of performing multiple functions with a single power actuator 30 of a power latch assembly 10 having a ratchet 32 configured for movement between a striker capture position and a striker release position and being biased toward the striker release position, and a pawl 34 configured for movement between a ratchet holding position, whereat the pawl 34 maintains the ratchet 32 in the striker capture position, and a ratchet releasing position, whereat the pawl 34 releases the ratchet 32 for movement of the ratchet 32 to the striker release position, is provided. The method 1000 includes a step 1100 of configuring the single power actuator 30 to selectively move the pawl 34 from the ratchet holding position to the ratchet releasing position when the power latch assembly 10 is in a latch closed, unlocked position. The method 1000 further includes a step 1200 of configuring the single power actuator 30 to selectively place the power latch assembly 10 in a double pull lock state, whereat completion of a first and second mechanical actuation of an inside release mechanism 24, the pawl 34 is moved from the ratchet holding position to the ratchet releasing position. The method 1000 further yet includes a step 1300 of configuring the single power actuator 30 to selectively place the power latch assembly 10 in a child lock state, whereat repeated mechanical actuation of the inside release mechanism 24 fails to move the pawl 34 from the ratchet holding position to the ratchet releasing position.

In accordance with another aspect, the method 1000 can include a step 1400 of arranging a power release gear 52 in operable communication with the single power actuator 30 and configuring the single power actuator 30 to drive the power release gear 52 from a home position, in a first direction, to a release position, whereupon the power release gear 52 operably drives the pawl 34 from the ratchet holding position to the ratchet releasing position, and to drive the power release gear 52 from the home position, in a second direction, to a lock position, whereupon the power release gear 52 operably places the power latch assembly 10 in one of the double pull lock state and the child lock state.

In accordance with another aspect, the method 1000 can include a step 1450 of operably coupling the power release gear 52 to a pawl release lever 36 with a power release link 54, and configuring the power release link 54 to drive the pawl release lever 36 and move the pawl 34 from the ratchet holding position to the ratchet releasing position when the power release gear 52 is driven from the home position to the release position.

In accordance with another aspect, the method 1000 can include a step 1500 of configuring the power release gear 52 and the power release link 54 for lost-motion with one another.

In accordance with another aspect, the method 1000 can include a step 1550 of, while driving the power release gear 52 from its home position in the first direction to the release position, causing a pin 58 disposed in an elongate slot 56 of the power release link 54 to engage a drive end 60 of the elongate slot 56 to drive the power release link 54 to move the pawl release lever 36 and drive the pawl 34 from the ratchet holding position to the ratchet releasing position, and while driving the power release gear 52 from its home position in the second direction to the lock position, causing the pin 58 to move away from the drive end 60 in lost-motion through the elongate slot 56 to place the power latch assembly 10 in one of the double pull lock state and the child lock state.

In accordance with another aspect, the method 1000 can include a step 1600 of arranging an inside release link 70 for driven movement from a rest position to a deployed position in response to mechanical actuation of the inside release mechanism 24, and further including arranging an inside lock cam 72 for movement between a cam unlock position, whereat the inside release link 70 is aligned for operable engagement with the pawl release lever 36, a cam double pull lock position, whereat the inside release link 70 is misaligned from operable engagement with the pawl release lever 36 during a first mechanical actuation of the inside release mechanism 24, and a cam child lock position, whereat the inside release link 70 remains misaligned from operable engagement with the pawl release lever 36 during repeated mechanical actuations of the inside release mechanism 24.

In accordance with another aspect, the method 1000 can include a step 1650 of arranging the inside lock cam 72 to be engaged by a lug 74 of the power release gear 52 and moved to the cam double pull lock position when the power release gear 52 is driven a first time from its home position in the second direction to the lock position.

In accordance with another aspect, the method 1000 can include a step 1700 of configuring the inside lock cam 72, while in the cam double pull lock position, to be engaged by the lug 74 of the power release gear 52 and moved to the cam child lock position when the power release gear 52 is driven a second time from its home position in the second direction to the lock position.

In accordance with another aspect, the method 1000 can include a step 1750 of coupling a double pull link 84 to the inside lock cam 72 and arranging the double pull link 84 to be selectively driven by the inside release link 70 while the inside lock cam 72 is in the cam double pull lock position, such that upon completing a first mechanical actuation of the inside release mechanism 24, the double pull link 84 drives the inside lock cam 72 to the cam unlock position and the inside release link 70 becomes aligned for operable engagement with the pawl release lever 36, and upon completing a second mechanical actuation of the inside release mechanism 24, the inside release link 70 moves the pawl release lever 36 and drives the pawl 34 to move from the ratchet holding position to the ratchet releasing position.

In accordance with another aspect, the method 1000 can include a step 1800 of arranging the double pull link 84 to remain free from driven engagement with the inside release link 70 while the inside lock cam 72 is in the cam child lock position, such that during repeated mechanical actuation of the inside release mechanism 24, the inside lock cam 72 remains in the cam child lock position and the pawl 34 remains in the ratchet holding position.

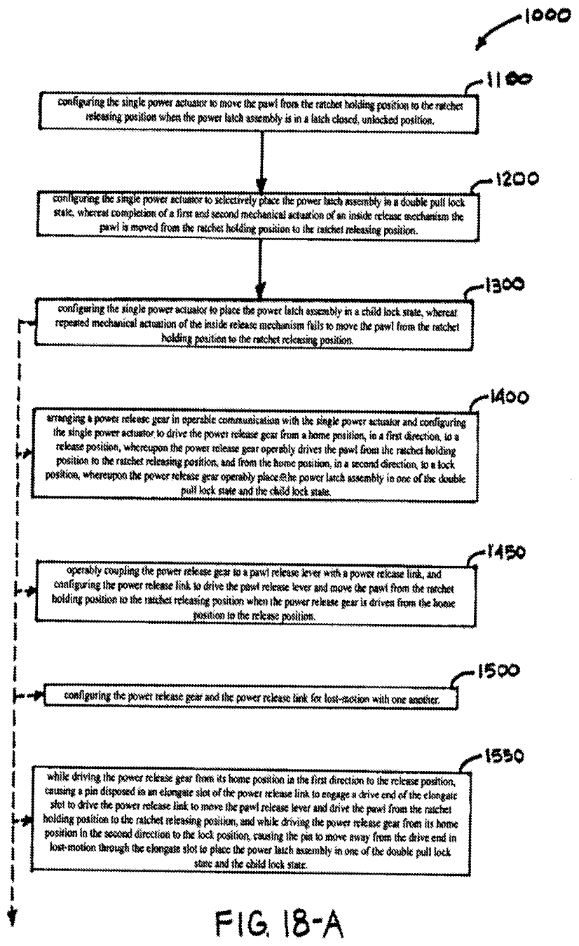

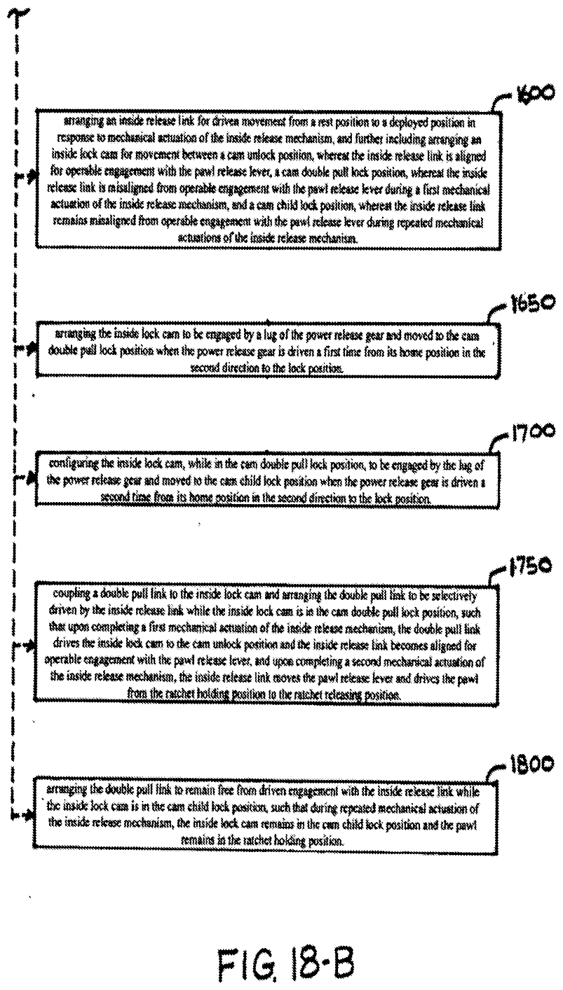

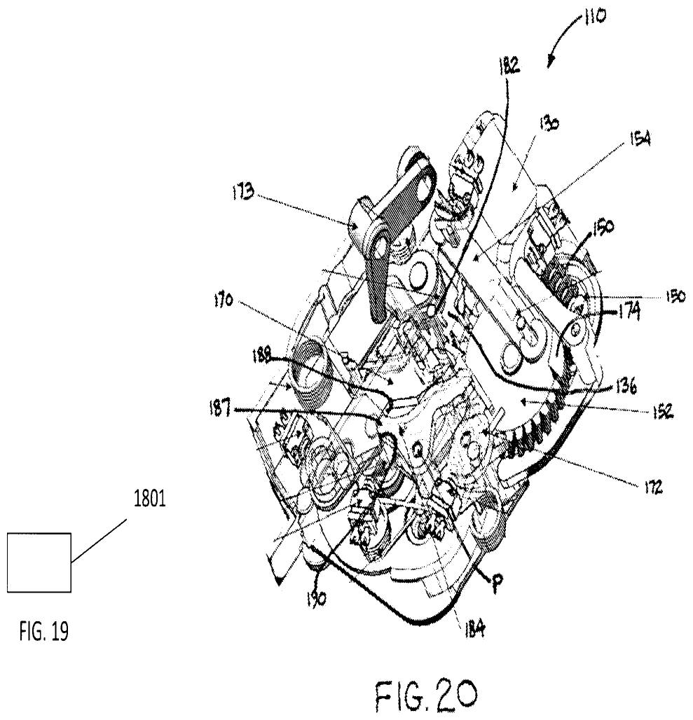

FIG. 19 details some functions 1801 of another non-limiting embodiment of latch assembly 110 (FIG. 20), wherein the same reference numerals, offset by a factor of 100, have been used to identify like features, with some components removed for clarity purposes only. Latch assembly 110 has a latch mechanism 116 including a ratchet 132 and a pawl 134, and a release lever, also referred to as release link, pawl release link, or pawl release lever 136. Ratchet 132 functions as discussed above for ratchet 32, wherein a ratchet biasing member 140 (shown schematically in FIG. 21D), such as a spring, is provided to normally bias ratchet 132 toward its striker release position. Pawl 134 functions as discussed above for pawl 34, wherein a pawl biasing member 142, such as a suitable spring, is provided to normally bias pawl 134 toward its ratchet holding position. Functions 1801 include for example a power release function, lock and double lock/power child lock function, and double pull mechanical release from locked state function which may be facilitated by a one motor design as described using the example configurations herein.

Pawl release lever 136 is operatively (directly or indirectly via another component, such as an intermediate or secondary pawl release lever, and shown as directly, by way of example and without limitation) coupled, also referred to as connected, to pawl 134 and is movable between a deployed position, also referred to as pawl release position, whereat pawl release lever 136 moves pawl 134 against the bias of pawl biasing member 142 to its ratchet releasing position, and a non-deployed position, also referred to as home position, whereat pawl release lever 136 permits pawl 134 to remain or return to its ratchet holding position in biased engagement with ratchet 132 via the bias imparted by pawl biasing member 142. A pawl release lever biasing member 144 (FIGS. 3A and 6), such as a suitable spring, can be provided to normally bias pawl release lever 136 to its home position.

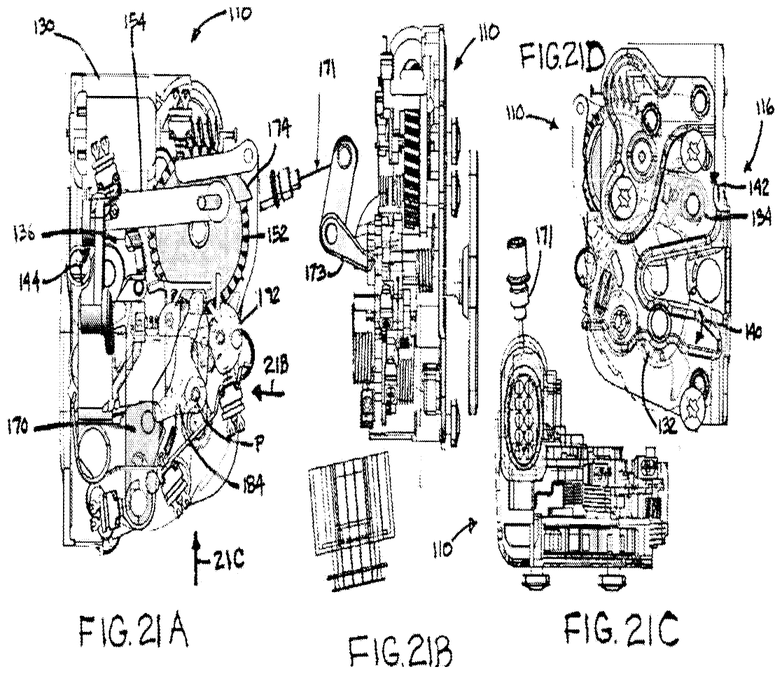

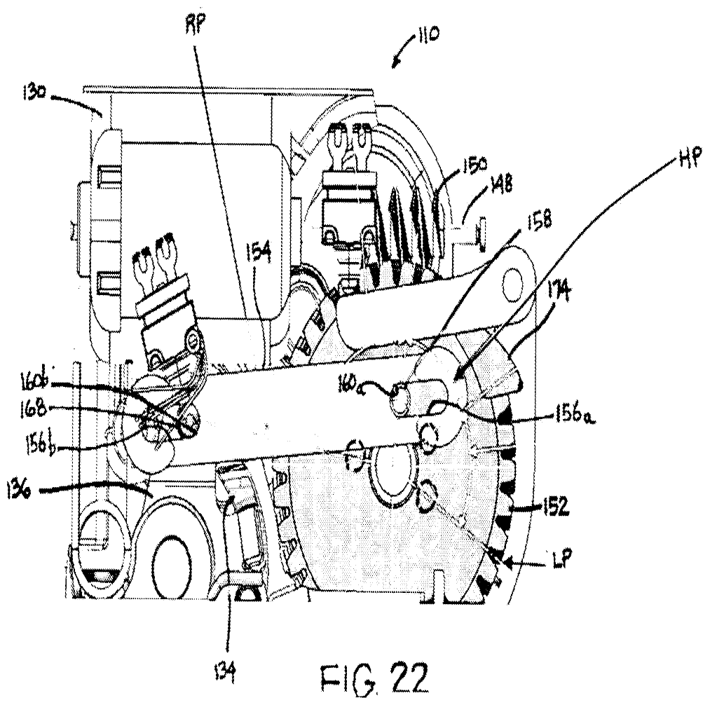

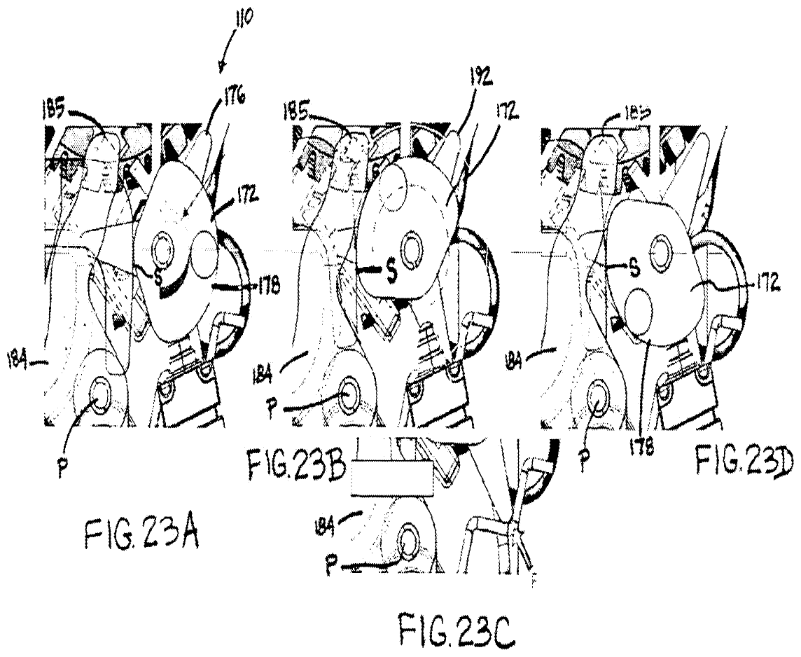

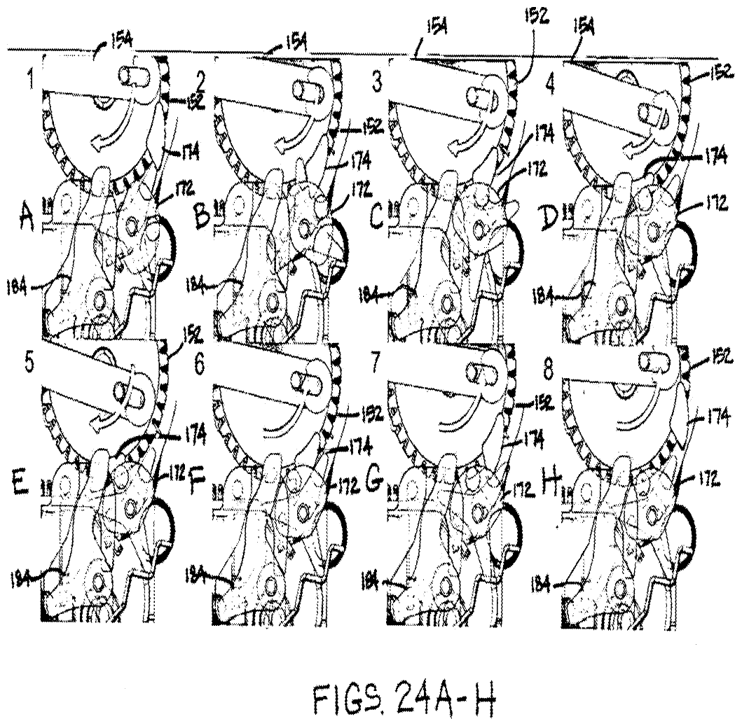

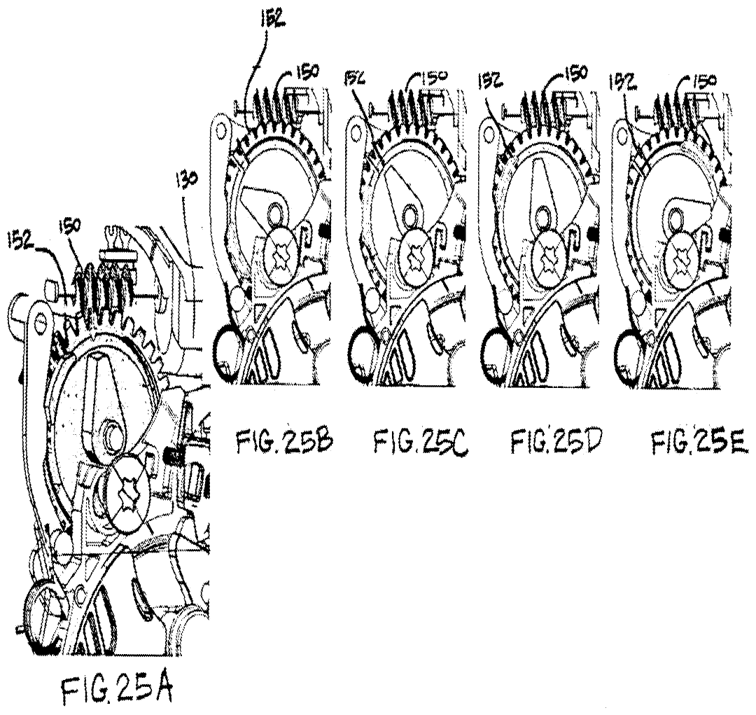

Pawl release lever 136 can be moved in a normal powered actuation to its pawl release position via selective powered actuation of power release actuator 130. Power release actuator 130 has an output, shown as an output shaft 48, with a power release gear 152 configured in meshed engagement with an output gear, also referred to a main drive gear or drive gear 150, as discussed above for drive gear 50 and power release gear 52. Driven movement of power release gear 152 from a home position (HP) in a first direction (counterclockwise, as viewed in FIG. 22) to a full travel release position (RP) is configured to move pawl release lever 136 to its pawl release position, whereat pawl 134 is moved to its ratchet releasing position and ratchet 132 is free to move under the bias of ratchet biasing member 140 to the striker release position.

When desired to move pawl 134 from the (its) ratchet holding positon to the (its) ratchet releasing position during normal use conditions, electronic key fob 28 (FIG. 2), electronic switch 62, electronic switch 63 and latch electronic control unit (ECU) 64 can operably communication with one another, as discussed above, to control the operation of latch assembly 110. As such, when desired, power release gear 152 can be caused to be rotatably driven from its home position in the first direction to its full travel release position to release the latch mechanism 116 and shift latch assembly 110 into an unlatched operating state so as to facilitate subsequent opening of vehicle swing door 12. Power release motor 130 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 110). In turn, if detecting a normal use condition, such as the presence of electronic key fob 28, by way of example and without limitation, latch ECU 64 actuates power release motor 130 to shift latch assembly 110 into an unlatched operating state so as to facilitate subsequent opening of vehicle door 12, as discussed above.

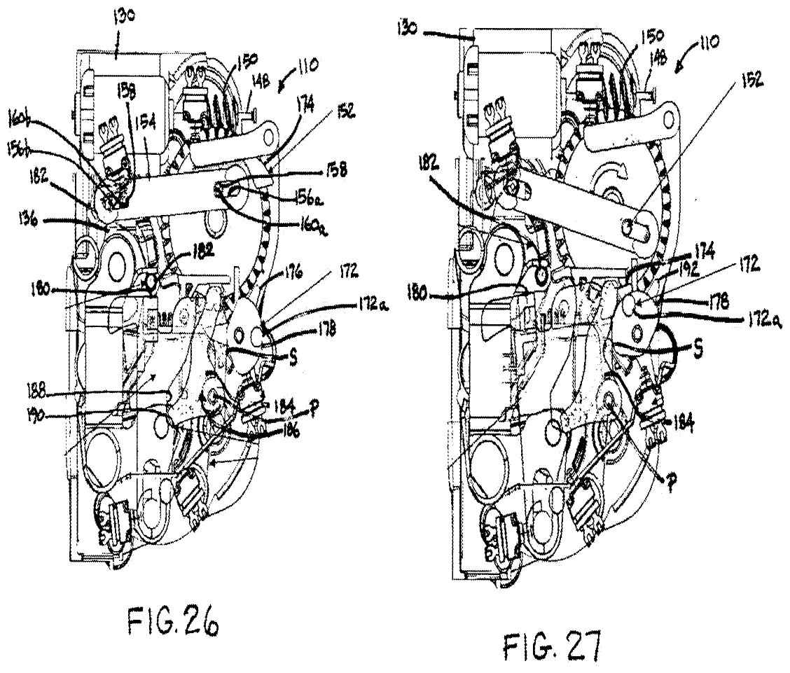

During normal operation, as drive gear 150 causes power release gear 152 to rotate in the first direction (counterclockwise as viewed in FIG. 26), a power release link 154, operably coupling the power release gear 152 with pawl release lever 136, is configured to drive the pawl release lever 136 against the bias of pawl release lever biasing member 144 (FIG. 21A) and move the pawl 134 from the ratchet holding position to the ratchet releasing position when the power release gear 152 is driven from the home position HP to the full travel release position RP.

To facilitate the desired movement between power release gear 152 and power release link 154, power release link 154 has a pair of elongate slots 156a, 156b (only identified by reference numerals in FIG. 26 to avoid cluttering the FIGS.) and the power release gear 152 has an outwardly extending pin 158 fixed thereto, with pin 158 being disposed in the elongate slot 156a for selective lost-motion translation therein. Pawl release lever 136 can be pivotably coupled directly to pawl release link 154, such as via a pin 168 extending from pawl release lever 136 for lost-motion receipt and movement in elongate slot 156b. When the power release gear 152 is driven from its home position HP in the counterclockwise, first direction from the home position HP to the release position RP, as best shown in FIG. 22, pin 158 is moved into engagement with a drive end 160a of the elongate slot 156a and drives the power release link 154, whereupon a drive end 160b of elongate slot 156b engages and drives pin 168 to move the pawl release lever 136 and drive the pawl 134 against the bias of pawl biasing member 142 from the ratchet holding position to the ratchet releasing position, whereat ratchet 132 is free to move to the striker release position under the bias of ratchet biasing member 140.

Then, upon release of power latch assembly 110, ECU 64, upon receiving a signal from a position sensor 67, which can be configured to detect the relative position of power release gear 152, ratchet 132 and/or pawl 134, by way of example and without limitation, signals power release motor 130 to rotate in an opposite direction, thereby causing a reversal in motion of power release gear 152 in a clockwise direction, as viewed in FIG. 26, whereupon pawl release lever 136 is allowed to return to its home position, such as under the bias of pawl release lever biasing member 144, returning pawl 134 to the ratchet holding position.

In addition to the normal power release discussed above, power release gear 152 can be driven from its home position HP in the second direction, clockwise as viewed in FIG. 27, to a full travel lock position, also referred to as the lock position (LP). During movement of the power release gear 152 toward the lock position LP, the pin 158 can move away from the drive end 160a of elongate slot 156a in lost-motion through the elongate slot 156a and pin 158 can move away from the drive end 160b of elongate slot 156b in lost-motion through the elongate slot 156b to place the power latch assembly in one of a double pull lock state, whereat two manual actuations of the inside release mechanism 24 is required to move the pawl 134 from the ratchet holding position to the ratchet releasing position to manually unlatch the power latch assembly 110, as discussed further below, and a child lock state, whereat any number of repeated manual actuations of the inside release mechanism 24 does not move the pawl 134 from the ratchet holding position to the ratchet releasing position, and thus, fails to manually unlatch the power latch assembly 110, thereby preventing the door 12 from being manually opened via inside release mechanism 24 while power latch assembly 110 is in the child lock state.

To facilitate manual actuation of power latch assembly 110 from the inside release mechanism 24, an inside release link 170 is configured for driven movement via a cable 171 (FIGS. 21A and 21C) as cable 171 is pulled by inside release mechanism 24. Cable 171 moves an inside release lever 173, shown as being rotatably pivoted about a pin, whereupon inside release lever 173 engages and drives inside release link 170 to translate inside release link 170 from a rest, also referred to as home position, to a deployed position in response to mechanical actuation of the inside release mechanism 24. While inside release link 170 is in an unlock position, such as shown in FIG. 26, inside release link 170 is configured for operable communication to engage and move pawl release lever 136, upon inside release link 170 being moved to its deployed position, such that pawl 134 is moved from its ratchet holding position to its ratchet releasing position. In contrast, while inside release link 170 is in a lock position, such as shown in FIG. 27, inside release link 170 is moved out of operable communication from pawl release lever 136, such that inside release link 170 is unable to engage pin 182 and move pawl release lever 136 upon being moved to its deployed position, and thus, pawl 134 is prevented from being moved from its ratchet holding position to its ratchet releasing position.

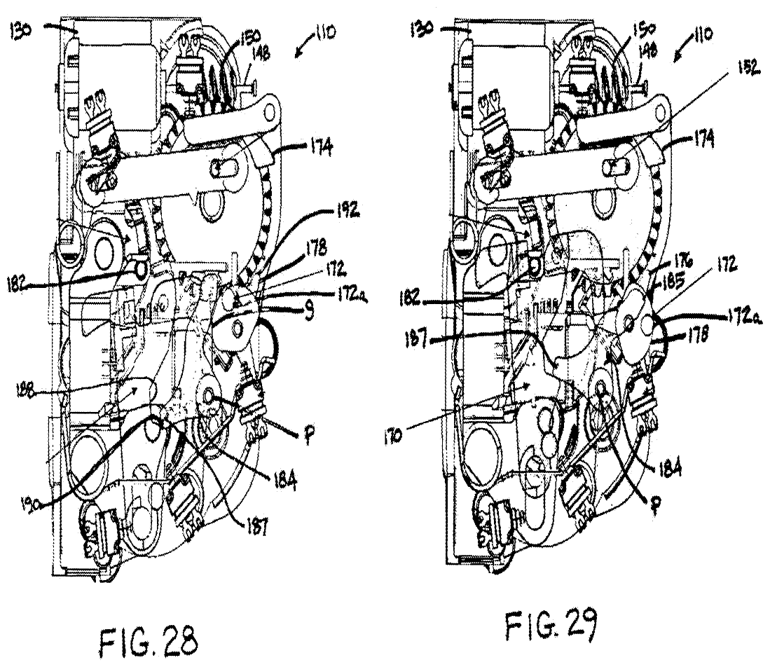

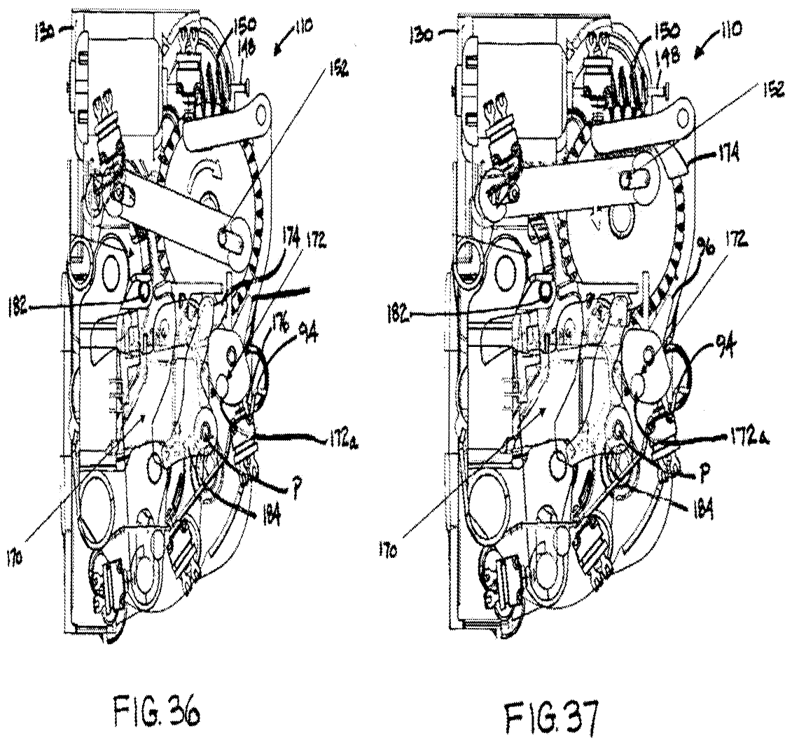

To facilitate moving inside release link 170 between its unlock and lock positions, an inside lock cam 172 is configured for movement between a cam unlock position (FIG. 26), whereat the inside release link 170 is aligned for operable engagement with the pawl release lever 136; a cam double pull lock position (FIGS. 27 and 28), whereat the inside release link 170 is misaligned from operable engagement with the pawl release lever 136 during a first mechanical actuation of the inside release mechanism 24; and a cam child lock position (FIGS. 36-38 and 41-42), whereat the inside release link 170 remains misaligned from operable engagement with the pawl release lever 136 for any number of mechanical actuations of the inside release mechanism 24, thus, preventing manual opening of door 12 via inside release mechanism 24 as long as inside lock cam 172 is in its cam child lock position.

To facilitate movement of the inside lock cam 172 between the cam unlock position; cam double pull lock position; and the cam child lock position, the inside cam lock 172 is configured for engagement by a drive member, also referred to as lug 174, of the power release gear 152 when the power release gear 152 is driven a first time from its home position HP in the second direction (clockwise) to the lock position LP, whereupon the inside lock cam 172 is driven to the cam double pull lock position (FIGS. 27 and 28). When the inside lock cam 172 is in its unlock position, and as the power release gear 152 is driven a first time from its home position HP in the second direction to the lock position LP, lug 174 engages a first protrusion, also referred to as first arm 176 to rotate inside lock cam 172 in a counterclockwise direction, as viewed in FIGS. 26-28. As inside lock cam 172 is rotated via engagement with lug 174 of power release gear 152, an eccentric, bulbous cam lobe 178 engages a surface S of inside release link 170 to push a drive surface, also referred to as drive face 180 (FIG. 26), of inside release link 170 from aligned relation with a driven member, also referred to as driven lug 182 of pawl release lever 136, whereat inside release link 170 is in the unlock position (FIG. 26), out from alignment with the driven lug 182, whereat inside release link 170 is in the lock position (FIG. 27). Driven lug 182 is shown, by way of example and without limitation, as an upstanding pin or protrusion fixed to pawl release lever 136. Upon inside release link 170 being moved to the lock position, and inside lock cam 172 being moved to the cam double pull lock position (FIGS. 27 and 28), power release gear 152 is able to be rotated back in the counterclockwise direction (FIG. 28) from the full travel lock position LP to the home position HP.

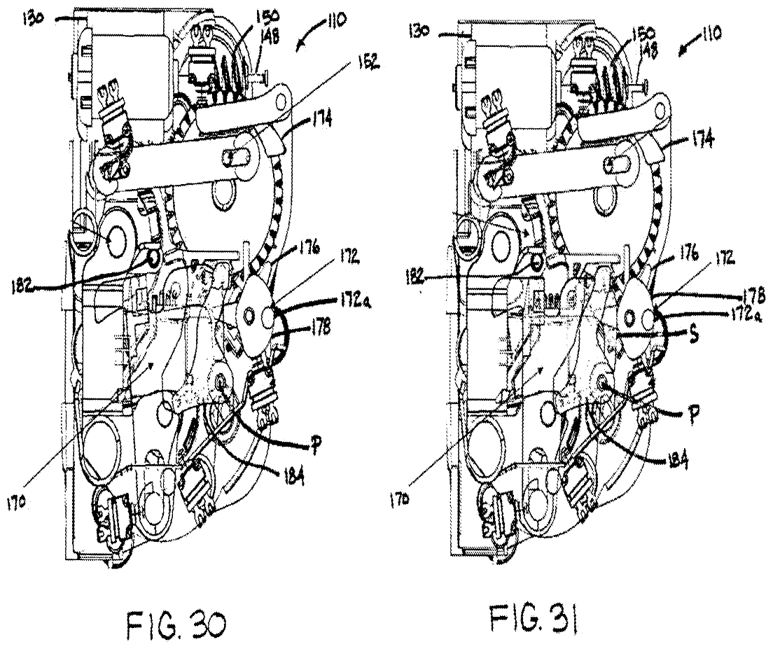

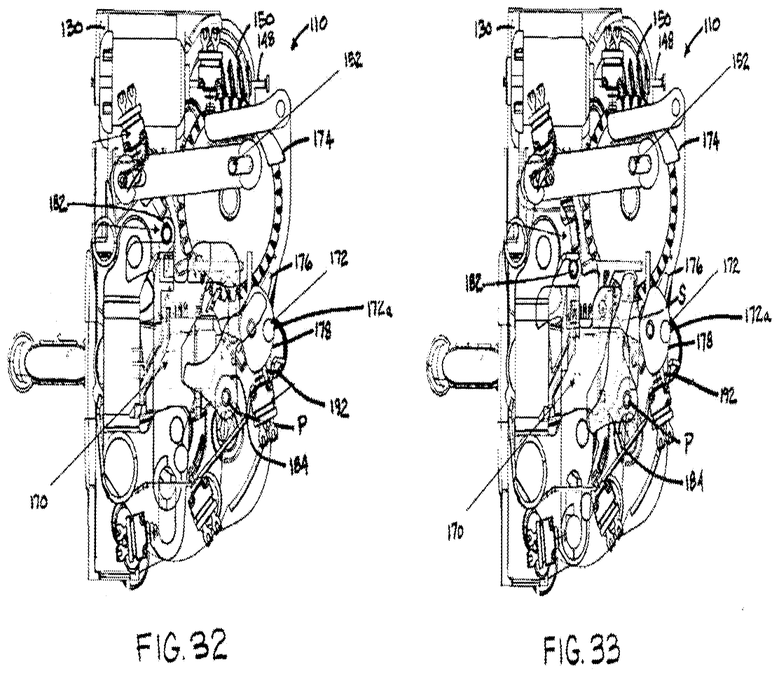

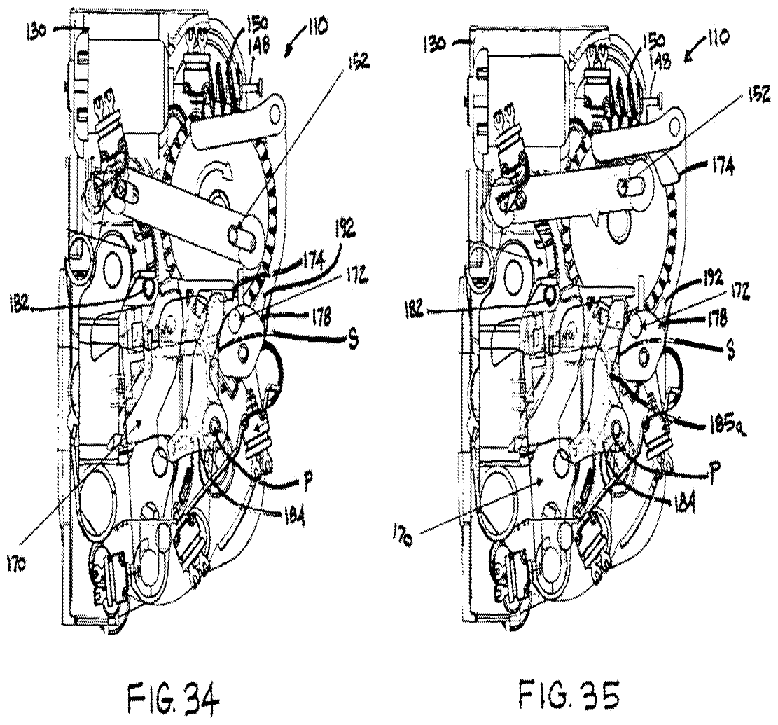

While the inside lock cam 172 is rotated to the cam double pull lock position (lock position), a double pull link, also referred to as double pull member or double pull lever 184, is configured for operable communication with inside lock cam 172 to facilitate movement of inside lock cam 172 from the lock position LP back to the home position HP during a double pull sequence. Double pull lever 184 has a first end 185 configured for operable engagement with inside lock cam 172 and a second end 187 configured for operable engagement with the inside release link 70 (reference numerals for first end 185 and second end 187 are shown primarily in FIG. 29 to avoid cluttering the FIGS.). Double pull link 184 is shown fixed for pivotal movement about a pin P and is biased via a double pull link biasing member, such as a torsion spring member shown schematically at 186 (FIG. 26), to bring and maintain second end 187 of double pull link 184 into engagement with a recessed surface 188 of inside release link 170, wherein recessed surface 188 terminates at a drive shoulder 190. While the inside lock cam 172 is in the cam double pull lock position (FIGS. 27 and 28), during a first mechanical actuation of the inside release mechanism 24 (FIG. 29), a protrusion, also referred to as lug 172a of the inside lock cam 172 is engaged and driven by the first end 185 of double pull lever 184, via engagement of the drive shoulder 190 with second end 187 of double pull lever 184, to move inside lock cam 172 to the cam unlock position, whereat the drive face 180 of inside release link 170 is brought into aligned relation for operable engagement with the driven lug 182 of pawl release lever 136 upon completion of the first mechanical actuation of the inside release mechanism 24 (FIG. 31). It can be seen that the double pull lever 184, upon rotatably driving the inside lock cam 172, causes the enlarged bulbous cam lobe 178 to rotate out from cammed engagement with inside release link 170, thereby causing inside release link 170 to be moved back to its unlock position. As such, during a second mechanical actuation of the inside release mechanism 24 (FIGS. 32 and 33), the inside release link 170 is driven such that the drive face 180 of inside release link 170 forcibly engages driven lug 182 of pawl release lever 136 to cause pawl release lever 136 to drive the pawl 134 from the ratchet holding position to the ratchet releasing position, thereby allowing ratchet 132 to move from the striker capture position to the striker releasing position. Accordingly, a double mechanical actuation of inside release mechanism 24 while inside lock cam 172 is in the double pull lock position causes power latch assembly 110 to move from the latch closed position to the latch released position.

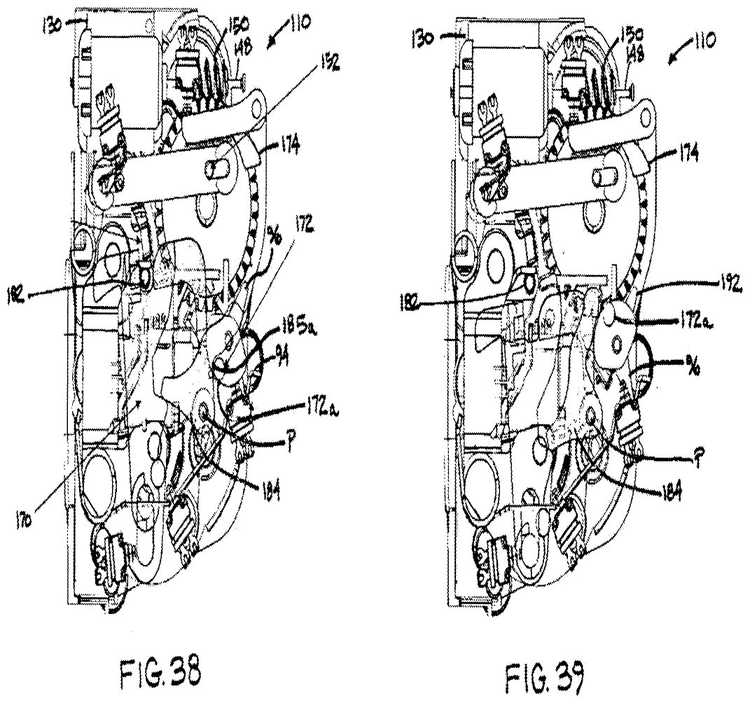

While the inside lock cam 172 is in the cam double pull lock position, a second arm 192 of the inside lock cam 172, extending generally from an opposite side of inside lock cam 172 from first arm 176, is configured for engagement by the lug 174 of the power release gear 152 when the power release gear 152 is driven a second time (FIGS. 36 and 40) from its home position HP in the second direction to the lock position LP, whereupon the inside lock cam 172 is driven to the child lock position (FIGS. 36-38). Upon rotation of inside lock cam 172 to the child lock position, the bulbous cam lobe 178 engages surface S and maintains inside release link 170 out from alignment with the driven lug 182. As inside lock cam 72 remains in the child lock position, which can be facilitated via incorporation of a spring member 94 to impart a bias on first arm 176, the lug 172a of inside lock cam 172 is moved out from possible engagement with the first end 185 of double pull lever 184 as double pull lever 184 is rotated during movement of inside release link 170 from its home position to its deployed position. Spring member 94 can be configured to further facilitate releasably maintaining inside lock cam 172 in lock position and the unlock position via operable communication with third arm 96 and a second arm 192, respectively. In the embodiment illustrated, by way of example and without limitation, an arm of inside lock cam 172 extending to first end 185 has a recessed pocket 185a configured for receipt of lug 172a when inside release link 170 is moved to its deployed position (FIG. 38), such that lug 172a is not driven by the arm extending to first end 185. As such, while the inside lock cam 172 is in the child lock position, during repeated mechanical actuation of the inside release mechanism 24, associated translating movement of inside release link 170 does not cause movement of inside lock cam 172, as the first arm 185 of double pull link 184 does not engage the lug 172a of inside lock cam 172, and thus, the inside lock cam 172 remains in the child lock position.

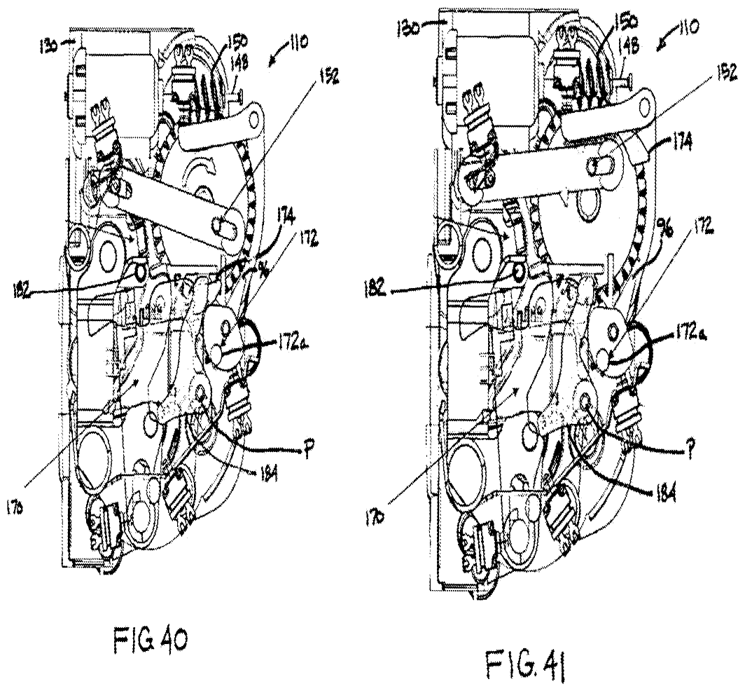

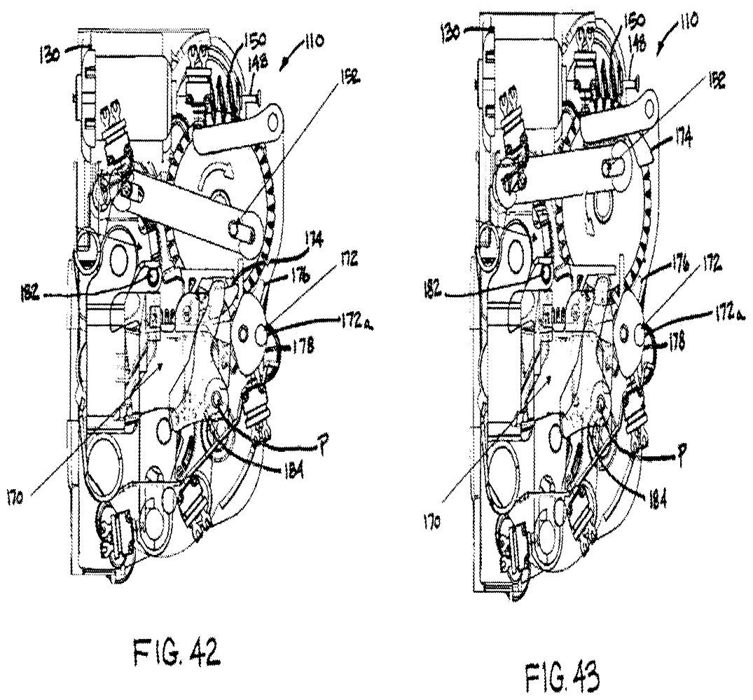

Then, when desired to return the power latch assembly 110 to the unlocked position, as shown in FIGS. 39 and 42, the power release gear 152 can be driven a third time from its home position HP in the second direction to the lock position LP via selective actuation of electric motor 130, whereupon the third arm 96 of inside lock cam 172 is driven by lug 174 to rotate the inside lock cam 172 back to its unlock position.

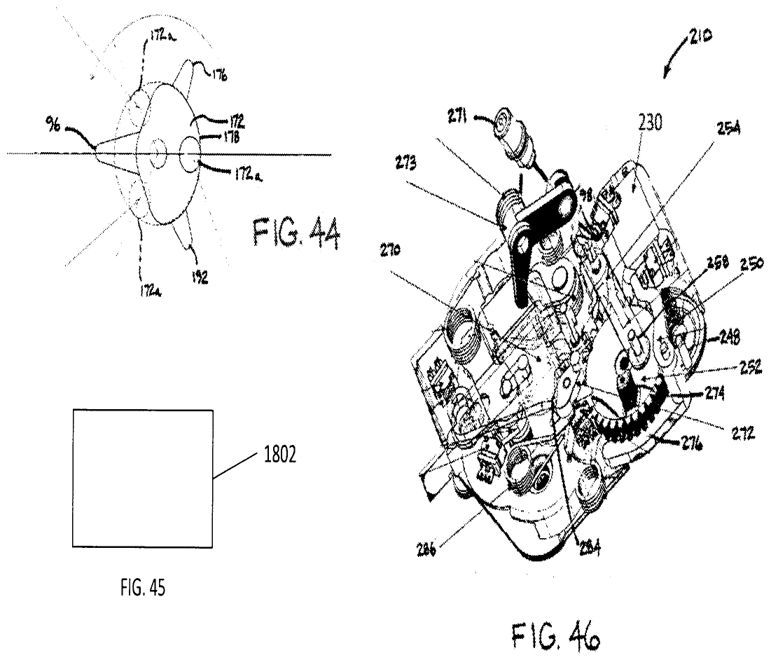

In FIG. 45, various switches 1802, as shown in the accompanying FIGS., with some identified in FIG. 20, can be provided, including ajar, door open, pawl position, ratchet position, inside release, power release gear home, lock switch, child lock switch, by way of example and without limitation, with the various switches being configured in electrical communication with ECU 64 to sense, indicate, and prompt operation of latch assembly 110 as desired to place the latch assembly 110 in the desired position, whether, unlocked, locked, or child lock position.

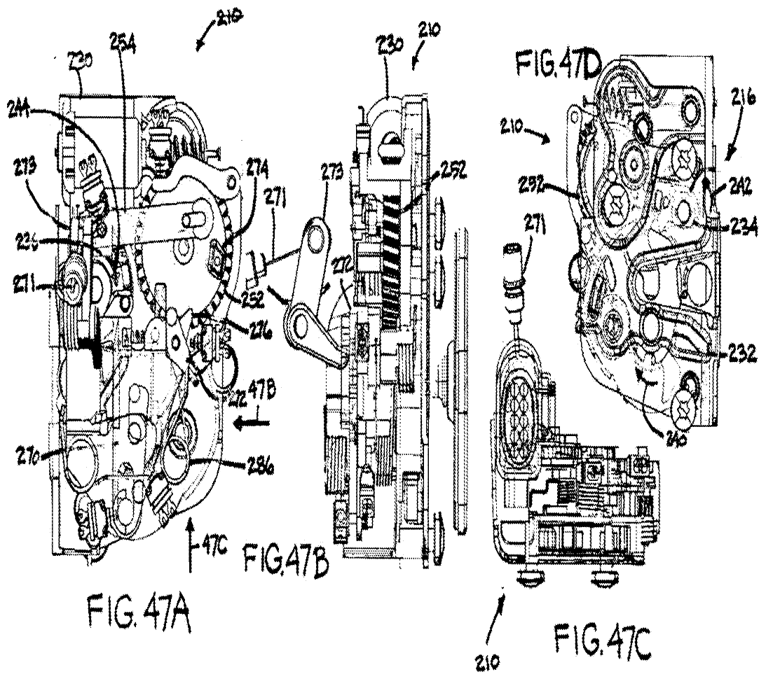

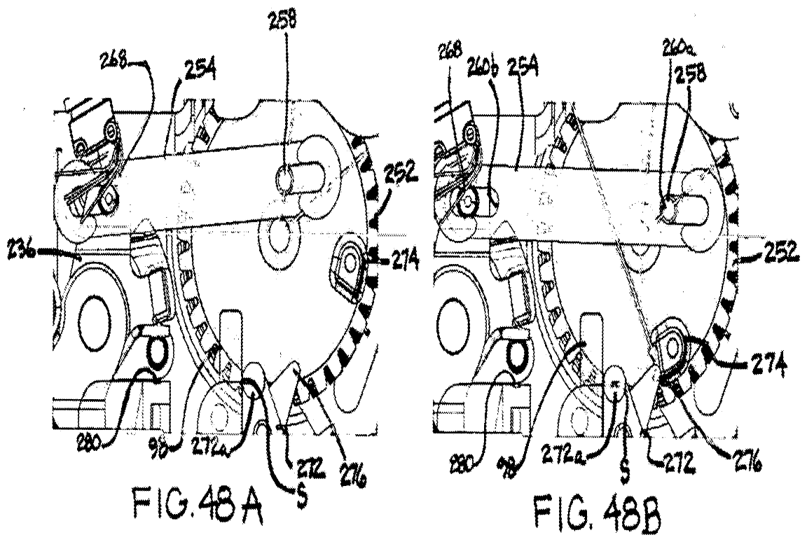

In FIG. 46 another non-limiting embodiment of latch assembly 210 is shown, wherein the same reference numerals, offset by a factor of 200, have been used to identify like features, with some components removed for clarity purposes only. Latch assembly 210 has a latch mechanism 216 (FIG. 47D) including a ratchet 232 and a pawl 234, and a release lever, also referred to as release link, pawl release link, or pawl release lever 236. Ratchet 232 functions as discussed above for ratchet 32, wherein a ratchet biasing member 240 (shown schematically in FIG. 47D), such as a spring, is provided to normally bias ratchet 232 toward its striker release position. Pawl 234 functions as discussed above for pawl 34, wherein a pawl biasing member 242, such as a suitable spring, is provided to normally bias pawl 234 toward its ratchet holding position.

Pawl release lever 236 is operatively (directly or indirectly via another component, such as an intermediate or secondary pawl release lever, and shown as directly, by way of example and without limitation) coupled, also referred to as connected, to pawl 234 and is movable between a deployed position, also referred to as pawl release position, whereat pawl release lever 236 moves pawl 234 against the bias of pawl biasing member 242 to its ratchet releasing position, and a non-deployed position, also referred to as home position, whereat pawl release lever 236 permits pawl 234 to remain or return to its ratchet holding position in biased engagement with ratchet 232 via the bias imparted by pawl biasing member 142. A pawl release lever biasing member 244 (FIGS. 47A and 49), such as a suitable spring, can be provided to normally bias pawl release lever 236 to its home position.

Pawl release lever 236 can be moved in a normal powered actuation to its pawl release position via selective powered actuation of power release actuator 230. Power release actuator 230 has an output, shown as an output shaft 248, with a power release gear 252 configured in meshed engagement with an output gear, also referred to a main drive gear or drive gear 250, as discussed above for drive gear 50 and power release gear 52. Driven movement of power release gear 252 from a home position (HP) in a first direction (counterclockwise, as viewed in FIG. 49) to a full travel release position (RP) is configured to move pawl release lever 236 to its pawl release position, whereat pawl 234 is moved to its ratchet releasing position and ratchet 232 is free to move under the bias of ratchet biasing member 240 to the striker release position.

When desired to move pawl 234 from the (its) ratchet holding positon to the (its) ratchet releasing position during normal use conditions, electronic key fob 28 (FIG. 2), electronic switch 62, electronic switch 63 and latch electronic control unit (ECU) 64 can operably communication with one another, as discussed above, to control the operation of latch assembly 210. As such, when desired, power release gear 252 can be caused to be rotatably driven from its home position HP in the first direction to its full travel release position RP to release the latch mechanism 216 and shift latch assembly 210 into an unlatched operating state so as to facilitate subsequent opening of vehicle swing door 12. Power release motor 230 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 210). In turn, if detecting a normal use condition, such as the presence of electronic key fob 28, by way of example and without limitation, latch ECU 64 actuates power release motor 230 to shift latch assembly 110 into an unlatched operating state so as to facilitate subsequent opening of vehicle door 12, as discussed above.

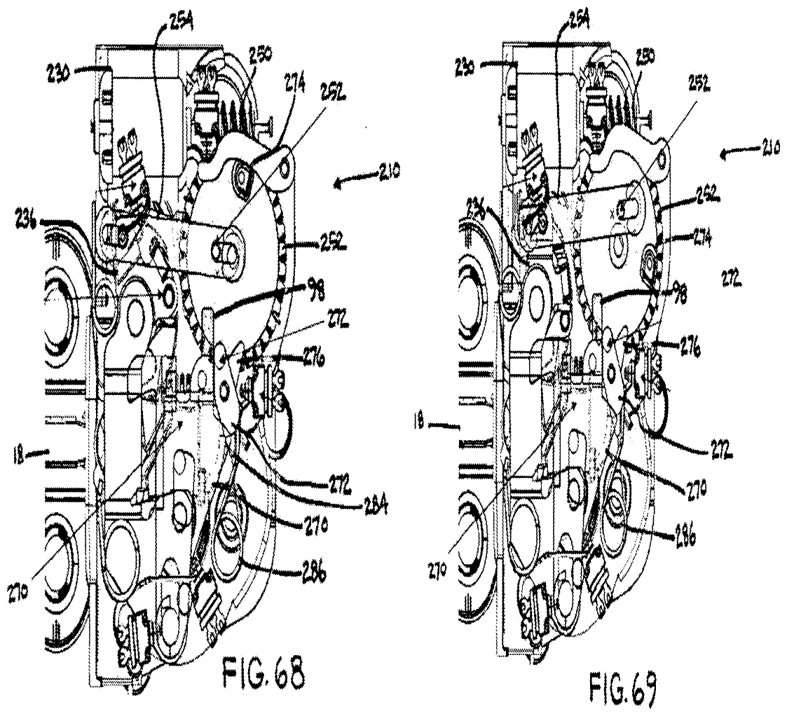

During normal operation, as drive gear 250 causes power release gear 252 to rotate in the first direction (counterclockwise as viewed in FIGS. 51, 67 and 68), a power release link 254, operably coupling the power release gear 252 with pawl release lever 236, is configured to drive the pawl release lever 236 against the bias of pawl release lever biasing member 244 (FIG. 47A) and move the pawl 234 from the ratchet holding position to the ratchet releasing position when the power release gear 252 is driven from the home position HP to the full travel release position RP.

To facilitate the desired movement between power release gear 252 and power release link 254, power release link 254 has a pair of elongate slots 256a, 256b (only identified by reference numerals in FIG. 49 to avoid cluttering the FIGS.) and the power release gear 252 has an outwardly extending pin 258 fixed thereto, with pin 258 being disposed in the elongate slot 256a for selective lost-motion translation therein. Pawl release lever 236 can be pivotably coupled directly to pawl release link 254, such as via a pin 268 extending from pawl release lever 236 for lost-motion receipt and movement in elongate slot 256b. When the power release gear 252 is driven from its home position HP in the counterclockwise, first direction from the home position HP to the release position RP, as best shown in FIG. 49, pin 258 is moved into engagement with a drive end 260a of the elongate slot 256a and drives the power release link 254, whereupon a drive end 260b of elongate slot 256b engages and drives pin 268 to move the pawl release lever 236 and drive the pawl 234 against the bias of pawl biasing member 242 from the ratchet holding position to the ratchet releasing position, whereat ratchet 232 is free to move to the striker release position under the bias of ratchet biasing member 240.

Then, upon release of power latch assembly 210, ECU 64, upon receiving a signal from a position sensor 67, which can be configured to detect the relative position of power release gear 252, ratchet 232 and/or pawl 234, by way of example and without limitation, signals power release motor 230 to rotate in an opposite direction, thereby causing a reversal in motion of power release gear 252 in a clockwise direction, as viewed in FIGS. 51 and 69, whereupon pawl release lever 236 is allowed to return to its home position, such as under the bias of pawl release lever biasing member 244, returning pawl 234 to the ratchet holding position.

In addition to the normal power release discussed above and illustrated in FIGS. 67-69, power release gear 252 can be driven from its home position HP in the second direction, clockwise as viewed in FIG. 52, to a full travel lock position, also referred to as the lock position (LP). During movement of the power release gear 252 toward the lock position LP, the pin 258 can move away from the drive end 260a of elongate slot 256a in lost-motion through the elongate slot 256a and pin 258 can move away from the drive end 260b of elongate slot 256b in lost-motion through the elongate slot 256b to place the power latch assembly 210 in one of a double pull lock state, whereat two manual actuations of the inside release mechanism 24 is required to move the pawl 234 from the ratchet holding position to the ratchet releasing position to manually unlatch the power latch assembly 210, as discussed further below, and a child lock state, whereat any number of repeated manual actuations of the inside release mechanism 24 does not move the pawl 234 from the ratchet holding position to the ratchet releasing position, and thus, fails to manually unlatch the power latch assembly 210, thereby preventing the door 12 from being manually opened via inside release mechanism 24 while power latch assembly 210 is in the child lock state.

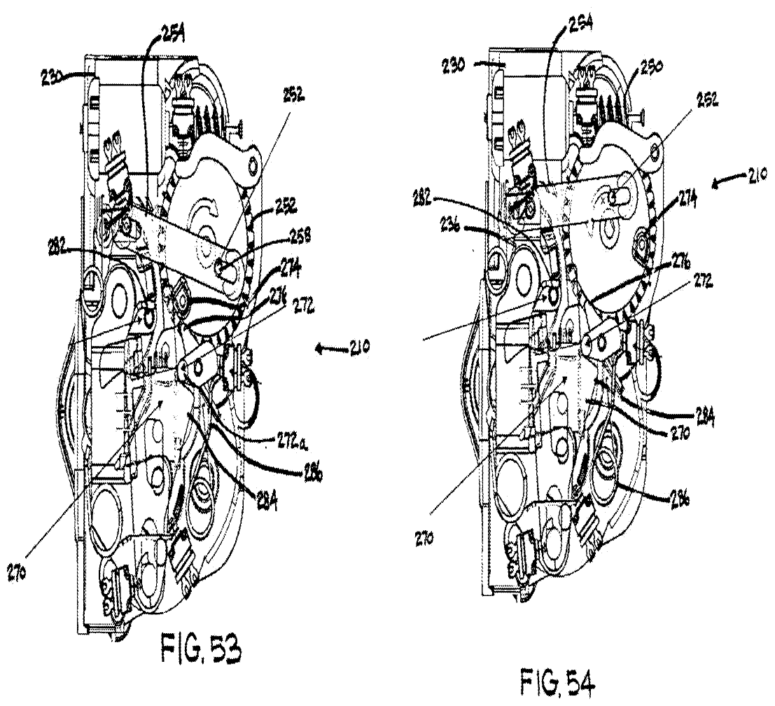

To facilitate manual actuation of power latch assembly 210 from the inside release mechanism 24, an inside release link 270 is configured for driven movement via a cable 271 (FIGS. 46-47C) as cable 271 is pulled by inside release mechanism 24. Cable 271 moves an inside release lever 273, shown as being rotatably pivoted about a pin, whereupon inside release lever 273 engages and drives inside release link 270 to translate inside release link 270 from a rest, also referred to as home position, to a deployed position in response to mechanical actuation of the inside release mechanism 24. While inside release link 270 is in an unlock position, such as shown in FIG. 52, inside release link 270 is configured for operable communication to engage and move pawl release lever 236, upon inside release link 270 being moved to its deployed position, such that pawl 234 is moved from its ratchet holding position to its ratchet releasing position. In contrast, while inside release link 270 is in a lock position, such as shown in FIG. 53, inside release link 270 is moved out of operable communication from pawl release lever 236, such that inside release link 270 is unable to engage pin 282 and move pawl release lever 236 upon being moved to its deployed position, and thus, pawl 234 is prevented from being moved from its ratchet holding position to its ratchet releasing position.

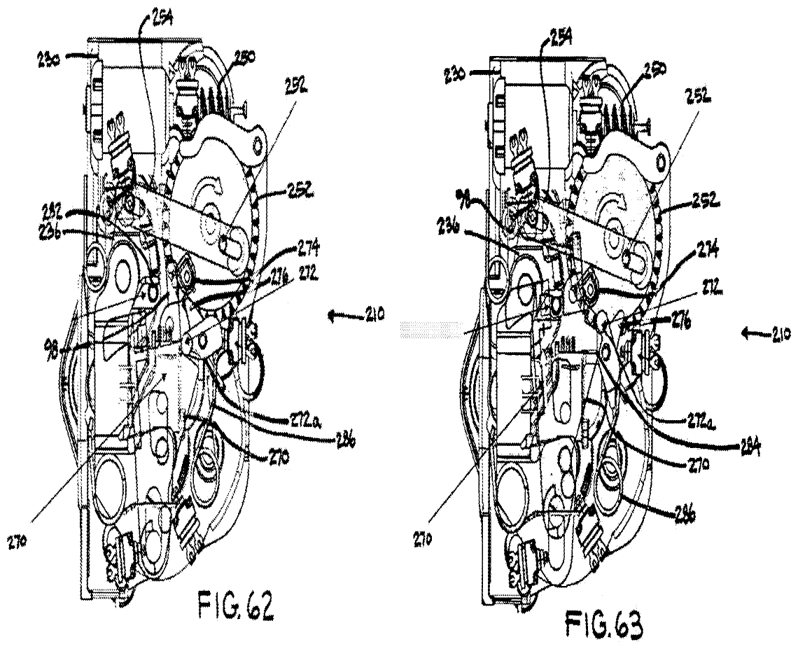

To facilitate moving inside release link 270 between its unlock and lock positions, an inside lock cam 272 is configured for movement between a cam unlock position (FIG. 51), whereat the inside release link 270 is aligned for operable engagement with the pawl release lever 236; a cam double pull lock position (FIGS. 53 and 54), whereat the inside release link 270 is misaligned from operable engagement with the pawl release lever 236 during a first mechanical actuation of the inside release mechanism 24; and a cam child lock position (FIGS. 62-64), whereat the inside release link 270 remains misaligned from operable engagement with the pawl release lever 236 for any number of mechanical actuations of the inside release mechanism 24, thus, preventing manual opening of door 12 via inside release mechanism 24 as long as inside lock cam 272 is in its cam child lock position.

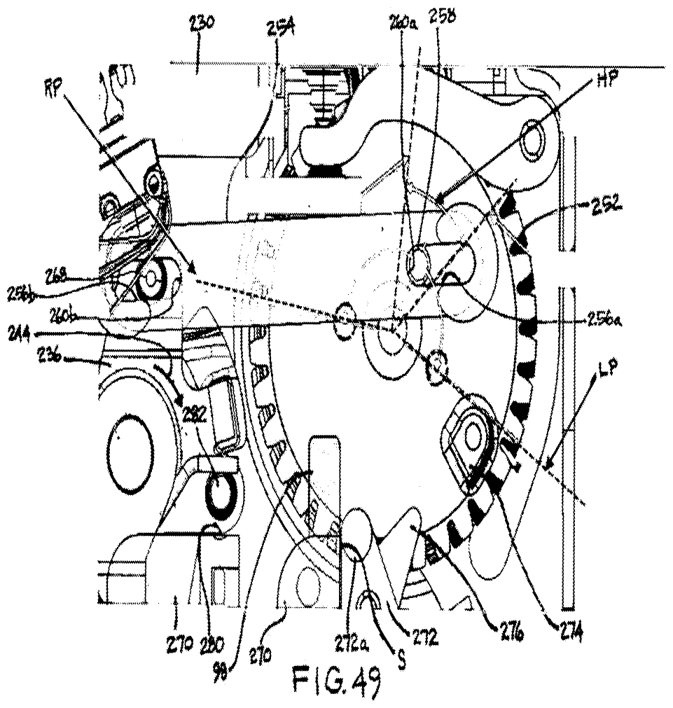

To facilitate movement of the inside lock cam 272 between the cam unlock position; cam double pull lock position; and the cam child lock position, the inside cam lock 272 is configured for engagement by a drive member, also referred to as lug 274, of the power release gear 252 when the power release gear 252 is driven a first time from its home position HP in the second direction (clockwise) to the lock position LP, whereupon the inside lock cam 272 is driven to the cam double pull lock position (FIGS. 53 and 54). When the inside lock cam 272 is in its unlock position, and as the power release gear 252 is driven a first time from its home position HP in the second direction to the lock position LP, lug 274 engages a first protrusion, also referred to as first arm 276 to rotate inside lock cam 272 in a counterclockwise direction, as viewed in FIGS. 52-53. As inside lock cam 272 is rotated via engagement with lug 274 of power release gear 252, a cam lobe 278 engages a surface S (48A-49) of inside release link 270 to push a drive surface, also referred to as drive face 280 (FIG. 48A-49 and 51), of inside release link 270 from aligned relation with a driven member, also referred to as driven lug 282 of pawl release lever 236, whereat inside release link 270 is in the unlock position (FIG. 51), out from alignment with the driven lug 282, whereat inside release link 270 is in the lock position (FIG. 53-54). Driven lug 282 is shown, by way of example and without limitation, as an upstanding pin or protrusion fixed to pawl release lever 236. Upon inside release link 270 being moved to the lock position, and inside lock cam 272 being moved to the cam double pull lock position (FIGS. 53 and 54), power release gear 252 is able to be rotated back in the counterclockwise direction (FIG. 54) from the full travel lock position LP to the home position HP.

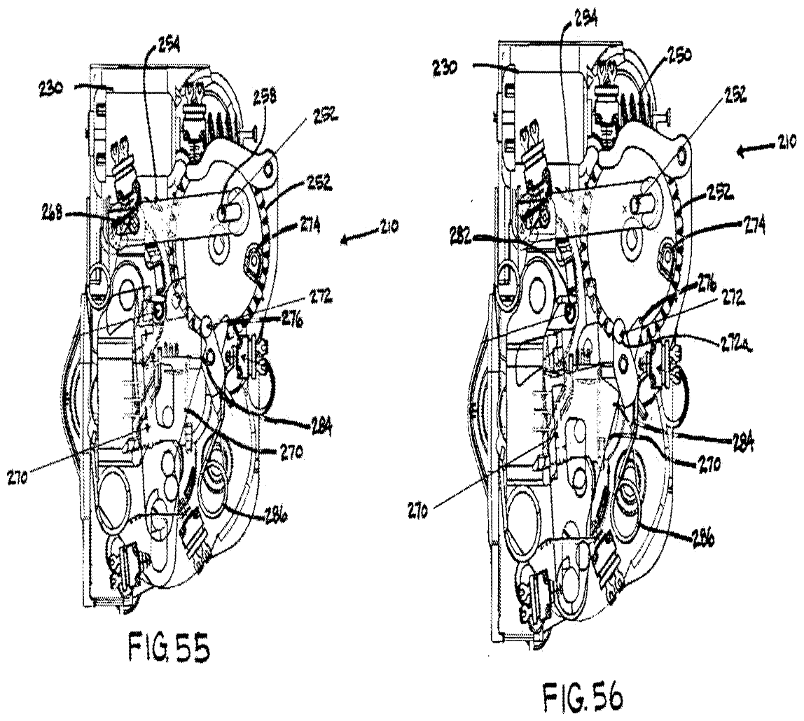

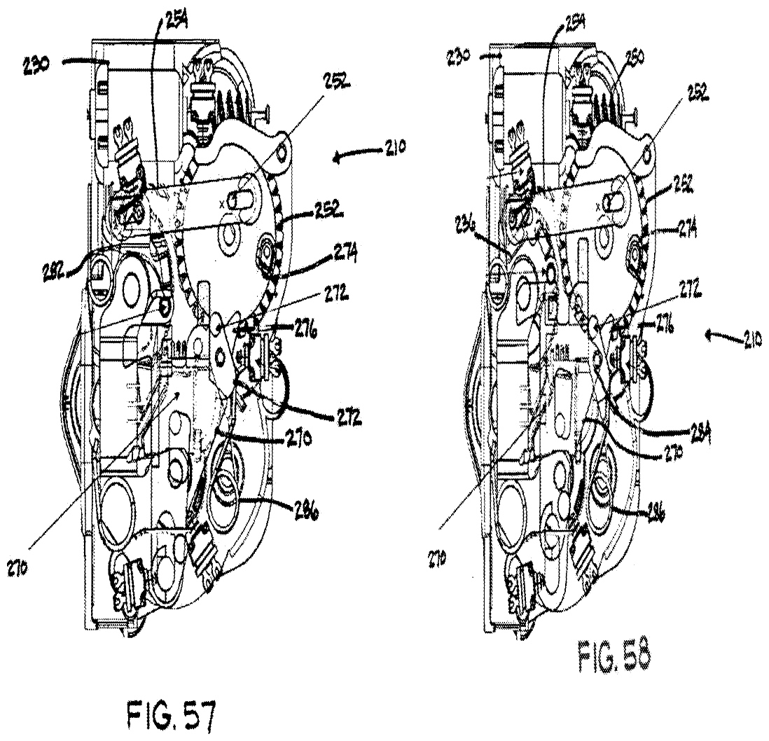

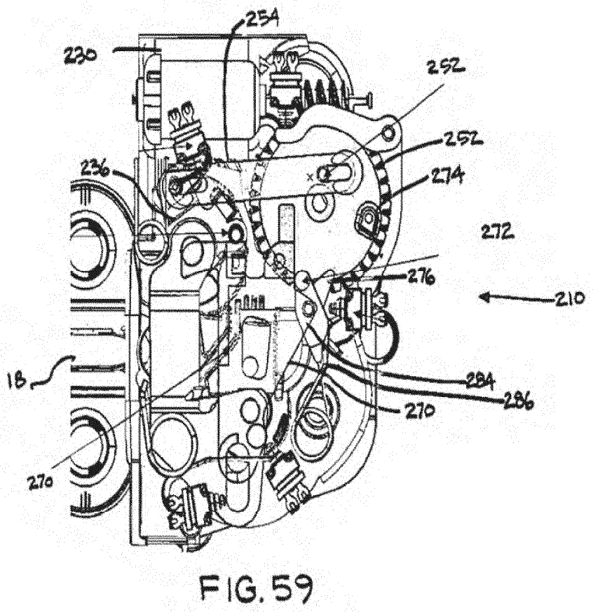

While the inside lock cam 272 is rotated to the cam double pull lock position (lock position), a double pull protrusion, also referred to as double pull lever or double pull member 284, is configured for operable communication with inside lock cam 272 to facilitate movement of inside lock cam 272 from the lock position LP back to the home position HP during a double pull sequence. Double pull member 284 is fixed to inside release link 270, and can be formed as a monolithic piece of material with inside release link 270, wherein double pull member 284 is configured for operable, and shown as direct engagement with inside lock cam 272. Double pull member 284 is shown configured for engagement with a lug 272a of inside lock cam 272 to move inside lock cam 272 between its unlock and lock positions, and is biased to remain in the respective unlock and lock positions via a double pull link biasing member, such as a torsion spring member 286. While the inside lock cam 272 is in the cam double pull lock position (FIGS. 53 and 54), during a first mechanical actuation of the inside release mechanism 24 (FIG. 55), lug 272a of the inside lock cam 272 is engaged and driven by double pull member 284 to move inside lock cam 272 to the cam unlock position, whereat spring member 286 allows toggled movement of inside lock cam 272 from the lock position to the unlock position, such that the drive face 280 of inside release link 270 is brought into aligned relation for operable engagement with the driven lug 282 of pawl release lever 236 upon completion of the first mechanical actuation of the inside release mechanism 24 (FIG. 57). It can be seen that the double pull member 284, upon rotatably driving the inside lock cam 272, causes cam lobe 278 to rotate out from cammed engagement with surface S of inside release link 270, thereby causing inside release link 270 to be moved back to its unlock position. As such, during a second mechanical actuation of the inside release mechanism 24 (FIGS. 58-60), the inside release link 270 is driven such that the drive face 280 of inside release link 270 forcibly engages driven lug 282 of pawl release lever 236 to cause pawl release lever 236 to drive the pawl 234 from the ratchet holding position to the ratchet releasing position, thereby allowing ratchet 232 to move from the striker capture position to the striker releasing position. Accordingly, a double mechanical actuation of inside release mechanism 24 while inside lock cam 272 is in the double pull lock position causes power latch assembly 210 to move from the latch closed position to the latch released position.

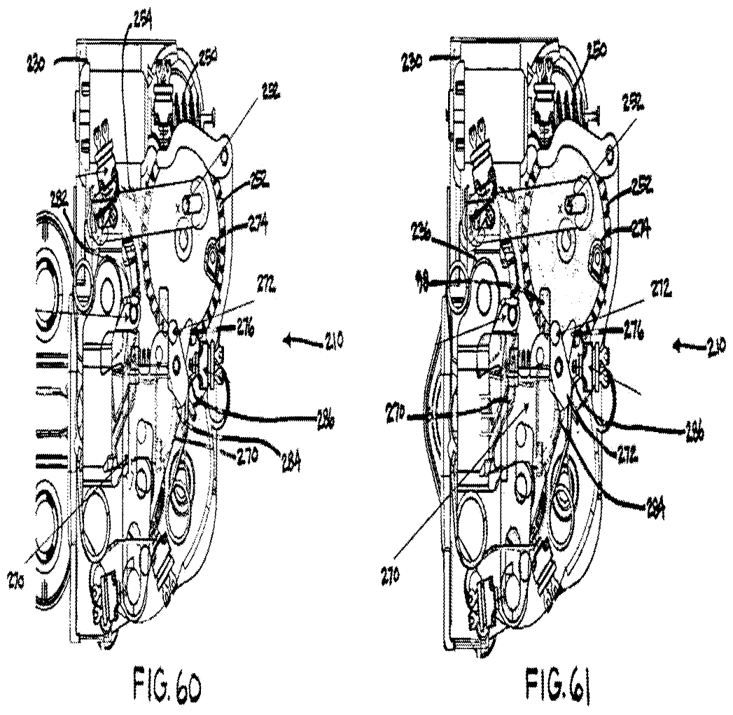

To place latch assembly 210 in the child lock position from the unlock position (FIG. 61), a similar operation is performed as with placing the latch assembly 210 in the lock position (double pull lock position), with a notable difference. Power release gear 252 is driven from its home position HP in the second direction (clockwise) to the lock position LP, whereupon the inside lock cam 272 is driven to the same position as described above for the cam double pull lock position (FIG. 62). Accordingly, lug 274 engages the first arm 276 of inside lock cam 272 to rotate cam lobe 278 into engagement with surface S of inside release link 270 to push drive face 280 of inside release link 270 from aligned relation with driven lug 282 of pawl release lever 236 out from alignment with the driven lug 282. The difference being, rather than rotating power release gear 252 back in the counterclockwise direction from the full travel lock position LP to the home position HP, as done when placing latch assembly 210 in the lock position, power release gear 252 remains in the full travel lock position to effectively place latch assembly 210 in the child lock position. As such, while the inside lock cam 272 is in the child lock position (FIG. 62), during a first mechanical actuation of the inside release mechanism 24 (FIG. 63), lug 272a of the inside lock cam 272 is engaged and driven by the protrusion forming double pull member 284 to toggle inside lock cam 272 back to the cam unlock position, whereat spring member 286 allows the toggled movement of inside lock cam 272 from the lock position to the unlock position and releasably retains inside lock cam 272 in the unlock position. However, in contrast to when in the lock position, the inside release link 270 is not returned under a bias of an inside release link spring (FIG. 46) into aligned relation for operable engagement with the driven lug 282 of pawl release lever 236, but rather, inside release link 270 remains misaligned out from possible engagement with the driven lug 282 due to the influence of lug 274 of power release gear 252 acting on a child lock ledge, also referred to as projection 98, of inside release link 270 (FIG. 64). Accordingly, with projection 98 being engaged by lug 274, any number of actuations of inside release mechanism 24 does not cause pawl 234 to be moved out from its ratchet holding position.

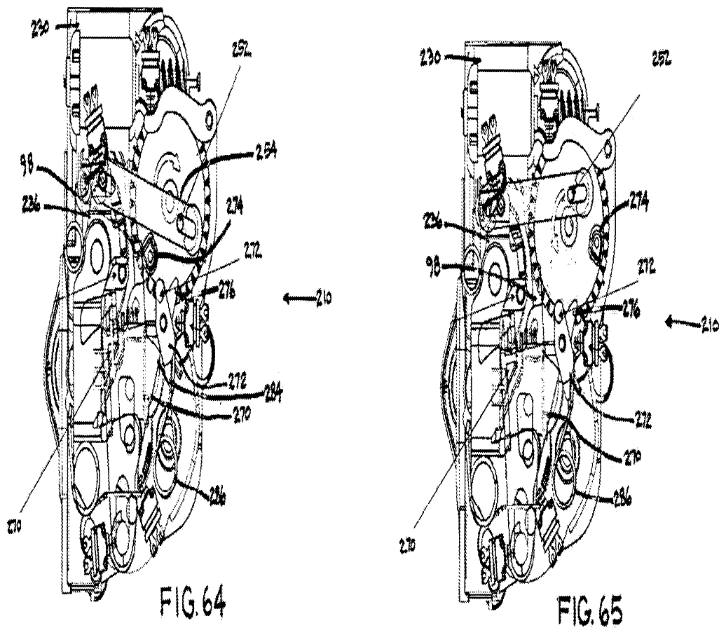

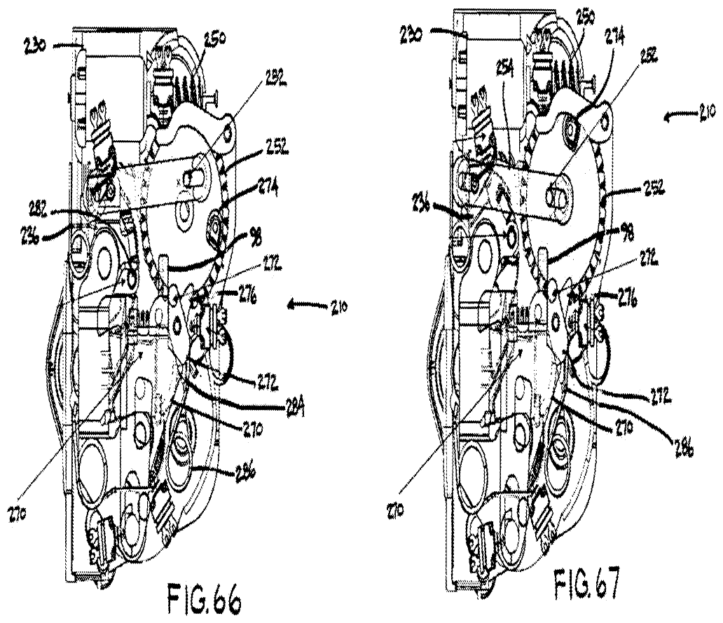

Then, when desired to return the power latch assembly 210 to the unlocked position from the child lock position, as shown in FIGS. 65 and 66, the power release gear 252 is driven from its full travel lock position LP to the home position HP via selective actuation of electric motor 230, whereupon the lug 274 is removed from blocking relation with the child lock projection 98 of inside release link 270, thereby allowing inside release link 270 to freely return to its unlocked position under the bias of release link spring, whereat drive face 280 of inside release link 270 is aligned with driven lug 282 of pawl release lever 236.

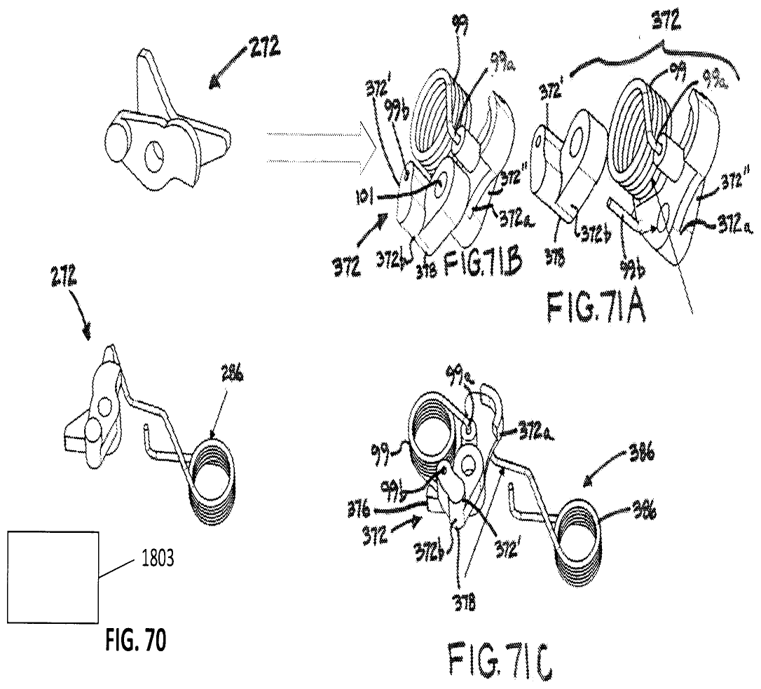

In FIG. 70, various switches, as shown in the accompanying FIGS., with some identified in FIG. 46, can be provided, including ajar, door open, pawl position, ratchet position, inside release, power release gear home, lock switch, child lock switch, by way of example and without limitation, with the various switches being configured in electrical communication with ECU 64 to sense, indicate, and prompt operation of latch assembly 210 as desired to place the latch assembly 210 in the desired position, whether, unlocked, locked, or child lock position.

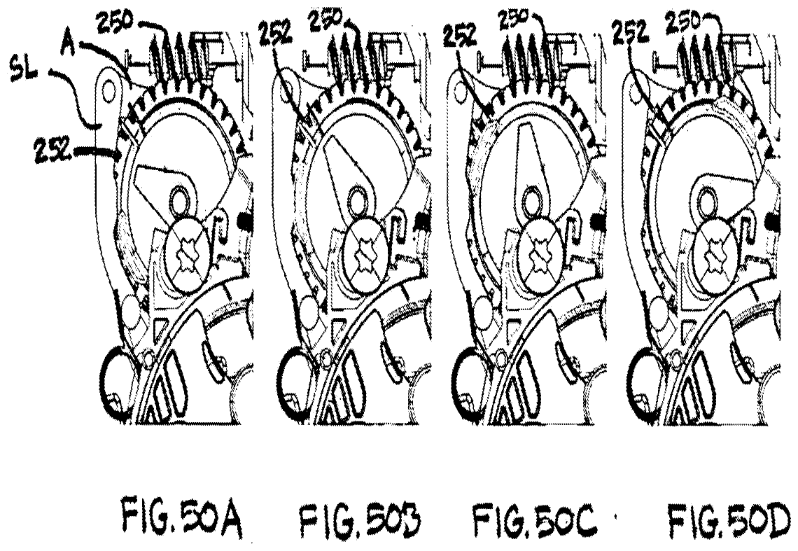

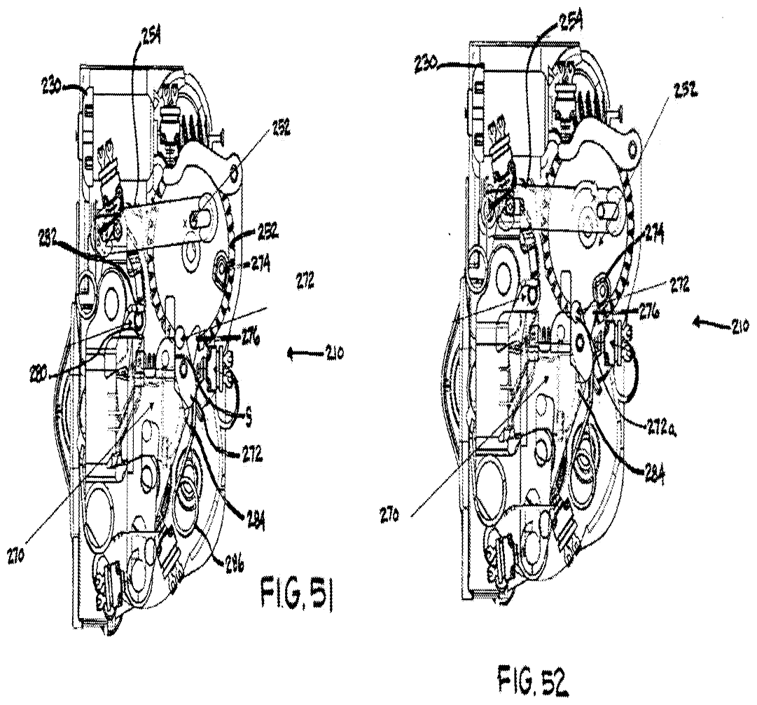

FIGS. 71A and 71B illustrate respective exploded and assembled views comparing the inside lock cam 272 of power latch assembly 210 of FIGS. 46-69 with a two-piece inside lock cam, referred to hereafter as inside lock cam 373, of a power latch assembly 310 constructed in accordance with another non-limiting embodiment of the disclosure. Inside lock cam 372 is moveable between unlock and lock positions, as discussed above for inside lock cam 272, and is biased to remain in the respective unlock and lock positions via a double pull link biasing member, such as a torsion spring member 386 (FIG. 71C). As detailed further below, inside lock cam 372 provides an ability to move the power latch assembly 310 from a child lock position directly to a double pull lock position without having to first return a power release gear 352 to a home position.

Inside lock cam 372 has a first cam member 372a and a second cam member 372b coupled for relative movement with one another via a biasing member, shown as a coil torsion spring 99. Coil torsion spring member 99 has a first leg 99a fixed to first cam member 372a and a second leg 99b fixed to second cam member 372b, with first cam member 372a and second cam member 372b being joined for relative pivotal movement about an axis via a pin 101. Coil torsion spring 99 is shown as an example of a resilient element adapted to deflect or deform in response to an actuation of a release mechanism, such as for example the inside release mechanism 24, to prevent the lock mechanism, such as for example the inside lock cam 372, from shifting from the first lock state (such as the double locked state) to the second lock state (such as the double pull state). Illustratively, the coil torsion spring 99 is provided between the first cam member 372a and second cam member 372b so as to allow the actuation of the inside release mechanism 24 without affecting the inside lock cam 372 state of holding the inside release mechanism 24 misaligned from operable engagement with the pawl release lever 336.

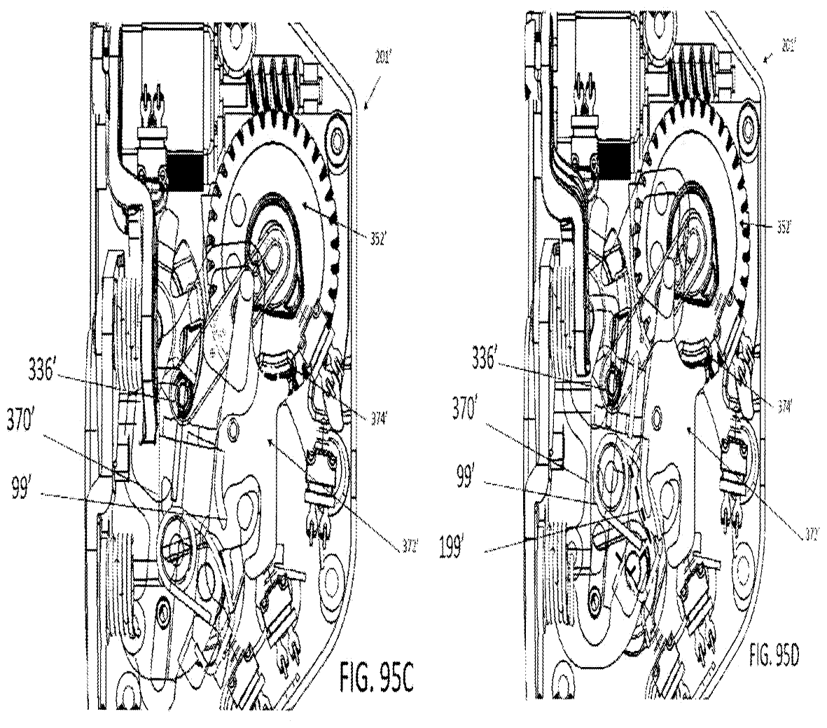

Other configurations of the resilient element may be provided, for example now with reference to FIG. 95A and FIG. 95B illustrating another possible configuration of a power latch assembly 210′, having similar features and configurations to that of power latch assembly 210 referenced using numerals associated with power latch assembly 210 yet now indicated using a prime “” symbol. Power latch assembly 210′ is adapted with a spring 99′ provided between the cam member 372′ and the inside release link 370′ so as to allow the actuation of the inside release mechanism without affecting the inside lock cam 372′ state of holding the inside release link 370′ from operable engagement with the pawl release lever 336′. Spring 99′ is shown illustratively as mounted to inside release link 370′ such that it is positioned between the inside release link 370′ and the inside lock cam 372′. In particular and with reference to FIG. 95A, cam member 372′ can hold inside release link 370′ misaligned from pawl release lever 336′. Lug 374′ is shown in a home position providing a second lock state, or a double pull lock state of the power latch assembly 210′. In this second lock state, lug 374′ is shown as not interacting with the inside lock cam 372′ to prevent the movement of the inside lock cam 372′. As a result an activation of the inside release link 370′ can cause rotation of the inside lock cam 372′ to change the lock state of the latch assembly 210′ from a double pull state (FIG. 95A) to an unlock state when spring 99′ is urged against the inside lock cam 372′ to cause a rotation of the inside lock cam 372′ to allow the inside release link 370′ to move from an unaligned position with the pawl release lever 336′ to an aligned position with the pawl release lever 336′. Since the movement or rotation of the inside lock cam 372′ is not inhibited, for example by the lug 374′ as will be described in more details herein below, the spring 99′ is not, or is not substantially, compressed or does not yield to a degree such that the activation of the inside release link 370′ is not transferred to the inside lock cam 372′ to prevent rotation (shown as being in the counterclockwise direction in FIG. 95B). Since the movement or rotation of the inside lock cam 372′ is not inhibited, for example by the lug 374′ as will be described in more details herein below, the spring 99′ is not, or is not substantially, compressed or does not yield to a degree such that the activation of the inside release link 370′ is not transferred to the inside lock cam 372′ to prevent rotation (shown as being in the counterclockwise direction in FIG. 95B). With reference now to FIG. 95C, power release gear 352′ is shown to be moved to a double lock/child lock position such that the lug 374′ is moved into a blocking position with the inside lock cam 372′ (shown with reference to a circular dotted outline in FIG. 95C) to prevent the rotation of the inside lock cam 372′ in the counterclockwise direction to an unlocked position where inside release link 370′ may be aligned with cam member 372′. With lug 374′ maintained in the blocking position shown in FIG. 95C, activation of the inside release link 370′ cannot or is unable to cause the inside lock cam 372′ to rotate and thus change the lock state of the latch assembly 210′ due to the spring 99′ being adapted to compress or yield against the inside lock cam 372′ as shown in FIG. 95D with reference to dash line 199′. Since inside lock cam 372′ is blocked by the position of lug 374′ the compression of the resilient element e.g. spring 99′ results rather than causing a pivoting of the inside lock cam 372′ when the inside lock cam 372. Thus when the latch 10′, or for example when the lock cam 372′ holds the inside release link 370′ in a misaligned position with the pawl release lever 336′, the resilient element is adapted to temporarily yield without causing the state of the inside lock cam 372′ to change state, such as to an unlocked state or to a double pull state. In other words the actuation of the inside release mechanism 24 may not cause a permanent shift in the state of the lock mechanism illustratively by a rotation of the inside lock cam 372′ to another state (such as to another lock state or to an unlock state), such that upon return of the inside release mechanism 24 from the actuated position the inside lock cam 372 remains in a first lock state, or in the double lock/child lock state.

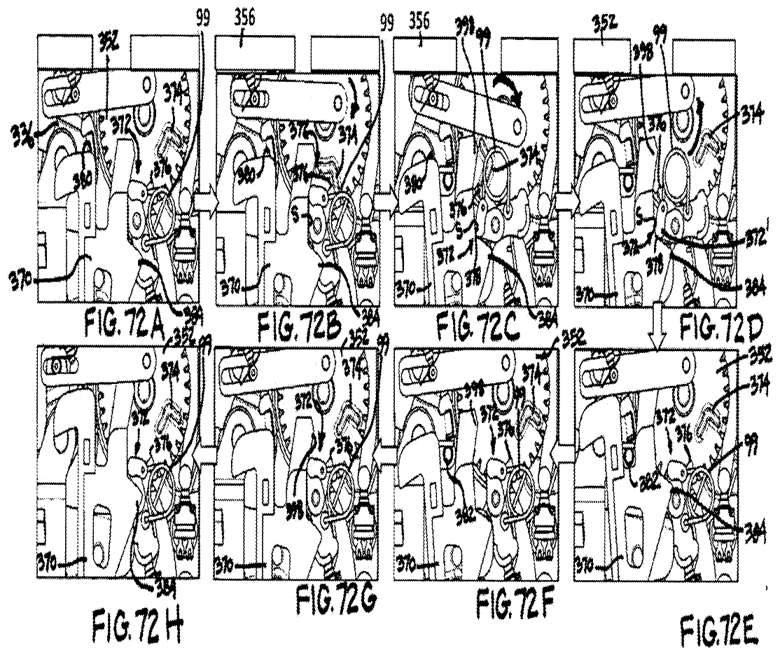

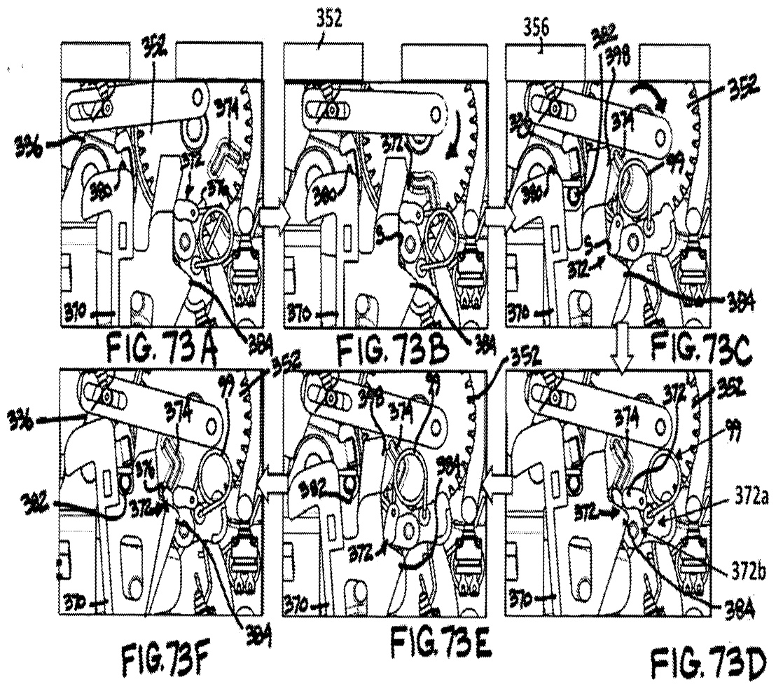

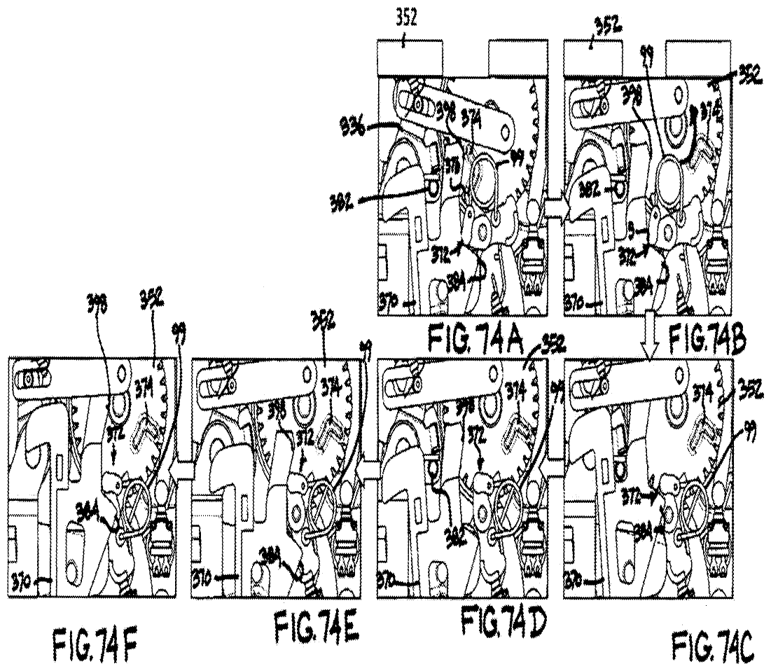

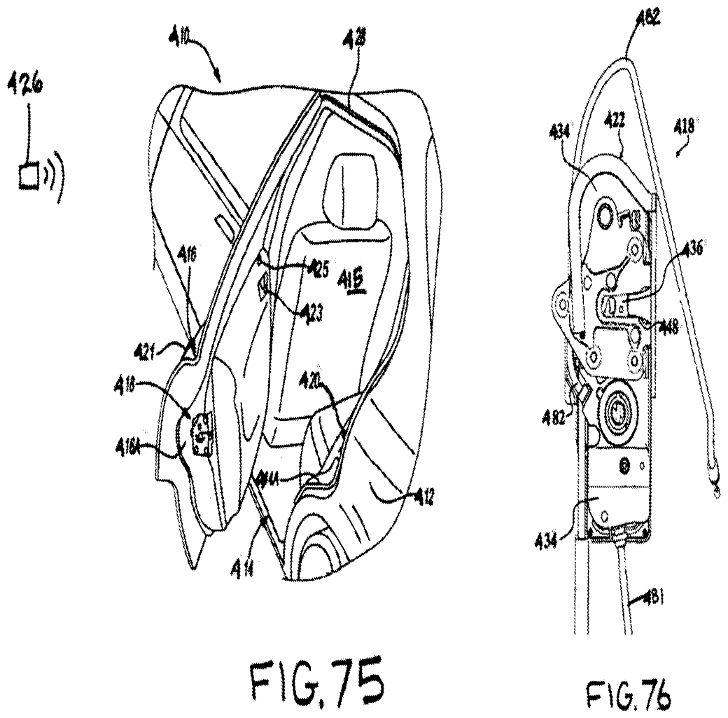

To facilitate moving an inside release link 370 between its unlock and lock positions, inside lock cam 372 is configured for movement between a cam unlock position (FIGS. 72A and 73A), whereat the inside release link 370 is aligned for operable engagement with a pawl release lever 336; a cam double pull lock position (FIGS. 72D and 74B), whereat the inside release link 370 is misaligned from operable engagement with the pawl release lever 336 during a first mechanical actuation of the inside release mechanism 24; and a cam child lock position (FIG. 73C), whereat the inside release link 370 remains misaligned from operable engagement with the pawl release lever 336 for any number of mechanical actuations of the inside release mechanism 24, thus, preventing manual opening of door 12 via inside release mechanism 24 as long as inside lock cam 372 is in its cam child lock position.

To facilitate movement of the inside lock cam 372 between the cam unlock position; cam double pull lock position; and the cam child lock position, the inside cam lock 372 is configured for engagement by a drive member, also referred to as lug 374. In FIGS. 72A-72H, a sequence of moving inside lock cam 372 to the cam double pull lock position and performing a double pull mechanical actuation of power latch assembly 310 via inside release mechanism 24 is illustrated. As shown in FIGS. 72A-72C, when the inside lock cam 372 is in its unlock position, and as the power release gear 352 is driven a first time from its home position HP in the second direction to the lock position LP, lug 374 engages a first protrusion, also referred to as first arm 376 of first cam member 372a to rotate inside lock cam 372 in a counterclockwise direction, with first and second cam members 372a, 372b rotating conjointly with one another via being coupled by biasing member 99 as viewed in FIG. 72C. As inside lock cam 372 is rotated via engagement with lug 374 of power release gear 352, a cam lobe 378 engages a surface S (72C and 72D) of inside release link 370 to push a drive surface, also referred to as drive face 380, of inside release link 370 from aligned relation with a driven member, also referred to as driven lug 382 of pawl release lever 336, whereat inside release link 370 is in the unlock position (FIGS. 72C-72E), out from alignment with the driven lug 382, whereat inside release link 370 is in the lock position. Driven lug 382 is shown, by way of example and without limitation, as an upstanding pin or protrusion fixed to pawl release lever 336. Upon inside release link 370 being moved to the lock position, and inside lock cam 372 being moved to the cam double pull lock position (FIGS. 72C and 72D), power release gear 352 is able to be rotated back in the counterclockwise direction (FIG. 72D) from the full travel lock position LP to the home position HP.

While the inside lock cam 372 is rotated to the cam double pull lock position (lock position), a double pull protrusion, also referred to as double pull lever or double pull member 384, is configured for operable communication with inside lock cam 372 to facilitate movement of inside lock cam 372 from the lock position LP back to the home position HP during a double pull sequence. Double pull member 384 is fixed to inside release link 370, and can be formed as a monolithic piece of material with inside release link 370, wherein double pull member 384 is shown as being configured for direct engagement with second cam member 372b and inside lock cam 372. Double pull member 284 is shown configured for engagement with an upstanding lug 372′ of second cam member 372b to move inside lock cam 372 between its unlock and lock positions, and is biased to remain in the respective unlock and lock positions via a double pull link biasing member, such as a torsion spring member 386, engaging a detent protrusion 372″ of first cam member 372a (FIGS. 71A and 71B). While the inside lock cam 372 is in the cam double pull lock position (FIGS. 72D), during a first mechanical actuation of the inside release mechanism 24 (FIG. 72E), lug 372′ of the inside lock cam 372 is engaged and driven by double pull member 384 to move inside lock cam 372 to the cam unlock position, whereupon first and second cam members 372a, 372b pivot conjoint with one another as a result of the bias imparted by biasing member 99 therebetween, whereat spring member 386 slides along biasing detent 372″ of first cam member 372a to provide toggled movement of inside lock cam 372 from the lock position to the unlock position, such that the drive face 380 of inside release link 370 is brought into aligned relation for operable engagement with the driven lug 382 of pawl release lever 336 upon completion of the first mechanical actuation of the inside release mechanism 24 (FIG. 72G). It can be seen that the double pull member 384, upon rotatably driving the inside lock cam 372, causes cam lobe 378 of second cam member 372b to rotate out from cammed engagement with surface S of inside release link 270, whereupon spring member 386 maintains inside lock cam 372 in its unlock position, thereby allowing inside release link 370 to return under a spring bias to its unlock position. As such, during a second mechanical actuation of the inside release mechanism 24 (FIG. 72H), the inside release link 370 is driven such that the drive face 380 forcibly engages driven lug 382 of pawl release lever 336 to cause pawl release lever 336 to drive the pawl from the ratchet holding position to the ratchet releasing position, thereby allowing ratchet to move from the striker capture position to the striker releasing position, as discussed above for pawl 234 and ratchet 232. Accordingly, a double pull mechanical actuation of inside release mechanism 24 while inside lock cam 372 is in the double pull lock position causes power latch assembly 310 to move from the latch closed position to the latch released position.

To place latch assembly 310 in the child lock position from the unlock position (FIG. 73A), a similar operation is performed as with placing the latch assembly 310 in the lock position (double pull lock position), with a notable difference. Power release gear 352 is driven from its home position HP in the second direction (clockwise) to the lock position LP, whereupon the inside lock cam 372 is driven to the same position as described above for the cam double pull lock position (FIG. 72D). Accordingly, lug 374 engages first arm 376 of first cam member 372a to rotate inside lock cam 372 in a counterclockwise direction to rotate cam lobe 378 into engagement with surface S of inside release link 370 to push drive face 380 of inside release link 370 from aligned relation with driven lug 382 of pawl release lever 336 out from alignment with the driven lug 382. The difference being, rather than rotating power release gear 352 back in the counterclockwise direction from the full travel lock position LP to the home position HP, as done when placing latch assembly 310 in the lock position, power release gear 352 remains in the full travel lock position LP to place latch assembly 310 in the child lock position. While inside lock cam 372 is in the child lock position (FIG. 73C), during a mechanical actuation of the inside release mechanism 24 (FIG. 73D), upstanding lug 372′ of the inside lock cam 372 is engaged and driven by the protrusion forming double pull member 384 to pivot second cam member 372b relative to first cam member 372a, wherein the bias imparted by biasing member 99 is overcome to allow the relative movement between first and second cam members 372a, 372b due to first cam member 372a being blocked against movement by lug 374. Accordingly, biasing member 99 becomes temporarily compressed under the forcible engagement of protrusion 384 with second cam member 372b during a mechanical actuation of the inside release mechanism 24. Then, upon completion of the mechanical actuation of the inside release mechanism 24, protrusion 384 is moved out from engagement with second cam member 372b, whereupon second cam member 372b is returned to its home position under the bias of biasing member 99, whereat inside lock cam 372 is resumes the position corresponding to the double pull lock position. The indexable lock cam 372 is adapted to maintain the position of the inside release link 370 in the unaligned position notwithstanding the mechanical actuation of the inside release mechanism 24 when the latch assembly is in the first lock state such as the child lock state or double lock state. In other words, the actuation of the inside release mechanism 24 when the latch assembly 10 is in the child lock/double lock state does not shift the latch to another lock state, for example from the child lock/double lock state to a non child lock/double lock state or second lock state, (e.g. double pull state). In other words, the actuation of the inside release mechanism 24 is unable to change the lock state of the latch assembly 10 from a first lock state (for example the double lock state where the inside release mechanism 24 is decoupled from the pawl 234) to a second lock state (for example the double pull state where the inside release mechanism 24 can be coupled from the pawl 234, such as following a first actuation of the inside release mechanism 24). The indexable lock cam 372 adapted to temporarily yield in response to the actuation of the inside release link 370 prevents the position of the indexable lock cam 372 to be changed in response to actuation of the inside release link 370. For example, as shown in FIG. 73C, the indexable lock cam 372 holds the inside release link 370 in the unaligned position prior to actuation of the inside release link 370, and whereas after actuation of the inside release link 370 the indexable lock cam 372 maintains the inside release link 370 in the unaligned position as shown in FIG. 73E. With power release gear 352 remaining in its full travel lock position LP, the inside release link 370 is not returned under the bias of an inside release link spring into aligned relation for operable engagement with the driven lug 382 of pawl release lever 336, but rather, inside release link 370 remains misaligned out from possible engagement with the driven lug 382 due to the influence of lug 374 of power release gear 352 acting on a child lock ledge, also referred to as projection 398, of inside release link 370 (FIG. 73E). Accordingly, with projection 398 being engaged by lug 374, any number of actuations of inside release mechanism 24 does not cause pawl 334 to be moved out from its ratchet holding position, nor does it cause inside lock cam 372 to be moved out from its double pull lock position.

Then, when desired to return the power latch assembly 310 to the unlocked position from the child lock position, as shown in FIGS. 74A-74E, the power release gear 352 is driven from its full travel lock position LP to the home position HP, whereupon the lug 374 freely bypasses inside lock cam 372, while in its double pull lock position, and is removed from blocking relation with the child lock projection 398 of inside release link 370. As such, upon power release gear 352 returning to its home position HP, power latch assembly 310 is effectively placed in its double pull lock position directly from its child lock position without having to further actuate power release gear 352. Accordingly, power latch assembly 310 can then be unlatched via a double pull actuation of inside release mechanism 24, as shown in FIGS. 74C-74F, as discussed above for FIGS. 72E-72H, whereupon power latch assembly 310 is returned to its unlock position.

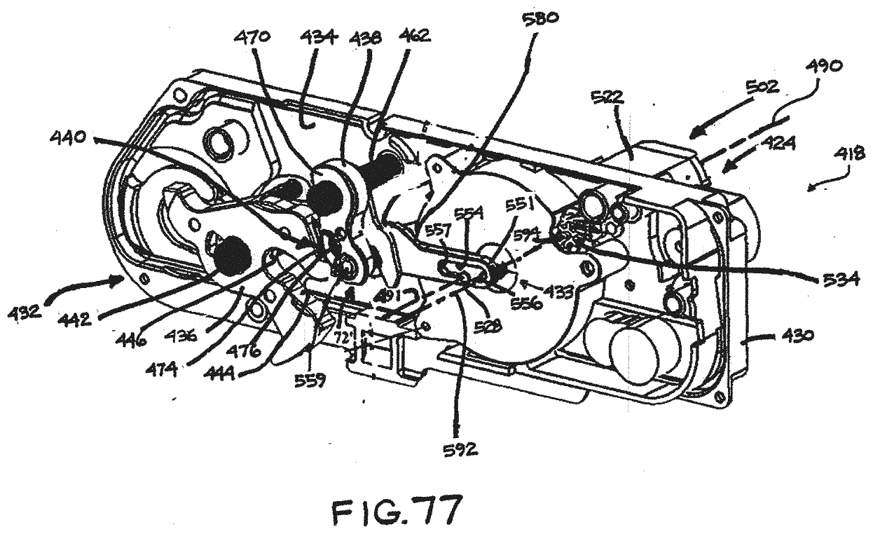

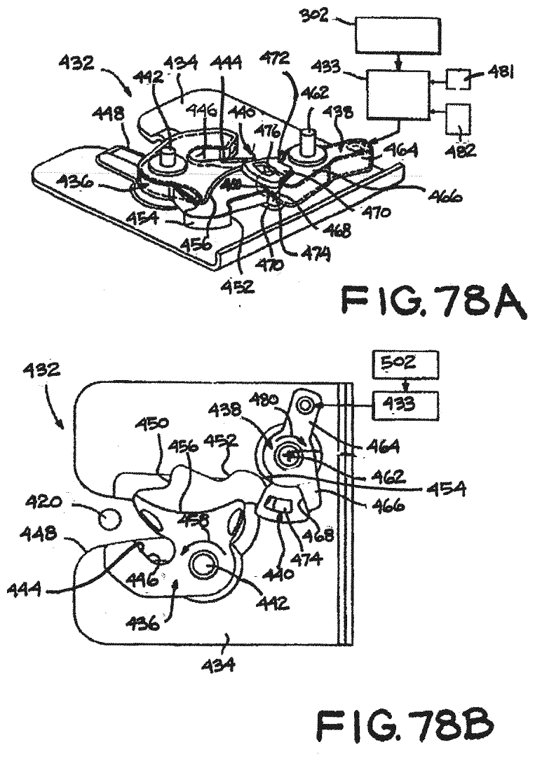

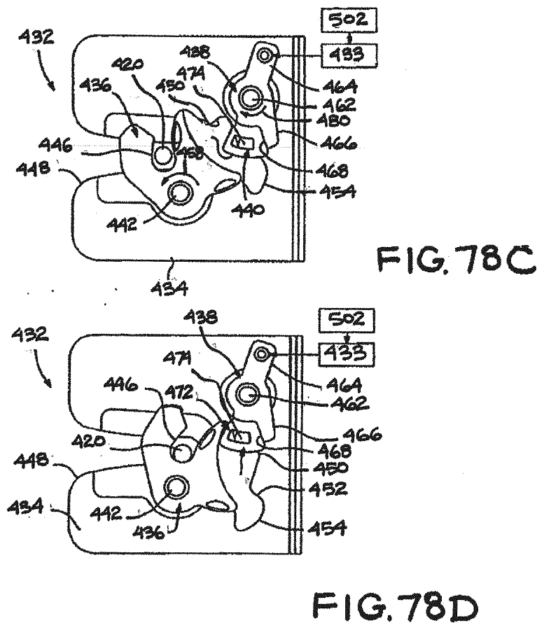

Referring to FIG. 75, a motor vehicle 410 is shown to include a vehicle body 412 defining an opening 414 to an interior passenger compartment 415. A vehicle closure panel 416 is pivotably mounted to body 412 for movement between an open position (shown), a partially-closed position, and a fully-closed position relative to body 412. A closure latch assembly 418 is rigidly secured to closure panel 416 adjacent to an edge portion, also known as a shut face 416A, thereof and is releasably engageable with a striker 420 that is fixedly secured to a recessed edge portion 414A bounding a portion of opening 414. Closure latch assembly 418 includes a latch mechanism 432 (FIGS. 77 and 78A-78D) operable to engage striker 420 and releasably hold closure panel 416 in one of its partially-closed and fully-closed positions. An outside handle 421 and an inside handle 423 are provided for actuating (i.e. mechanically (via manual actuation) and/or electrically (via powered actuation)) closure latch assembly 418 to release striker 420 and permit subsequent movement of closure panel 416 to its open position. An optional lock knob 425 is shown which provides a visual indication of the locked state of closure latch assembly 18 and which may also be operable to mechanically change the locked state of closure latch assembly 418. A weather seal 428 is mounted on edge portion 414A of opening 414 in vehicle body 412 and is adapted to be resiliently compressed upon engagement with a mating sealing surface on closure panel 416 when closure panel 416 is held by closure latch assembly 418 in its fully-closed position so as to provide a sealed interface therebetween, which is configured to prevent entry of rain and dirt into the passenger compartment 415 while minimizing audible wind noise. For purpose of clarity and functional association with motor vehicle 410, the closure panel is hereinafter referred to as door 416, wherein door 416 can be configured as a swing door or any other type of door, and closure panel can be provided as other than a door, such as a front hood, rear trunk lid, hatch, or otherwise.

For purposes of illustration only, a non-limiting version of latch mechanism 432 is shown in FIGS. 78A-78D, generally include a latch frame plate 434, ratchet 436, and a pawl 438 having a roller-type engagement device 440, by way of example and without limitation. Ratchet 436 is supported on latch frame plate 434 by a ratchet pivot post 442 for movement between a released or “striker release” position (FIG. 78B), a soft close or “secondary striker capture” position (FIG. 78C), and a hard close or “primary striker capture” position (FIGS. 78A and 78D). Ratchet 436 includes a striker guide channel 444 terminating in a striker retention cavity 446. As seen, latch frame plate 434 includes a fishmouth slot 448 aligned to accept movement of striker 420 relative thereto upon movement of door 416 toward its closed positions. Ratchet 436 includes a primary latch notch 450, a secondary latch notch 452, and an edge surface 454. A raised guide surface 456 is also formed on ratchet 436. Arrow 458 indicates a ratchet biasing member that is arranged to normally bias ratchet 436 toward its striker release position.

Pawl 438 is shown pivotably mounted to latch frame plate 434 about a pawl pivot post 462 and includes a first pawl leg segment 464 and a second pawl leg segment 466 defining a pawl engagement surface 468. Roller-type engagement device 440 is secured to second pawl leg segment 466 of pawl 438 and includes a pair of oppositely-disposed sidewalls 470 defining a cage 472, and a roller, shown as a spherical ball bearing 474, that is retained by cage 472 within aligned roller slots 476 formed in sidewalls 470. Pawl 438 is pivotable between a ratchet releasing position (FIG. 78B) and a ratchet holding position (FIGS. 78A, 78C and 78D). Pawl 438 is normally biased toward its ratchet holding position by a pawl biasing member, indicated by arrow 480.

As shown in FIG. 78B, pawl 438 is held in its ratchet releasing position when ratchet 36 is located in its striker release position due to engagement of ball 474 with pawl engagement surface 468 on pawl 438 and with edge surface 454 on ratchet 436, whereby a released operating state for latch mechanism 432 is established. As shown in FIG. 78C, ball 474 is in engagement with pawl engagement surface 468 on pawl 438 and with secondary latch notch 452 on ratchet 436 so as to cause pawl 438, now located in its ratchet holding position, to hold ratchet 436 in its secondary striker capture position. In this orientation, striker 420 is retained between ratchet guide channel 446 and fishmouth slot 448 in latch frame plate 434 to hold door 416 in a partially-closed position and establish a secondary latched state for latch mechanism 432. Finally, FIGS. 78A and 78D illustrate pawl 438 located in its ratchet holding position with ball 474 in engagement with pawl engagement surface 68 on pawl 438 and with primary latch notch 450 on ratchet 436 such that pawl 438 holds ratchet 436 in its primary striker capture position so as to hold door 416 in its fully-closed position and establish a primary latched operating state for latch mechanism 432.

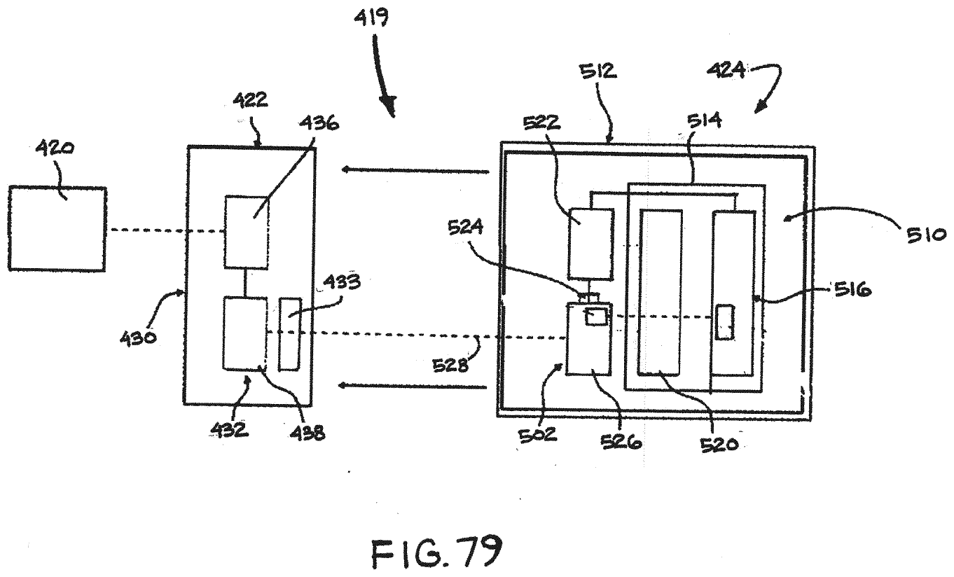

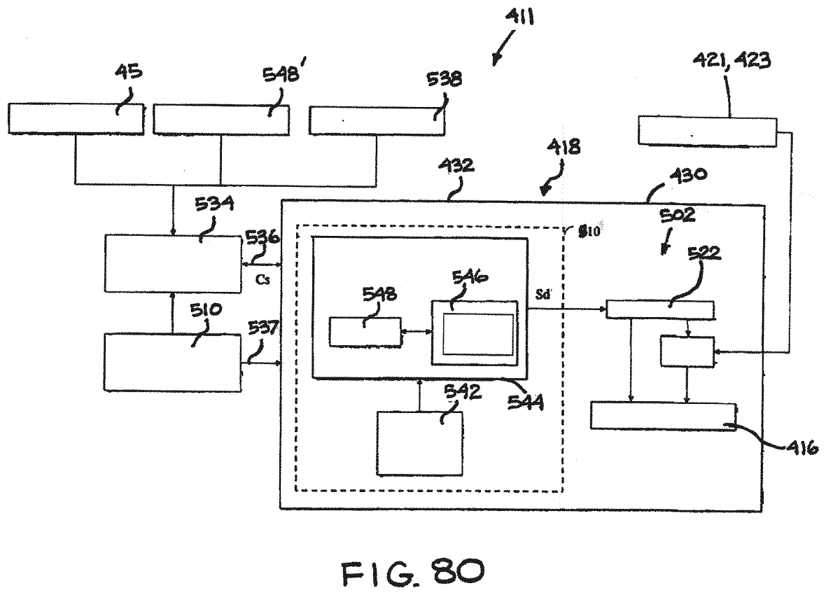

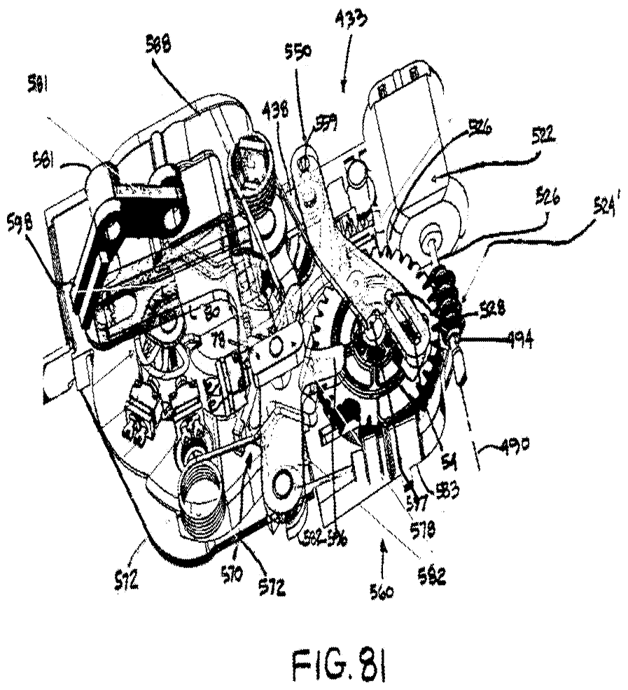

A latch release mechanism 433 is shown schematically in FIGS. 78A-78D and 79 to be connected to first pawl leg segment 464 of pawl 438. Latch release mechanism 433 functions to cause movement of pawl 438 from its ratchet holding position into its ratchet releasing position when it is desired to shift latch mechanism 432 into its released operating state. An inside latch release mechanism (i.e. inside release cable assembly 481) operably connects inside handle 423 to latch release mechanism 433 to permit mechanical, manual release of latch mechanism 432 from inside the passenger compartment 415 of vehicle 410. Likewise, an outside latch release mechanism (i.e. outside release cable assembly 482) operably connects outside handle 421 to latch release mechanism 433 to permit mechanical, manual release of latch mechanism 432 from outside of vehicle 410.

In addition, a power release actuator system, also referred to as power release actuator or power actuator 502, associated with actuator module 424, is shown in FIGS. 78A-78D schematically connected to latch release mechanism 433. Actuation of power release actuator 502 causes latch release mechanism 433 to move pawl 438 from its ratchet holding position into its ratchet releasing position. As will be detailed, power release actuator 502 is an electric motor-driven arrangement forming part of a power release chain. A ratchet switch lever (not shown) is mounted to ratchet 436 and works in cooperation with a ratchet release sensor (not shown) to provide a “door open” signal when ratchet 536 is located in its striker release position and a secondary latched sensor (not shown) to provide a “door ajar” signal when ratchet 436 is located in its secondary striker capture position. As is well known, these sensor signals are used by a latch control system integrated into actuator module 424 to control operation of power release actuator 502.

Referring again to FIG. 79, actuator module 424 is generally shown to include an ECU/actuator assembly 510 and an ECU cover 512, which together can be secured to a latch housing 430 of a latch module 422 via any attachment arrangement, shown schematically at 419. ECU/actuator assembly 510 generally includes a housing plate 514, power actuator 502, and a control unit 516. Power actuator 502 can be pre-assembled prior to mounting on housing plate 514 and generally includes a carrier plate 520, an electric motor 522 mounted to carrier plate 520 and having a motor shaft 494 driving a pinion gear 524 (FIG. 77) or a worm gear 524′ about a motor shaft axis 490, a drive gear, also referred to as power release gear 526, in constant meshed engagement with pinion or worm gear 524, 524′, and having an actuation feature 528, also referred to as gear pin or drive pin, adapted to interact with latch release mechanism 433.

Actuation feature 528 is provided as an elongate pin which is oriented in relation to a multipurpose, multifunctional pawl release link, also referred to release link, link member or link arm 550, wherein link arm 550 operably connects pawl 438 with drive pin 528. Link arm 550 and drive pin 528 function together to define latch release mechanism 433, and further function to provide a double lock and child lock mechanism, as discussed further hereafter. Actuation feature 528 extends laterally outwardly from a side face of drive gear 526 along an axis, also referred to as drive pin axis 491 (FIG. 77), that is parallel with, and shown as being in immediately adjacent relation with a drive gear axis 492, collinear with motor shaft axis 490, about which drive gear 526 rotates. As discussed further, the close proximity of drive pin axis 491 to drive gear axis 492 facilitates smooth, reliable operation of closure latch assembly 418. Still further, the close proximity of the drive pin axis 491 to drive gear axis 492, or in other words the closer radial position or distance of the drive pin axis 491 to drive gear axis 492, than to the outer circumference of the drive gear 526 reduces the moment arm developed between the drive pin 528 and the drive gear axis 492 during the rotation of the drive gear 526, and thus motor 522 does not need to configured to overcome the larger increase in moment arm due to a farther proximity of drive pin axis 491 to the drive gear axis 492 as would be a configuration of the motor 522 where the drive pin 528 is positioned closer to the circumferential extents, or outer circumference, of the drive gear 526 and further away from the drive gear axis 492.

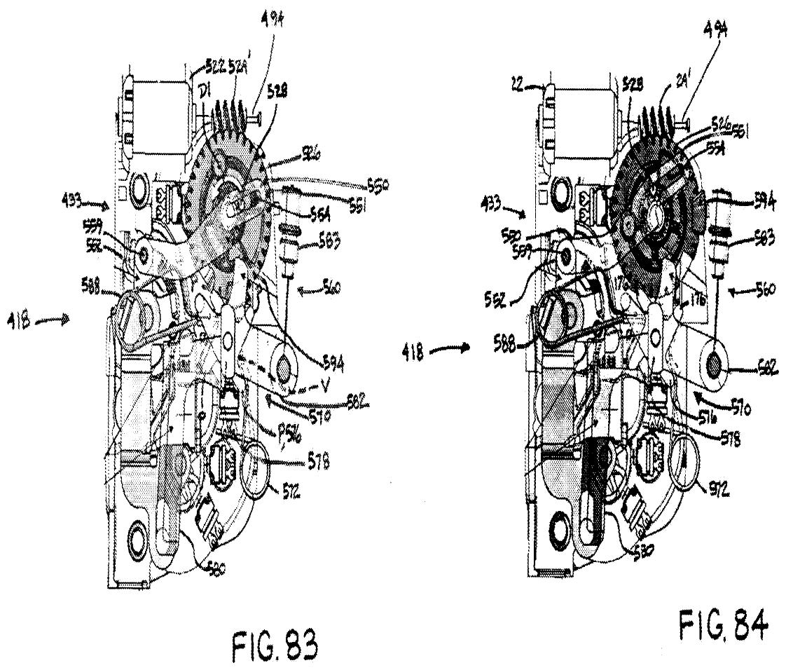

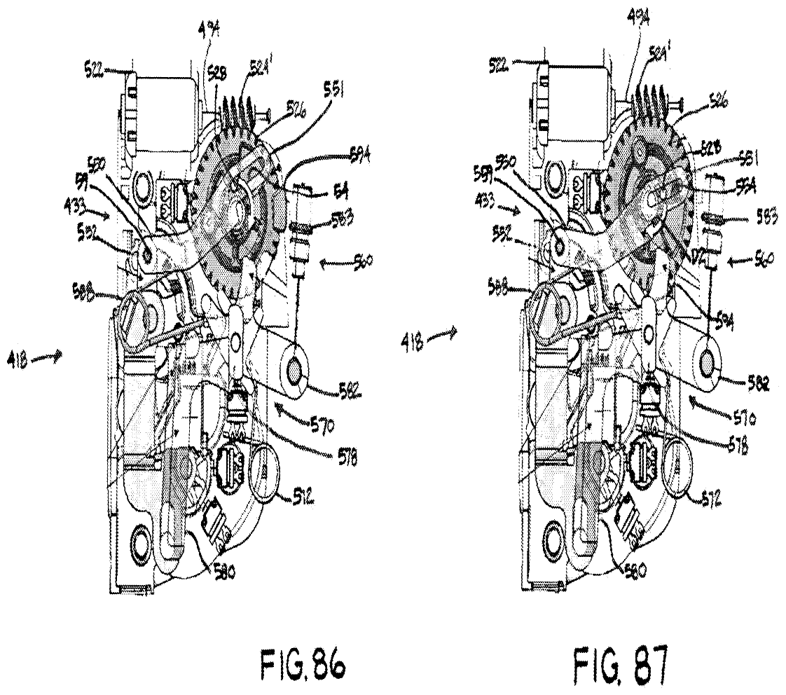

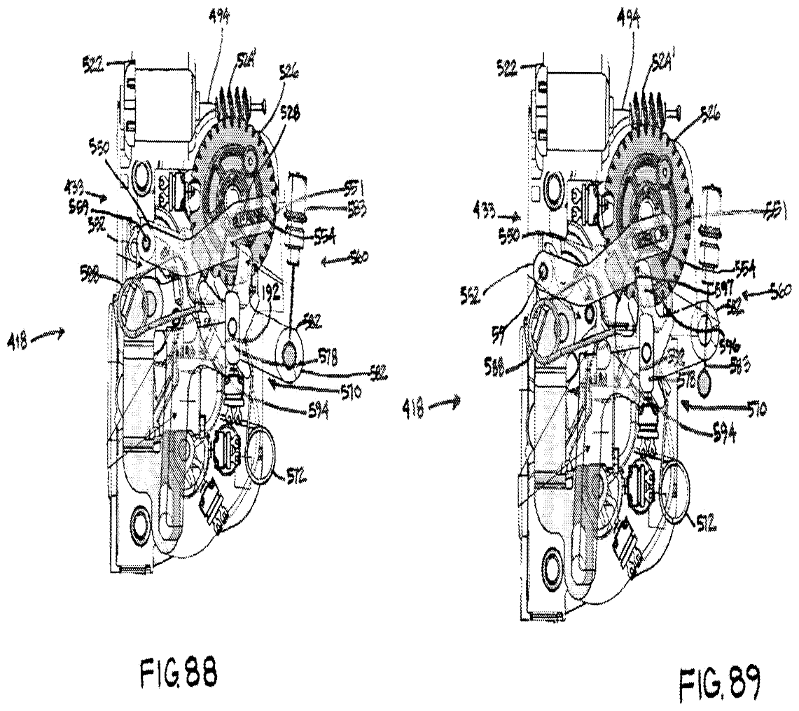

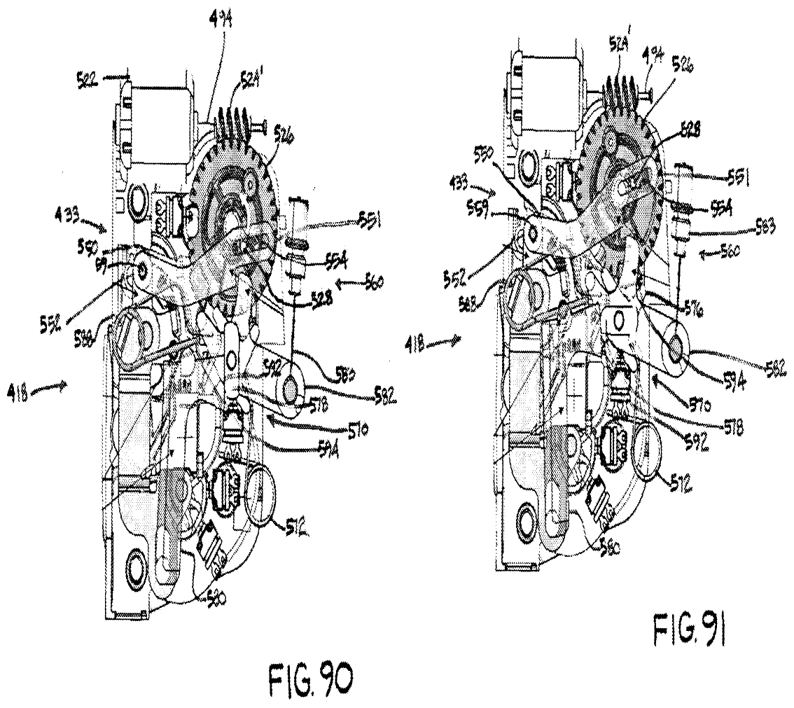

As shown in FIGS. 83-85, rotation of drive gear 526 in a first or counterclockwise direction CCW from a home position to a released position via energization of electric motor 522 in response to a power release command causes drive pin 528 to move link arm 550 and drive pawl 438 from its ratchet holding position to its ratchet releasing position. Following a power release command, as shown in FIGS. 86-87, electric motor 522 is commanded to rotate drive gear 526 in the second or opposite clockwise direction back to its home position so as to reset latch release mechanism 433 to subsequently allow pawl 438 to move back into its ratchet holding position.

Link arm 550 is shown as directly coupling drive pin 528 to pawl 438 to form a lost motion connection therebetween; however, it is contemplated that by operably connecting pawl 438 with drive pin 528 that addition levers or mechanisms could be incorporated therebetween. Link arm 550 is elongate and extends lengthwise between opposite first and second ends 551, 552. To facilitate forming the lost motion connection between drive gear 526 and pawl 438, link arm 550 has an elongate slot 554 extending lengthwise between opposite first and second drive ends 556, 557 intermediate the opposite first end 551 and second end 552 of link arm 550. Elongate slot 554 is illustratively shown as a linearly extending elongated slot, or a linear slot, and not a curved slot. Drive gear 526 is operably coupled to link arm 550 via drive pin 528 being disposed in slot 554 for sliding movement therealong, wherein the length of slot 554 is greater than the diameter of drive pin 528, thereby creating a lost motion connection, meaning that drive pin 528 can translate within slot 554 until it comes into engagement with one of the ends of slot 554. Pawl 438 is operably coupled to link arm 550 proximate second end 552, such as via a pin 559, by way of example and without limitation. It is to be recognized that pin 559 could be a rivet or otherwise, and be attached to and extend from pawl 438 about which link arm 550 may be allowed to rotate. For example a receptacle such as a bore in the link arm 550 may be configured to receive pin 559 therein and allow rotation of link arm 550 about the pin 559. Alternatively, pin 559 may be attached to and extend from link arm 550 for receipt within a receptacle or bore provided in pawl 438. A Hall effect sensor/magnet can be associated with link arm 550, such as via being fixed adjacent second end 552 and/or on pin 559 to facilitate direct position information to a sensor for determination of the precise location of pawl 438, as will be understood by one possessing ordinary skill in the art.

Now referring to FIG. 80, a power latch system 411 and power latch assembly 418 thereof includes the latch electronic control unit (ECU) 510, also referred to as the controller, for example including, as discussed in detail hereinafter, a microcontroller or other known computing unit, which, in a possible embodiment, is conveniently embedded and arranged in a same latch housing or plate (shown schematically as 430) together with power release actuator system 502, thus providing an integrated compact and easy-to-assemble unit. The electronic control unit (ECU) 510 is coupled to the power release actuator system 502 and provides to the prime mover, for example the power release motor 522, suitable driving signals Sd. The electronic control unit (ECU) 510 is electrically coupled to a vehicle management unit 534, which is configured to control general operation of the motor vehicle 410, via an electrical connection element 536, for example a data bus, so as to exchange signals, data, commands and/or information. The vehicle management unit 534 is also coupled to crash sensors 538, for example accelerometer or force sensors, which provide signals, for example acceleration or force signals, which indicate the presence of an emergency situation, such as a crash. Other sensors may be provided to detect the state of the vehicle 410, such as a main battery disconnect sensor (not shown), which may be integrated into vehicle management unit 534. Conveniently, the electronic control unit (ECU) 510 also receives feedback information about the latch actuation from position sensors (such as via a sensor configured to detect the home position of power release gear 526 via detection of actuation feature 528, by way of example and without limitation), wherein additional sensors, such as Hall sensors, can be configured to detect the operating position, for example of the ratchet 436 and/or pawl 438; and also receives (directly and/or indirectly via the vehicle management unit 534) information about the actuation of the vehicle (external and/or internal) handles 421, 423 and/or from handle sensors, which detect user activation of the external and/or internal handles 421, 423 of the door 416 of the motor vehicle 410. The electronic control unit (ECU) 510 is also coupled to the main power source 540 of the motor vehicle 410, so as to receive the battery voltage Vbatt 537; the electronic control unit (ECU) 510 is able to check if the value of the battery voltage Vbatt decreases below a predetermined threshold value, for example which may indicate a low power condition, a battery disconnect condition, which may in response require the power latch assembly 418 to be transitioned from a normal mode of operation whereby the power release actuator system 502 is electronically controlled for controlling powered actuation of the latch mechanism 432 without the requirement or enablement of a manual activation of external and/or internal handles 421, 423 for controlling the manual actuation of the latch mechanism 432. According to an aspect of the present disclosure, the electronic control unit (ECU) 510 includes an embedded and integrated backup energy source 542, which is configured to supply electrical energy to the prime mover, for example the power release motor 522 and to the same electronic control unit (ECU) 510, in case of failure or interruption of the main power source 540 of the motor vehicle 410. The electronic control unit (ECU) 510 is able to check if the value of the backup energy source voltage Vbackup decreases below a predetermined threshold value. This backup energy source 542 is usually kept in a charged state during normal operation, by the main power source 540, so as to be readily available as soon as the need arises, for example in case of a crash or loss of the main vehicle battery 540. In more detail, electronic control unit (ECU) 510 includes a control unit 544, for example provided with a microcontroller, microprocessor or analogous computing module 546, coupled to the backup energy source 542 and the power release motor 522 (providing thereto the driving signal Sd), to control the operation of the power release motor 522. The control unit 510 has an embedded memory 548, for example a non-volatile random access memory, coupled to the computing module 546, storing suitable programs and computer instructions (for example in the form of a firmware). It is recognized that the control unit 544 could alternatively comprise a logical circuit of discrete components to carry out the functions of the computing module 546 and memory 548. The electronic control unit (ECU) 510 is configured to control the latch assembly 418 for controlling actuation of the door 416, based on signals detected by the handle sensors, which are indicative for example of the user intention to power release and open the door 416, and based on signals received from the vehicle management unit 534, which are indicative for example of a correct authentication of the user carrying suitable authentication means (such as in a key fob 426), in a normal mode of operation, and the electronic control unit (ECU) 510 is configured to control the latch assembly 418 for controlling actuation of the door 416, based a manual actuation by one or both inside and outside handles 421, 423 based on signals received from the vehicle management unit 534, which are indicative for example of a state of the vehicle such as a crash condition, an emergency condition, a low or disconnected power supply condition whereby the power release operation of the latch assembly 418 is not desired or possible. Furthermore, the electronic control unit (ECU) 510 is configured to control the latch assembly 418 for controlling a manual actuation of the door 416, based on signals indicating a desired operating condition of the latch assembly 418, which may include for example a double lock operating state of the latch assembly 418 controlled by activation of a double lock or lock switch 545 for example provided on the FOB 426, a child lock disabled operating state controlled by activation of a child lock switch 548′ whereby a manual activation of the inside door handle 423 will cause the manual activation of the latch release assembly 410.

Referring now to FIGS. 81 through 93B, an override release mechanism 560 is shown, with the override release mechanism 560 being moveable between a disengaged position, whereat at least one or both of the inside door handle 423 and the outside door handle 421 is disengaged from operable communication with link member 550, thereby being ineffective to release latch assembly 418, and an engaged position, whereat at least one or both of the inside door handle 423 and outside door handle 421 is engaged in operable communication with link member 550, thereby being effective to release power latch assembly 418. The power release actuator system 502 is configured to control powered movement and actuation of the link member 550 to move the pawl 438 from the ratchet holding position to the ratchet releasing position and to maintain the override release mechanism 560 in the disengaged position during normal operation of the power latch assembly 418 and to selectively move the override release mechanism 560 to the engaged position, such as in a double lock/child lock and automatically in a crash condition.

As discussed above, the power release actuator system 502 includes motor 522 and drive gear 526 driven about a drive gear axis 492 by motor 522. The actuation feature 528 (e.g. upstanding pin) extending outwardly from drive gear 526 in spaced relation from drive gear axis 492 is configured in operable (indirect, or as shown in direct) communication with link member 550 to selectively move pawl 438 from the ratchet holding position to the ratchet releasing position when motor 522 drives drive gear 526 in a first direction D1 (FIG. 83).

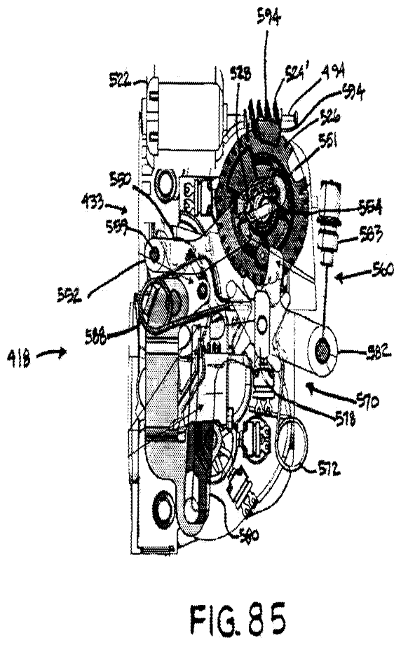

Override release mechanism 560 includes link member 550 being operably coupled at one end 552 to pawl 438, shown as being connected via pin 559, by way of example and without limitation. Actuation feature 528 is configured in operable communication with link member 550 to selectively move override release mechanism 560 between the disengaged and engaged positions when motor 522 drives the drive gear 526 in a second direction D2 (FIG. 87) opposite the first direction. Actuation feature 528 is configured for initial lost motion relative to link member 550 upon energizing motor 522, as shown in FIGS. 83 and 84 and as discussed above, and to move link member 550 concurrently with pin 559 during a normal power release (FIG. 85) and/or in pivotal relation to pin 559 to move override release mechanism 560 between the disengaged and engaged positions, such as in a double lock or child lock operation (FIGS. 87, 88, and 91).

To facilitate movement of power latch assembly 418 to the double lock and child lock positions, upon movement of power release gear 526 from its full or maximum rest position (FIG. 87) clockwise in the second direction D2 and then returning counterclockwise back to the full rest position, a lug 594 on power release gear 526 engages an indexing member, also referred to as indexing knob 570. The indexing member 570 is configured to move between a plurality of indexed positions to bring the inside door handle 421 into and out of operable communication with the pawl 438, thereby being effective to activate and deactivate inside door handle 423.

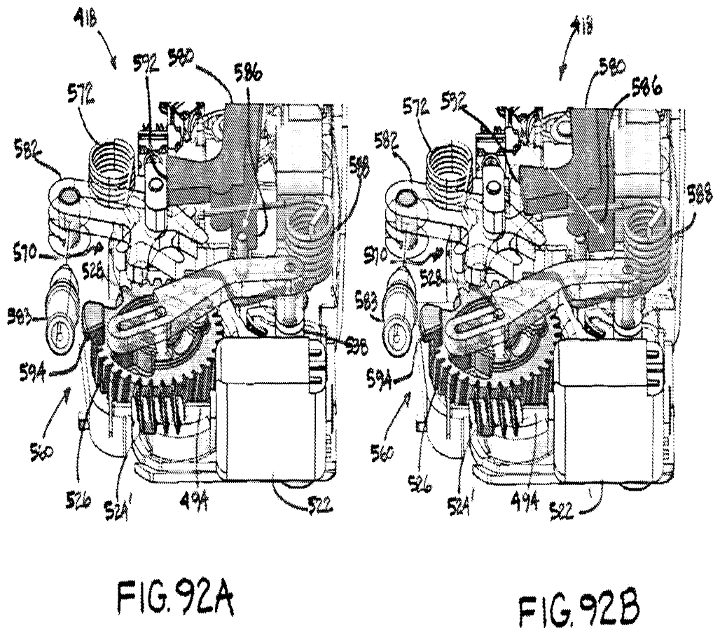

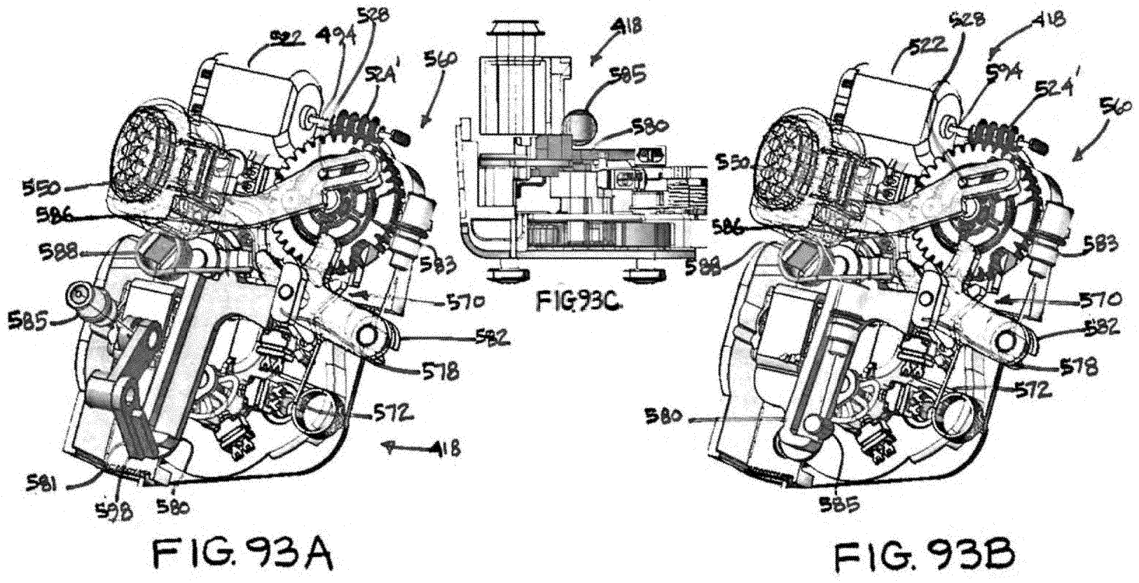

Indexing member 570 is indexable a predetermined number of degrees, such as 90 degrees, by way of example and without limitation, between adjacent ones of the plurality of indexed positions under biased engagement with lug 594 to releasably hold the inside door handle 421 in operable or inoperable communication with pawl 438. An indexing member biasing member, such as a torsion spring 572, is configured to releasably hold indexing member 570 in each of the plurality of indexed positions until desired to index the indexing member 570 to an adjacent indexed position. To facilitate such indexed movement, indexing member 570 has a plurality of radially outwardly extending lobes extending to peaks P, with valleys V being formed between the lobes. With reference to FIG. 83, the indexing biasing member 572 is configured to remain biased radially inwardly into a respective one of the valleys V, thereby holding indexing member 570 in a select position, until indexing member 570 is desired to be forcibly acted on by lug 594 of power release gear 526 forcibly engaging and driving one of a plurality of driven lugs 576 of indexing member 570, as shown in FIG. 91. Indexing member 570 further includes a cam member, shown as a bi-lobe cam member 578, by way of example and without limitation configured to engage an inside release link 580. Cam member 578 is configured to move inside release link 580 between engaged (FIG. 92A) and disengaged (FIG. 92B) positions in response to movement of lug 594 into driving engagement with indexing member 570 upon override release mechanism 560 moving between engaged and disengaged positions.

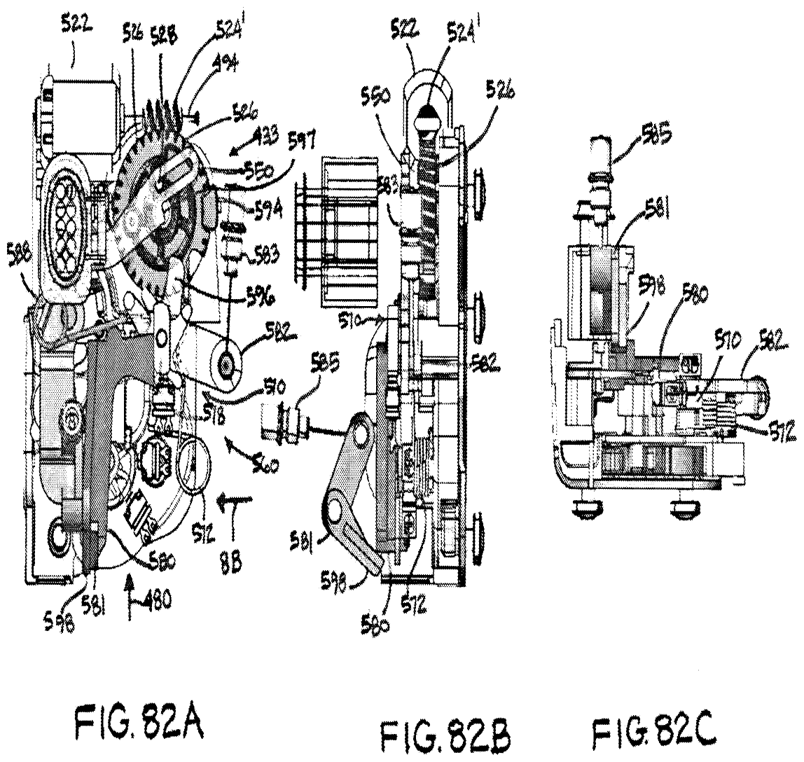

An outside release lever 582 is operably coupled to the outside door handle 421, such as via a Bowden cable 583, with outside release lever 582 having a disengaged position, whereat a drive arm 596 of the outside door handle 421 is disengaged (decoupled) from operable communication with a driven feature, shown as a shoulder 597 of the link arm 550 (identified in FIGS. 81, 82A, but not identified in other views by reference to avoid cluttering the drawings, but shown), and an engaged position, whereat the drive arm 596 of outside door handle 421 is engaged (coupled) in operable communication with shoulder 597 of the link arm 550 (FIG. 89). When outside door handle 421 is in the disengaged position, actuation of the outside door handle 421 does not actuate latch mechanism 432, and thus, pawl 438 is not caused to move from its ratchet holding position. However, when outside door handle 421 is in the engaged position, actuation of the outside door handle 421 does actuate latch mechanism 432, and thus, pawl 438 is caused to move from its ratchet holding position, thereby allowing ratchet 436 to move to its striker release position, thus, allowing door 416 to be opened. Outside release lever 582 is engaged with link arm 150 when the override release mechanism 560 is in the engaged position and is disengaged from the link arm 550 when the override release mechanism 560 is in the disengaged position. While in the engaged position, as best shown in FIG. 89, drive arm 596 of outside release lever 582 is shown positioned to confront and forcibly drive driven feature 597 of link arm 550. Conversely, while in the disengaged position, the drive arm 596 of outside release lever 582 is shown in spaced relation from driven feature 597, thereby being unable to drive link arm 550 to release pawl 438 upon actuation of outside door handle 421.

Inside release link 580 is configured to be operably coupled to the inside door handle 423, such as via a Bowden cable 585 and an inside release lever 581 (FIG. 93A), and in an alternate embodiment, solely via Bowden cable 585 (FIG. 93B) while in an engaged position, and decoupled from inside door handle 423 while in a disengaged position. Accordingly, while in the engaged position, inside door handle 423 is engaged in operable communication with pawl 438 via link arm 550, and thus, inside door handle 423 is effective to actuate latch assembly 418 to move pawl 438 to its ratchet releasing position, whereat ratchet 436 is able to move to its striker release position. Conversely, while in the disengaged position, such as in a child lock or double lock state, inside door handle 423 is disengaged from operable communication with pawl 438, with inside release lever 581 being moved out from possible engagement with link arm 550, and thus, inside door handle 423 is ineffective to actuate latch assembly 418 and unable to move pawl 438 to its ratchet releasing position, thereby being unable to move ratchet 436 to its striker release position.

An inside release link biasing member 588, also referred to as release member or release spring, such as a torsion spring, by way of example and without limitation, is configured to bias inside release link 580 into operably coupled relation with inside door handle 423 by being biased into engagement with an arm 598 of intermediate inside release lever 581, by way of example and without limitation. While cam member 578 of indexing member 570 is in an unlocking position (FIGS. 81-90), inside door handle 423 is engaged in its engaged position in operable communication with pawl 438, such that translation of inside release link 580 via being engaged by inside release lever 581 causes a driven member, also referred to as driven surface or lug 586 of inside release link 580, during actuation of inside door handle 423 to operably drive pawl 438 to its ratchet releasing position (FIGS. 81-90, 92A, 93A, 93B). Accordingly, inside release link 580 is moved between its engaged and disengaged positions via selective interaction with cam member 578 during selectively powered movement of power release gear 526 and corresponding toggled movement of indexing member 570 as power release gear moves from its maximum rest position in direction D2 and back to its maximum rest position.

In FIG. 83, latch assembly 418 is shown in a closed state, with drive gear (power release gear) 526 at a rest position. In this view, outside door handle 421 is in its disengaged state (corresponding to a crash unlock OFF state) and inside door handle 423 is in its engaged state. Accordingly, actuation of outside door handle 421 is ineffective to move link arm 550, thereby being unable to move pawl 438 from its ratchet holding position to release latch assembly 418, while actuation of inside door handle 423 is effective to move inside release link 580 into operably biased engagement with pawl 438, thereby being able to move pawl 438 from its ratchet holding position to release latch assembly 418. Actuation of motor 522 to release latch assembly 418 while in this state is shown in FIGS. 84-87. Motor 522 drives actuation feature 528 in a counterclockwise direction, thereby link arm 550 to be driven to the left (as viewed in the FIGS.), thus moving pawl 438 to its ratchet release position via being coupled to pawl 438 by pin 559. Then actuation feature 528 is ultimately returned to its maximum rest position, as shown FIG. 87. Then, in a crash condition, when desired to move outside door handle 421 into an operable state, whereat outside door handle 421 is rendered effective at opening door 16 (corresponding to a crash unlock ON state), automated movement of power release gear 526 in a clockwise direction via motor 522, as shown in FIGS. 88-89, is performed via command by the ECU 510 via communication with the various crash sensors 538. ECU 510 signals motor 522 to drive actuation feature 528 in a clockwise direction, thereby driving link arm 550 in a clockwise direction, whereupon driven feature 597 of link arm 550 is brought into confronting alignment with drive arm 596 of outside release lever 582. Accordingly, actuation of outside door handle 421 is effective in driving link arm 550, operably coupled to pawl 438 via pin 559, to cause movement of pawl 438 to its ratchet releasing position. It can be seen that the aforementioned actuation of power release gear 526 causes lug 594 of power release gear 526 to engage and index indexing member 570 as discussed above. Each indexed movement of indexing member 570, as discussed above, brings cam member 578 into and out of camming engagement with a surface 592, shown as a laterally extending arm, of inside release link 580 to bias inside release link 580 between its disengaged and engaged positions relative to pawl 438, and thus, inside door handle 423 can be readily disengaged (double lock/child lock) and engaged with inside release link 580.

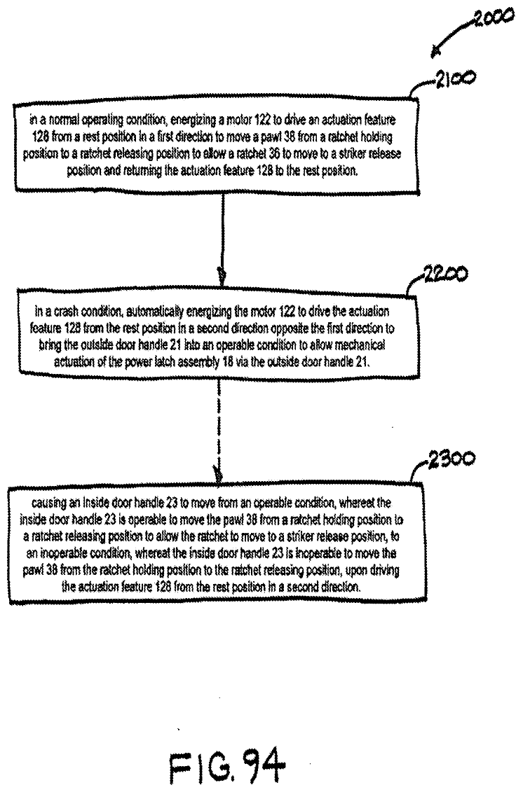

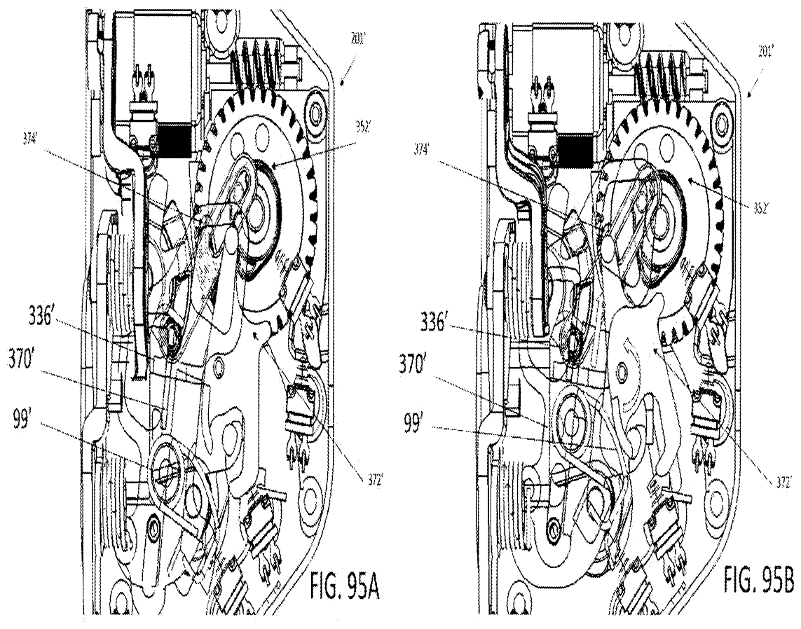

In accordance with another aspect of the disclosure, as detailed diagrammatically in FIG. 94, a method 2000 of operating the power latch assembly 418 includes, in a normal operating condition, wherein an outside door handle 421 is inoperable to allow mechanical actuation of the power latch assembly 418, a step 2100 of energizing a motor 522 to drive an actuation feature 528 from a rest position in a first direction to move a pawl 438 from a ratchet holding position to a ratchet releasing position to allow a ratchet 436 to move to a striker release position and returning the actuation feature 528 to the rest position, and in a crash condition, a step 2200 of automatically energizing the motor 522 to drive the actuation feature 528 from the rest position in a second direction opposite the first direction to bring the outside door handle 421 into an operable condition to allow mechanical actuation of the power latch assembly 418 via the outside door handle 421.

In accordance with another aspect of the disclosure, the method 2000 can further include a step 2300 of causing an inside door handle 423 to move from an operable condition, whereat the inside door handle 423 is operable to move the pawl 438 from a ratchet holding position to a ratchet releasing position to allow the ratchet to move to a striker release position, to an inoperable condition, whereat the inside door handle 423 is inoperable to move the pawl 438 from the ratchet holding position to the ratchet releasing position, upon driving the actuation feature 528 from the rest position in a second direction, such as may be desired when placing the closure latch assembly 418 in a double lock position or child lock position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position; and
a single power actuator configured to move the pawl from the ratchet holding position to the ratchet releasing position, to selectively place the power latch assembly in a double pull lock state, whereat a double mechanical actuation of an inside release mechanism moves the pawl from the ratchet holding position to the ratchet releasing position, and to place the power latch assembly in a child lock state, whereat mechanical actuation of an inside release mechanism does not move the pawl from the ratchet holding position to the ratchet releasing position.

2. The power latch assembly of claim 1, further including a power release gear configured in operable communication with the single power actuator wherein the single power actuator is configured to drive the power release gear from a home position in a first direction to a release position, whereupon the power release gear operably drives the pawl from the ratchet holding position to the ratchet releasing position, and from the home position in a second direction to a lock position, whereupon the power release gear operably places the power latch assembly in one of the double pull lock state and the child lock state.

3. The power latch assembly of claim 2, further including a power release link operably coupling the power release gear with a pawl release lever, wherein the power release link is configured to drive the pawl release lever and move the pawl from the ratchet holding position to the ratchet releasing position when the power release gear is driven from the home position to the release position.

4. The power latch assembly of claim 3, wherein the power release gear and the power release link are configured for lost-motion with one another.

5. The power latch assembly of claim 4, wherein the power release link has an elongate slot and the power release gear has a pin disposed in the elongate slot for translation therein, wherein when the power release gear is driven from its home position in the first direction to the release position, the pin engages a drive end of the elongate slot and drives the power release link to move the pawl release lever and drive the pawl from the ratchet holding position to the ratchet releasing position, and wherein when the power release gear is driven from its home position in the second direction to the lock position, the pin moves away from the drive end in lost-motion through the elongate slot to place the power latch assembly in one of the double pull lock state and the child lock state.

6. The power latch assembly of claim 3, further including an inside release link configured for driven movement from a rest position to a deployed position in response to mechanical actuation of the inside release mechanism, and further including an inside lock cam configured for movement between a cam unlock position, whereat the inside release link is aligned for operable engagement with the pawl release lever and a cam double pull lock position, whereat the inside release link is misaligned from operable engagement with the pawl release lever during a first mechanical actuation of the inside release mechanism.

7. The power latch assembly of claim 6, wherein the inside lock cam is configured for engagement by a lug of the power release gear when the power release gear is driven a first time from its home position in the second direction to the lock position, whereupon the inside lock cam is driven to the cam double pull lock position.

8. The power latch assembly of claim 7, wherein the inside lock cam, while in the cam double pull lock position, is configured for engagement by the lug of the power release gear when the power release gear is driven a second time from its home position in the second direction to the lock position, whereupon the inside lock cam is driven to the cam child lock position.

9. The power latch assembly of claim 7, further including a double pull link coupled to the inside lock cam and configured for operable engagement with the inside release link, wherein while the inside lock cam is in the cam double pull lock position, during a first mechanical actuation of the inside release mechanism the inside lock cam is driven by the double pull link to the cam unlock position, whereat the inside release link is aligned for operable engagement with the pawl release lever upon completion of the first mechanical actuation of the inside release mechanism, and during a second mechanical actuation of the inside release mechanism the inside release link moves the pawl release lever and drives the pawl from the ratchet holding position to the ratchet releasing position.

10. The power latch assembly of claim 9, wherein while the inside lock cam is in the child lock position, during repeated mechanical actuation of the inside release mechanism, the inside lock cam remains in the child lock position.

11. The power latch assembly of claim 6, wherein the inside lock cam is configured for movement to a cam child lock position, whereat the inside release link is misaligned from operable engagement with the pawl release lever for any number of mechanical actuations of the inside release mechanism.

12. The power latch assembly of claim 7, wherein the power release gear is configured to remain in the release position, whereat the lug of the power release gear engages a child lock projection of the inside lock cam to releasably place the power latch assembly in the child lock state.

13. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
an inside release link configured for driven movement from a rest position to a deployed position in response to mechanical actuation of the inside release mechanism, the inside release link having an aligned position for operable engagement with the pawl release lever, and an unaligned position for bypass of the pawl release lever when the inside release link is driven; and
a power actuator configured to move the pawl from the ratchet holding position to the ratchet releasing position, the power actuator further configured to selectively control an indexable cam for controlling the position of the inside release link.

14. The power latch assembly of claim 13, wherein the power latch assembly comprises a double pull lock state and a child lock state controlled by the indexable cam, wherein when the power latch assembly is in the child lock state, movement of the inside release link does not does shift the power latch assembly to another state.

15. The power latch assembly of claim 13, wherein the indexable cam is adapted to maintain the position of the inside release link in the unaligned position in response to movement of the inside release link when the latch is in a child lock/double lock state.

16. A latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a release mechanism operably coupled to the pawl; and
a lock mechanism adapted to couple and decouple the release mechanism to the pawl;
wherein the release mechanism is unable to shift the lock mechanism from a first lock state to another state when the lock mechanism is in the first lock state.

17. The latch assembly of claim 16, further comprising a resilient element adapted to deflect in response to an actuation of the release mechanism to prevent the lock mechanism from shifting from the first lock state to another lock state.

18. The latch assembly of claim 16, wherein the first lock state is a child lock/double lock state and the another lock state is a double pull lock state.

19. The latch of claim 16, wherein the further comprising a release link configured for driven movement from a rest position to a deployed position in response to mechanical actuation of the release mechanism, the release link having an aligned position for operable engagement with the pawl release lever, and an unaligned position for bypass of the pawl release lever when the release link is driven, and the lock mechanism comprises an inside lock cam for controlling the position of inside release link, the inside lock cam adapted to prevent the inside release link from moving into the aligned position when the lock mechanism is in the first lock state.

20. The latch of claim 19, further comprising a resilient element, wherein when the lock mechanism is in the first lock state the resilient element is adapted to deflect in response of the release link being driven.
